(19) United States
(12) Patent Application Publication
(10) Pub. No.: US 2020/0160443 A1
(43) Pub. Date: May 21, 2020

(54) PROCESS FOR THE DETECTION AND IDENTIFICATION OF IDIOSYNCRATIC VALUATIONS BY INTENT IN EQUITIES COMMERCE AND OTHER ILLEGAL EQUITY TRADES IN U.S. DOMESTIC STOCK MARKETS

(71) Applicant: Joseph Martin Weideman, Vancouver, WA (US)

(72) Inventor: Joseph Martin Weideman, Vancouver, WA (US)

(21) Appl. No.: 16/192,130

(22) Filed: Nov. 15, 2018

(51) Int. Cl. G06Q 40/04; G06Q 50/26; G06Q 40/06

(52) U.S. Cl. CPC G06Q 40/04; G06Q 40/06; G06Q 50/26

(57) ABSTRACT

It is the purpose of this Process for the Detection and Identification of Idiosyncratic Valuations by Intent in Equities Commerce and Other Illegal Equity Trades in U.S. Domestic Stock Markets to create a means of evaluation of specific sets of publicly available information in what has always officially been described as a random series of happenstance events, themselves allegedly subject only to all publicly available information; doing so in such a manner, without guile or subjective prejudice, sufficient to stand up in court proceedings and thorough challenge by rigorous testing of the results such that it survives the standards of reasonable doubt, for the purposes of establishing intent behind specific time-related actions, revealing a profit-oriented rationale for otherwise illegal equity trades and trading effects.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO SEQUENCE LISTING, ETC.

“Not Applicable”

### BACKGROUND OF THE INVENTION

Field(s) of Endeavor: Laws, Regulations and Rules of Monitoring, Investigation, Enforcement and Oversight Covering the U.S. Equities Markets by Both Public [The Securities and Exchange Commission (SEC) Regulation and Enforcement Divisions; The U.S. Department of Justice (DoJ), The Federal Bureau of Investigation (FBI), The Anti-Trust Division, and others under the DoJ; The U.S. Treasury Department and the Internal Revenue Service; The U.S. Federal Court System; as well as the various and assorted similar departments of each of the respective States] and Private [The Financial Industries Regulatory Authority and other Federal and State Sanctioned Self-Regulatory Agencies that oversee and regulate and enforce the Laws, Regulations and Rules that govern the U.S. Equities Markets] sectors and the victims of these illegal equities trading practices. Information Known to Me which is related to this Invention, specifically to problems involved in any “prior art” (or state of technology or even the total lack thereof) which this Invention is drawn toward: The current inability of respective Authorities to clearly demonstrate the Intent behind such criminal acts that is required for prosecution, in both Criminal and Civil cases, as well as clearly demonstrating to the victims the state and extent of their victimization so they, too, may pursue a redress of grievance and be made whole. A simple Reference to this problem can be found in the document published in 2009 by the Office of the Inspector General (OIG) of the Securities and Exchange Commission (SEC), Publication No. 450. It was stated multiple times that equities price manipulation is highly illegal yet without the ability to demonstrate “Intent” prosecution is not possible. This Process demonstrates that intent. This Process eliminates the obfuscatory nature of the how, when and what relational(s) much of the collected data displays publicly which enables the criminal trading activity and removes the camouflaging natures of what becomes the victimizing of the investing and retirement savings public.

### BRIEF SUMMARY OF THE INVENTION

This Process for the Detection and Identification of Idiosyncratic Valuations by Intent in Equities Commerce and Other Illegal Equity Trades in U.S. Domestic Stock Markets involves the proper alignment of data that is collected, in general as well as by regulatory authority and mandate, by specific date of creation (as opposed to peculiar date of reference and/or eventual publication), the inter- and intra-relational nature of that data, to itself and to specific non-trading data and referent information and date and timing of that non-trading data and referent information publication (making such information public) and the patterning of the referent trading data and in particular the patterning of specific patterns of trading data that immediately precede that public release of that non-trading data and referent information. Confirmation of certain manipulative acts can also be seen in consequent alternate trading data that succeeds the publication of certain types of non-trading data and referent information. The particular Unpredictability of the timing of the release of some information having documentable and demonstrable preceding trading patterns wholly unrelated to the release of confidential and specifically-natured Insider Information which IS not known to the public prior to its publication is of particular interest when showing the Intent behind such trading in Trading Price, in Trading Volume, in Short Volume, in Fails to Deliver count and in Short Interest, among other data, clearly demonstrate intent behind these actions. Well documented and explained analyses of that data is of particular and essential benefit to the exposure and pursuit of the perpetrators and facilitators, overseers and insiders, and most important the instigators of these illegal activities. It must be emphasized the price even one share trades at determines the price ALL other shares of like-kind are then priced, as valued, until the next trade of like-kind equity.

### BRIEF DESCRIPTION OF THE SEVERAL VIEWS OF THE DRAWING

“Not Applicable”

### DETAILED DESCRIPTION OF THE INVENTION

What follows are the Primary, Secondary, Tertiary, Quaternary, Quinary and Senary Levels of Assembling and Combining the Various Data Bases of Individual Stock Equities and Attendant Matters and Issues that Facilitate A Process for the Detection and Identification of Idiosyncratic Valuations by Intent in Equities Commerce and Other Illegal Equity Trades in U.S. Domestic Stock Markets.

These assemblies are applicable to insertion into any spreadsheet regardless of format, including paper or electronic, regardless of whether the spreadsheet is proprietary or open source.

It is highly recommended the entire detailed description be read through first before any attempt is made to construct this Process.

### Primary Level

Note 1: Highly Critical! The Trade Date is the most relevant data-alignment aspect for the detection of specific illegal trades, followed by the variety and range of the specific Column contents. This is important to note because a significant portion of the relevant data fields are published as Settlement Date-focused entries without making note of that aspect.

Note 2: None of the data used as primary, preliminary input (Columns A-Z) is proprietary.

Note 3: In this Description, Columns are vertical; Rows are horizontal.

Note 4: The actual ordering or sequence of each Column Name and respective content is not specifically relevant so long as all Columnar cell entries are properly entered to their respective Trade Dates and as long as each Column's date-specific contents maintains its relevance and relationship to the other Columns' date-specific contents. The presented alignment and sequence is to facilitate optimum referent visual recognition and relationship of each data cell in the context of all other data cells.

Note 5: The specific entries under and for each Column are in the respective Rows for each Trade Date.

Note 6: The term “Company” refers to the Company/Corporation for which the shares or equities are representative of proportional ownership. Under normal circumstances for analysis, the shares themselves are “Common” Shares (unless otherwise noted in a specific spreadsheet's Target Subject such as but not limited to “Preferred” or “Warrants” or “Lettered or Numbered Sub-types”).

Note 7: For presentation purposes in this Description
Column Names are underlined. Columnar Names in parentheses, brackets, etc. (abbreviations or acronyms or a mix of both) as the preferred entry are shown in bold. Some may be abbreviated further if necessary or desired. Those names shown in bold are only as examples.
Any definition or clarification of each entry follows immediately in italics.
“Alpha” (as in “Alpha Row” or “Alpha Column”) simply indicates “first”. 100 “Alpha Row” is actually a Columnar entry and “Alpha Column Title” is actually a Row entry.

Beginning with the spreadsheet itself:

Alpha Column Title entries are initially Alphabetic (for brevity and to distinguish from Row entries) and entered in full on Row 0.

Alpha Row entries are initially Numeric and are entered in full on Column 0, are whole-number sequential and oriented by and to all possible chronologically-sequenced Trade Dates (Column A) the markets are open regardless of whether or not the spreadsheet-specific equity traded on that date. For the purposes of this Description, Date Entries are ascending; that is, they begin with the earliest at the top and proceed downward to the latest or most recent.

Alpha Column Titles:

A) Trade Date (Trade Date) The actual available Date of Trading. The Trade Date format entry is not particularly relevant so long as it is consistent throughout the document and is recognized by the various data entries at and for the time and Date each is being entered. [Non-trading entries are also entered in their date-respective rows (see below Columns J, K, L, U, and W) as are inter- and/or intra-row Pre-algorithmic and/or Algorithmic analysis of date-specific entry results as each relational specification requires.] (“Pre-algorithmic” here means simple, single-function arithmetic calculation; “Algorithmic” means compound-function arithmetic and/or polynomial calculations.)

B) Opening Price (Open) This is the Opening or First Trade price at which the stock traded that was registered during normal market trading hours on the specific trading date.

C) High Price (High) This is the Highest Price for which the stock traded during normal market trading hours on the specific trading date.

D) Low Price (Low) This is the Lowest Price for which the stock traded during normal market trading hours on the specific trading date.

E) Closing Price (Close) This is the Last Price for which the stock traded during normal market trading hours on the specific trading date.

F) Daily Volume (or Trading Volume) (Volume) This is the Total Number of Shares traded during normal market trading hours on the specific trading date.

G) Price Range (Range) This is the nominal Difference in Prices paid between the High (Column C) and the Low (Column D) for shares traded during normal market trading hours on the specific trading date (Column C minus Column D entries) or (Col C−Col D) (See Column O Notes).

H) Settlement Date (Settlement Date or Settlement Date) This is the Date upon which any trades made under normal trading on the respective Trade Date must be settled. The Settlement Date was generally three days after the Trade Date. It had been referred to as “T+3” since 1993. This three-day specific delay to Settlement has been changed to a delay of two-days as of Sep. 5, 2017 and since then referred to as “T+2”. All further references to Trade Date/Settlement Date assumes this change. (See Notes and References for Tertiary, Quaternary and Quinary Levels for various adjustments to accommodate this change.) For each trade made, the shares must be delivered and the agreed-to price paid at (by) the close of trading on the Settlement Date. The Settlement Date is provided in case any question(s), incident(s), event(s), etc. arise in the interim between the respective Trade Date and Settlement Date (or shortly thereafter by minutes or hours). Its inclusion also illustrates “in context” the fact of the time interval of each Trade-Date-to-Settlement-Date Set or Pairing.

I) Quantity of Failure to Deliver Shares (Qty FTDs or simply FTDs) This is the Total Number of Existing Failures to Deliver† (FTDs) on this specific date. It is a bi-adjusted entry. First, the specific number is calculated by the total number of shares not delivered on or by the respective Settlement Date for those shares traded on that specific Trade Date plus any shares not delivered on previous Settlement Dates still not delivered by the current Trade Date's respective Settlement Date. [This adjustment is made by the source(s) of the specific data, sans mention of any relevant Trade Date(s).] Second, because the Settlement Date is three trading days AFTER the given Trade Date (or the revised two trading day delay), it imposes a delay in the determination of “Delivered” or “Failed to Deliver” when required to “settle” the trade made on the given Trade Date. Since that determination cannot be made until that respective Settlement Date, it is also not entered into the data field for official publication until that specific Settlement Date, not the Trade Date on which that specific trade occurred. Therefore, the adjustment is made by subtracting three trading dates (or the revised two trading days) from the officially published entry in order to properly align the number with the correct Trade Date. †Other terms that fall under the “FTD” or “FTDs” designation may include but are not limited to: “Fails to Deliver”; “Failed to Deliver”; “Failing to Deliver”; “Failing to be Delivered”; and so on, and, with or without the “Quantity of” since that is presumed. Contextual differences will not alter the generalized “FTD” or “FTDs” entry. Under normal usage the designation will most often be in the plural.

Note 8: There are circumstances where there are no FTD entries for a given Trade Date. These may be due to there being no FTDs remaining to be delivered. However, when the entry is the eve of a holiday or is a holiday not observed by the markets, the official collection or recording of any FTDs for that date may not have occurred. It is especially notable when there are entries immediately preceding and immediately following this specific “empty” cell.

Note 9: For more than five years Failure to Deliver numbers were collected on a quarterly basis (at the end of every three months January-March; April-June; July-September; and October-December). The release and publication of those daily-by-quarter results was further postponed by a mandated excess of 60-days after the end of the quarter in which they were generated. Currently, they are collected bi-monthly (twice a month) but their release and publication are still delayed and are still published by Settlement Date orientation. Other official practices of FTD data obfuscation are also ongoing.

J) Company Press Release (PR) Δ*Ω* This is simply an acknowledgment of any official Company-initiated Press Release (PR) made on a given Trade Date or entered on the first Trade Date immediately following any Company-initiated Press Release made on a non-trading/tradeable date. It does not necessarily require the PR to be made during normal trading hours. However, special attention may be necessary if the PR was made after normal trading hours immediately preceding a non-trading date such as a weekend or holiday, and/or if there are questionable trading indicators preceding or following such entries. Each entry is made note of in a “Company-specific” Press Release Reference Appendix organized by Date of Issuance. Time, region of release and/or subject matter and/or subject matter reference date are listed as well, when available. A given Company Press Release Reference Appendix entry may also list additional matters of relevance, up to and including the entire contents of the Company PR itself *Item of Focus (a.k.a. Items of Interest): See explanation at end of Primary Level below.

K) Official Securities and Exchange Commission (SEC) Company Filing Δ Ω (Filing Ref No or simply FlngRf No) This is the entry for all Filings made by the Company (except SEC employee share Ownership Forms 3, 4, 5). The Filings are each assigned a reference number specific to the spreadsheet document. They are each entered by the Date of Submission of Filing (assuming the SEC Acceptance is of the same Date noted if different). They are collected in a “Company-specific” Filing Reference Appendix numbered in sequence and organized by date and time and include: Type of Filing; Filing Date; SEC Acceptance Date and Time (unless otherwise noted is in Eastern Daylight EDT or Eastern Standard EST Time Zone); Reference Period (RP) (usually a date the filing refers to, depending on the nature of the Filing Type); Followed by any necessary Notes of special reference or general and/or full content. These Company-specific official SEC Filings are sourced from the SEC's own EDGAR website.

L) Filing Report/Reference Date/Period ΔΩ (Fing Rpt Prd or FRP) This is entered using the same spreadsheet document reference number used in Column K but entered on the Reference Period (RP) Date from the same numbered entry in the “Company-specific” Filing Reference Appendix. If; under some circumstances, there are more than one Reference Periods for a given Filing, such multiple Reference Periods are entered along with lowercase letter subscript identifiers and noted as such in the “Company-specific” Filing Reference Appendix.

M) Short Interest (Shrt Int or SI) This is the Short Interest (SI) recorded and reported as of specific monthly (Pre-September 2007) or twice-monthly (Beginning September 2007 onward) Settlement Date(s). It is oriented in the spreadsheet to the Last Trade Date for a given Record Date SI Settlement Date for the specific Report Period being entered. The release and publication of the given number for the specific entry can be delayed by up to three weeks after the specific entry's Last Trade Date. The published Short Interest is specifically oriented to the Settlement Date. Since the spreadsheet Settlement Date is coordinated to the specific Trade Date, consistency is maintained in and to Trade Date relevance. Short Interest Last Trade Date date of entry shall be listed in the “Company-specific” External Events Reference Appendix [Also See Col H Settlement Date and Col W ●Short Interest Last Trade Date (SILTD) along with the relevant Settlement Date details and the Date of Release and/or Publication, if available.]

N) Short Interest Average Daily Trading Volume (SI ADVol) This is the Average Trading Volume per day over the specified time period beginning at the start of trading at the open of the first trading day after the previous SI Report Period's Last Trade Date close of trading to the close of trading on the current SI Report Period's Last Trade Date (calculated by adding the daily trading volumes within normal trading hours for each day the equity trades in the given period divided by the number of trading days in that period). The published ADV range is Settlement Date oriented. This is not. [As the number of days between Short Interest Last Trade Dates varies (Col M 1 next day thru Col M), the referent in both Numerator and Denominator in this formula depends on that specific range for that specific time period. See also explanation for Col W/SILTD.] Formula:

[Sum(Col F of Col M Report Period)]÷(No. Col M Trading Days)

O) Daily Short Volume (Dly Shrt Vol or DSV) This is the total Number of Shares (equities) of the spreadsheet document-specific Company that were identified or registered as Short Sold or Sold Short at the time of trade. It is not to be confused with Short Interest. The number entered includes all shares (equities) registered at the time of trade as sold short during normal trading hours for the specific trading day regardless of whether or not they were “covered” during normal trading hours that day. The number does not include short sold shares of any previous trading days.

Note 10: In Formulas shown in all succeeding Column descriptions, the use of a “Col x” indicator for a factor in that formula indicates the day's entry in that specific Column, not the entire Column. The use of “Col” as a substitution for the word “Column” is for notational brevity. For instance; the Formula for arriving at the day's entry for Column P below, the formula “Col I (Col I−1)” is that day's entry in “Column I” subtracted by the previous day's entry in that same Column or “Column I−1”. This usage shall be throughout the Description of the Process's System of Formulas.

Note 11: The number “1” in the “y” position here (Col I y) and designated in Note: 10's example “(Col I−1)” is the day or number of days to count when immediately following a plus sign “+” or minus sign “−” after a “Col x” factor in a Formula: forward day count if a positive sign; regress day count if a negative sign.

Note 12: Formula are in Bold.

Note 13: Each Formula is shown on a separate line immediately following the Column's description.

Note 14: The Formula actually used will be in a mathematical format adapted by the user to the specifically-used spreadsheet format requirements as opposed to the literal format used here yet the intended and identical results are achieved.

P) Failures to Deliver Change (FTD Chnge) This is the Difference in the Number of FTDs from the immediately prior Trade Date. It is simply making note of the specific change from one day to the next. It is entered whether or not there were any FTDs entered on that previous trade date (See Note: 8 in the description for Column I). If it is a decrease in the number of FTDs, then it is entered as a negative number. It does not consider whether any shares FTD are new or from any previous trade date's continuing FTD status. Formula:

[Col I−(Col I−1)]

Q) FTD Percentage Change (FTD Chnge %) This is the Percentage of Change in the Number of FTDs from the immediately prior Trade Date. If there were no FTDs entered on that previous Trade Date, the cell is left empty. (See Note: 8 in the description for Column I). If all FTDs extant on the previous Trade Date were finally delivered and no new FTDs are generated from trading during the current Trade Date, the entry is a negative 100%. Formula:

Col P÷[(Col I−1)×0.01]

R) Volume Change (Vol Chnge) This is the Change in Trading Volume from the immediately prior Trade Date. If there was no change in volume from the previous Trade Date's volume there will be no entry. Formula:

[Col F−(Col F−1)]

S) Volume Percentage Change (Vol % Chnge) This is the Percentage of Change in Volume from the immediately prior Trade Date. If there was no change in volume from the previous Trade Date's volume there will be no entry. If there was no trading, the change will be negative 100%. If there was no trading the previous day, there will be no entry. Formula:

Col R÷[(Col F−1)×0.01]

T) Daily Short Volume Change (DSV Chnge) This is the Change in the Short Volume from any that may have been entered for the immediately prior Trade Date. Formula:

[Col O−(Col O−1)]

U) Shares Outstanding (Sh Outstndg or SH-OS) This is the Number of Shares Outstanding in the Company-specific spreadsheet document. They are entered for the same Trade Date as “Reference Date” presented in the reference source, normally a Company SEC Filing or Proxy Document. Since there are different ways or types (methods of counting and accounting for) in which Shares Outstanding are calculated for SEC Filing and/or publishing purposes for instance: Issued and Available for trade (IA); and/or, Fully Diluted (FD); and/or Volume Weighted fully diluted average (VW), it may be necessary to delineate entries with a letter-pair prefix (as suggested: “IA”; “FD”; or “VW”) if there is type-variance in and between a Company's filings. Generally, the number of Shares Outstanding Issued and Available (IA) for trade are used in calculating the Column V figure.

V) One-Half Percent of Shares Outstanding (SHOS x.005) This is to represent the Threshold Number for consideration of listing as “Threshold” by and for REG SHO purposes. It is calculated by multiplying the Issued and Available for Trade Shares Outstanding by 0.5% (×0.005). It is entered in whole numbers by rounding up if necessary. Formula:

(Col U×0.005)

W) External Events (Ext Ev)ΔΩ# [symbol] This is where External Events that may have a trading or price impact or influence are listed but may not have that effect on the trading on the specific date entered.

These entries are collected in a Company-specific External Events Reference Appendix, type-identified and organized by date(s) of relevance, including both publication date and reference date, if different from publication date.

Many are cyclical.

Many are not formally announced, either beforehand or in any case, but rather, interested party's attention is presumed.

Some are presumed to be known and therefore are not noted by announcements but do get entered as some, many or all of those types affect some, many or all stocks generally.

Some of these entries are entered in several, many, most or all Company-specific stocks' spreadsheets subject to this Process.

In many cases, entry is as much a place-holding for potentially affecting or open-to-advantage-taking events for explanation or rationalization of trading activity, yet any explanation or rationalization does not necessarily serve as legitimizing or legalizing such activity.

Each will have an Abbreviation or Alpha-Numeric Acronym or Designation specific to its type, be entered into the spreadsheet where date appropriate and are shown here italicized in parentheses.

The specific abbreviations or acronyms are suggestive but not mandatory and are only for demonstration purposes.

All are oriented to and entered on their respective Trade Dates.

These events are entered on the date of announcement or occurrence, as the case may be. If both are entered and are associated with a given event, they are entered separately and noted accordingly by lowercase typing initials: “a” for “announcement” and o″ for “occurrence”.

If entries affect multiple entities, components and/or other External Events, explanations may be included in the Company-specific External Events Reference Appendix.

Events or announcements that occur on days the markets are not open are listed on the most recent previous Trade Date for consistency.

Single-day and Multi-day events that occur on, begin on, extend into or through non-market trading days (weekends or holidays) are noted in the Company-specific External Events Reference Appendix with additional lowercase day initials (Sunday su; Monday mo; Tuesday tu; Wednesday—we; Thursday th; Friday—fr; Saturday—sa).

This List shown is neither exhaustive nor ordered by or to any level of relative importance. These External Events include but are not limited to:
Short Interest Last Trade Date (SILTD) (Included here but it is the Trading Date the Current Short Interest is entered and is a referent point for other entries directly and/or indirectly related to the Short Interest Report Period. It is rarely mentioned in published listings of Short Interest yet it is the Last Trading Date for which shares sold short and not covered can be traded as well as any existing can be covered by purchase and received by the Settlement Date.)
End of Quarter (EOQ)
Holiday Observed by Federal Government but not the Markets (HOF)
Eve of Holiday Observed by Federal Government but not Markets (EHOF)
Holiday Observed by both Federal Government and the Markets (HOFB)
Eve of Holiday Observed by Federal Government and Markets (EHOFB) Shortened Trading Day (STD)
Options Expiration Date (OED); (Tradeable Put/Call-type Options, Not Employee Incentive Options)
Russell Indexes Re-balancing Date (RIRD)
Russell Indexes Re-balancing Initial Announcement Date (RIRIAD) (the preliminary additions and subtractions list is announced)
Russell Indexes Re-balancing Final Announcement Date (RIRFAD) (final list of additions and subtractions list is announced)
Trade Show Date (TSD) (Company-relevant Trade Show events)
Major Competitor Event Announcement Date (MCEAD) (The date a major event occurs or is announced affecting a Company-specific competitor, if available)
Any Local, National or International Event or Occurrence (RANDOM) (any known event or occurrence in the world that is wholly unpredictable and/or random that may have a significant impact on or relevance to the Company or stock trading in general).

Any additional External Events-types not listed above but which are applicable would be included in the Company-specific External Events Reference Appendix as well.

X) Total Trading Volume for Current Short Interest Report Period This is determined by adding the Daily Trading Volumes for the Current Short Interest Report Period from the first Trading Day after the previous Short Interest Last Trade Date through the current Short Interest Last Trade Date. Entered on the current Short Interest Last Trade Date, same Trade Date as current Short Interest. Formula:

(Find Sum of Daily Trading Volumes During Normal Trading Hours for Current Short Interest Report Period)

Y) Five-Day Cumulative Trading Volume [Sum(F thru F−4)] This is the Sum of the Trading Volumes at the Close of Trading of the Current Day's Volume plus the Closing Volumes of the previous Four Days. It is calculated by adding the current Day's regular trading hour Trading Volume plus the regular trading hours volumes of the previous four days. Formula:

[Sum(Col F±0 thru Col F−4)]

Z) Five-Day Average Daily Volume (Col Y×0.2) This is the Average Daily Trading Volume for the most recent five-days of Trading. It is calculated by dividing the sum of the most recent five-days' trading volume by five or multiplying by 0.2. Formula:

(Col Y×0.2)

Note 15: Concerning Items of Interest (also referred to as Items of Focus)
Δ Items of Interest
Ω Unpredictable Items of Interest
# Predictable Items of Interest
[symbol] Somewhat Predictable Items of Interest—Item often known and anticipated but announcement/publication date is unpredictable yet has a narrow window for announcement/publication or may be related to (RANDOM) event.
Whether Unpredictable, Predictable or Somewhat Predictable, each instance is dependent on the circumstances of its type and issuance.
In some circumstances, Column entry Item of Interest or the Reference Date may come under more than one category (multiple listing) as in: End of Quarter Date can also be a Filing Report Period Date. In other circumstances Item may be the announcement of a Record Date for Shareholder Date of Record for Dividend or to qualify for Proxy Vote, or the date of a shareholder meeting or related event or Company press release.
Once a near-term trading pattern is identified and potentially typed, the net nature of a multiple listing of Item(s) of Interest Date may be determined from the data present but is not always the only influence on a given pattern.

This concludes the Primary Level of Assembling the Various Data Bases of Individual Stock Equities and Attendant Matters and Issues that Facilitate A Process for the Detection and Identification of Idiosyncratic Valuations by Intent in Equities Commerce and Other Illegal Equity Trades in U.S. Domestic Stock Markets.

### Secondary Level

What follows is the Secondary Level of Assembling spreadsheet Columns, one that comprises a non-definitive, non-conclusive variety or array of the Inter- and/or Infra-Row and/or Inter- and/or Infra-Columnar Pre-algorithmic and/or Algorithmic analyses of date-specific entry results as each relational specification requires. As mentioned in the description for Column A (Trade Date) in the Primary Section above, “Pre-algorithmic” means simple, single-function arithmetic calculation and “Algorithmic” means compound-function arithmetic and/or polynomial calculations. In some cases, the Pre-algorithmic calculations/results are stand alone, others are preliminary factors in some of the Algorithmic analytical calculations and some are both stand alone as well as preliminary factors in some of the Algorithmic analytical calculations. Some Algorithmic analytical calculations also function eventually as factors in additional Algorithmic analytical calculations. These calculations assist in whole, in part and/or in conjunction with other Column and/or Row entries with or without reference details from, through, within, above, below or beside specific entries in defining and/or clarifying and/or specifying A Process for the Detection and Identification of Idiosyncratic Valuations by Intent in Equities Commerce and Other Illegal Equity Trades in U.S. Domestic Stock Markets.

Note 16: While the specific entries are Date relevant, and that current Date Specificity is implied they are not necessarily restricted to containing exclusively same-Date specific components/factors in their calculations. When “Other” Date Specific data is included, it is normally specifically indicated as such, as is data that is from non-current Trade Date specific sources.

Note 17: Some of the entries are by their nature derived from Columnar Data, either exclusively or in conjunction with other Columnar and/or Row Data.

Note 18: Some of the entries are by their nature derived from Row Data, either exclusively or in conjunction with other Row and/or Columnar Data.

Note 19: As in the Primary Section above:
Column Names are underlined. Columnar Names in parentheses (abbreviations or acronyms or a mix of both) are the preferred entry and are shown in bold. Some may be abbreviated further if necessary or desired. Those names shown in bold are only as suggested examples.
Any definition or clarification of each entry follows immediately in italics.
Formula shown in definitions or clarifications are in bold but not italicized.

Note 20: Formula are shown in the same manner as described in Notes: 10 thru 14 immediately preceding the entry for Column P above.

Note 21: Alpha-Numeric identification in the spreadsheet of both Columns and Rows are continuations of those used in the Primary Section.

Note 22: Column Titles are spelled out in full. Preferred entries may use other Column Uppercase Alpha designations as components for compactness but that use does not diminish from the intent or alter the meaning of each designation.

Note 23: In Formulas shown in the following Column descriptions, the use of a “Col x” indicator for a factor in that formula indicates the day's entry in that specific Column, not the entire Column. The use of “Col” as a substitution for the word “Column” is for notational brevity.

Note 24: In Formulas where a “Col x” is followed by an arithmetic sign (“+” or “−”) and then a whole number, it indicates a movement backward (−) or forward (+) Date-wise along that same Column by the number of days indicated by that whole number.

Note 25: In Formulas where a “Col x” is followed by the term “thru” and an arithmetic sign (“+” or “−”) and then a whole number indicates the same backward or forward movement Date-wise along that same Column by the serial number of days indicated by those whole number entries which are cumulative to the equation for that entry.

Note 26: Of any formula for a given Column calculation, Column Uppercase Alpha designation(s) may be used in that formula to designate the specific factor entries.

Note 27: The Formula actually used may be in a mathematical format adapted to the specifically-used spreadsheet format requirements as opposed to the literal contextual format used here yet the identical results are achieved.

Note 28: The term “Failures to Deliver” or its equivalent “Fails to Deliver” or any of the other variants listed above (See: Description of Col I) shall be substituted by either acronym “FTD” or “FTDs” for brevity.

Note 29: Alphabetic Column identity begins double-entry.

Pre-algorithmic and/or Algorithmic Columns as follows:

AA) Daily Short Volume Percentage Change (DSVChng %) This is the percentage change in the Daily Short Volume Change (Col T) from the most recent previous Trade Date's Daily Short Volume (Col O−1). It is calculated by dividing the Daily Short Volume Change by One Percent of the Previous Daily Short Volume. Formula:

Col T+[(Col O−1)×0.01]

AB) Daily Short Volume as Percentage of the Volume (DSV % Vol or Col O % Vol) This is the Daily Short Volume as a percentage of the day s Trading Volume. It is calculated by dividing the Daily Short Volume by One Percent of the Day's Trading Volume. Formula:

Col O+[(Col F)×0.01]

AC) Failures to Deliver (FTDs) as Percentage of the Volume (Col I % Col F) This is the percentage of FTDs as a percentage of the day's Trading Volume. It is calculated by dividing the day's FTDs by One Percent of the Day's Trading Volume. Formula:

Col I+[(Col F)×0.01]

AD) FTD Change as Percentage of the Volume (Col P % Col F) This is the FTD Change as a percentage of the Day's Volume. It is calculated by dividing the Change in FTDs from the previous day's Quantity of FTDs by One Percent of the Day's Trading Volume. Formula:

Col P+[(Col F)×0.01]

AE) Price Range as Percentage of the Close (Col G % Col E) This is the Price Range as a percentage of the Closing Price. It is calculated by dividing the Price Range by One Percent of the Closing Price. Formula:

Col G−[(Col E)×0.01]

AF) Change in Closing Price (Close Chnge) This is the Change in Closing Price from the most recent Trading Day's Closing Price. It is calculated by subtracting the current day's Close from the most recent previous Day's Close. Formula:

[Col E−(Col E−1)]

AG) Closing Price Change As Percentage of Previous Closing Price (Cls % Cng) This is the Closing Price Change as a Percentage of the Previous Close. It is calculated by dividing the Change in Closing Price from the Previous Close by One Percent of the Previous Close. Formula:

Col AF−[(Col E−1)×0.01]

AH) Change in Open Price (Open Chnge) This is the Change in Opening Price from the most recent previous Trading Day's Opening Price. It is calculated by subtracting the current day's Open from the most recent previous Day's Open. Formula:

[Col B−(Col B−1)]

AI) Change in High Price (High Chnge) This is the Change in High Price from the most recent previous Trading Day's High Price. It is calculated by subtracting the current day's Open from the most recent previous Day's High. Formula:

[Col C−(Col C−1)]

AJ) Change in Low Price (Low Chnge) This is the Change in Low Price from the most recent previous Trading Day's Low Price. It is calculated by subtracting the current day's Low from the most recent previous Day's Low. Formula:

[Col D−(Col D−1)]

AK) Five-day Max High Price (5-day Max) This is the Highest Price the stock was traded in the most recent five-day period. It is calculated by isolating the most recent five-day High. Formula:

[Select highest value of:(Col C±0 thru Col C−4)]

AL) Range of Day's Low to Five-Day High Price (Low to 5-Day High or Rug D to AK) This is the range of trading prices over the most recent five-day period, from the 5-day highest price traded to the current day's Low. It is calculated by subtracting the Day's Low (Col D) from the Five-day Max High Price (Col AK). Formula:

(Col AK−Col D)

AM) Day's Low as Percentage of Five-Day Max High Price (Low % of Col AK or Col D % of Col AK or D % of AK) This is the percentage the day's Low to Five-Day Max (Col AK). It is calculated by dividing Col D by 1% of Col AK. Formula:

Col D+[(Col AK)×0.01]

AN) Five-day Minimum Low Price (5-day Low) This is the Lowest Price the stock was traded in the most recent five-day period. It is calculated by isolating the most recent five-day Low. Formula:

[Select lowest value of:(Col D+0 thru Col D−4)]

AO) Open Price Change to Prior Close (Open to Prr Cls or Opn:Prr Cls) This is the Change in Trading Price of the Open to the most recent Prior Close. It is calculated by subtracting the most recent prior closing price from the Day's Open. Formula:

[Col B−(Col E−1)]

AP) Five-day Average Daily Short Volume (ADSV 5) This is the Average Daily Short Volume for the most recent Five-day trading period, including the current day's trading. It is calculated by adding the Daily Short Volumes of the current Day plus the most recent previous four days and dividing that total by five. Formula:

[vol(Col O±0 thru Col O−4)]+5

AQ) Ten-day Average Daily Short Volume (ADSV 10) This is the Average Daily Short Volume or the most recent Ten-day trading period, including the current day's trading. It is calculated by adding the Daily Short Volumes of the current Day plus the most recent previous nine days and dividing that total by ten. Formula:

[vol(Col O±0 thru Col O−9)]+10

Note 30: As the number of days varies between SI Report Period Last Trade Dates, for this formula, “(Col M−1)” represents the entry of the most recent previous Short Interest Last Trade Date (SILTD).

AR) Change in Short Interest from Previous Report Period Short Interest (SI Chnge) This is the Change in Short Interest from the most previous Short Interest Report Period to the Current Short Interest Report Period. It is calculated by subtracting the current Short Interest of the Report Period Short Interest from the most recent previous Report Period Short Interest. Formula:

[Col M−(Col M−1)]

AS) Day's Low to 5-Day High Max Price Range as Percentage of 5-Day High (ColAL % ColAK or AL % AK) This is the range of the Day's Low to 5-Day Max High Price as a percentage of the 5-Day Max High Price. It is calculated by dividing the day's low to 5-day max high price range (ColAL) by 1% of 5-day max high price (Col AK). Formula:

Col AL+[(Col AK)×0.01]

AT) Sum of Trading Volume for Current Short Interest Report Period (TotSI RP Vol or ColM RPVol) This is the Sum of Daily Trading Volumes over the specified time period beginning at the start of trading at the open of the first trading day after the previous SI Report Period's Last Trade Date close of trading to the close of trading on the current SI Report Period's Last Trade Date. It is calculated by adding the daily trading volumes within normal trading hours for each day the equity trades in the given period. Formula:

(Find Sum of Daily Trading Volumes During Normal Trading Hours for Current Short Interest Report Period)

AU) Change in Short Interest from Previous Report Period as Percentage of Total Report Period Volume (AR % of AT) This is the Current Change in Short Interest as a Percentage of the Total Trading Volume in the Current Report Period. It is calculated by dividing the Change in Short Interest from Previous Report Period by 1% of the Total Report Period Volume. Formula:

Col AR+[(Col AT)×0.01]

AV) Five-Day Net Change in Fails to Deliver [Col I−(Col I−4)] This is the Net Change in FTDs over the course of the most recent Five-day period. It is calculated by subtracting the FTD number of (Col I−4) from the FTD number for Col I. Formula:

[Col I−(Col I−4)]

AW) Ten-Day Cumulative Trading Volume [Sum(F+0 thru F−9)] This is the Sum of the Trading Volumes at the Close of Trading of the Current Day's Volume plus the Closing Volumes of the previous Nine Days. It is calculated by adding the current Day's regular hour Trading Volume plus the regular trading hours volumes of the previous nine days. Formula:

[Sum(Col F+0 thru Col F−9)]

AX) Five-Day Cumulative Daily Short Volume [Sum(O thru O−4)] This is the Sum of the Daily Short Volumes at the Close of Trading of the Current Day's Short Volume plus the Closing Daily Short Volumes of the previous Four Days. It is calculated by adding the current Day's regular trading hour Daily Short Volume plus the regular trading hours' daily short volumes of the previous four days. Formula:

[Sum(Col O±0 thru Col O−4)]

AY) Ten-Day Cumulative Daily Short Volume [Sum(O thru O−9)] This is the Sum of the Daily Short Volumes at the Close of Trading of the Current Day's Short Volume plus the Closing Daily Short Volumes of the previous Nine Days. It is calculated by adding the current Day's regular trading hour Daily Short Volume plus the regular trading hours' daily short volumes of the previous nine days. Formula:

[Sum(Col O±0 thru Col O−9)]

AZ) Price Range as Percentage of Previous Close (G % of E) This is the Day's Price Range as a Percentage of the Previous Day's Close. It is calculated by dividing the Day's price Range by 1% of the Previous Day's Close. Formula:

Col G+[(Col E−1)×0.01]

BA) Sum of Daily Short Volume for Current Short Interest Report Period (TotShortVol SIRP or TotCol O of Col M Period) This is the Total Short Volume over the specified time period beginning at the start of trading at the open of the first trading day after the previous SI Report Period's Last Trade Date close of trading to the close of trading on the current SI Report Period's Last Trade Date. It is calculated by adding the Daily Short Volumes within normal trading hours for each day the equity trades in the given period. Formula:

(Find Sum of Daily Short Volumes During Normal Trading Hours for Current Short Interest Report Period)

BB) Sum of Total Daily Short Volume for Current Short Interest Report Period and Most Recent Previous Short Interest [Col BA+(Col M−1)] This is the sum of the Total Daily Short Volume for the Current Short Interest Report Period (Col BA) added to the Most Recent Previous Short Interest (ColM−1). Formula:

[Col BA+(Col M−1)]

BC) Opening Price Change As Percentage of Previous Opening Price (Col AH % Cng) This is the Opening Price Change as a Percentage of the Previous Open. It is calculated by dividing the Change in Opening Price from the Previous Opening Price by One Percent of the Previous Open. Formula:

Col AH÷[(Col B−1)×0.01]

BD) Change in High Price As Percentage of Previous High Price (Col AI % Cng) This is the High Price Change as a Percentage of the Previous High. It is calculated by dividing the Change in High Price from the Previous High Price by One Percent of the Previous High. Formula:

Col AI÷[(Col C−1)×0.01]

BE) Change in Low Price As Percentage of Previous Low Price (Col AJ % Cng) This is the Low Price Change as a Percentage of the Previous Low. It is calculated by dividing the Change in Low Price from the Previous Low by One Percent of the Previous Low. Formula:

Col AJ÷[(Col D−1)×0.01]

BF) Open Price Change to Prior Close As Percentage of Prior Closing Price (Col AO % Col E−1) This is the Opening Price Change to the Previous Close as a Percentage of the Prior Close. It is calculated by dividing the Change in Opening Price from the Prior Close by One Percent of the Prior Close. Formula:

Col AO÷[(Col E−1)×0.01]

BG) Change in Short Interest from Previous Report Period As Percentage of Short Interest of Previous Report Period (Col AR % Col M−1) This is the Report Period Short Interest Change as a Percentage of the Previous Report Period Short Interest. It is calculated by dividing the Change in the Report Period Short Interest from the Previous Report Period Short Interest by One Percent of the Previous Report Period Short Interest. Formula:

Col AR÷[(Col M−1)×0.01]

BH) Daily Short Volume as a Percentage of the Five-day Average Daily Short Volume (Col O % Col AP) This is the Day's Short Volume as a Percentage of the Five-day Average Daily Short Volume. It is Calculated by dividing the Day's Short Volume by One Percent of the Five-day Average Daily Short Volume. Formula:

Col O÷[Col AP×0.01]

BI) Daily Short Volume as a Percentage of the Ten-day Average Daily Short Volume (Col O % Col AQ) This is the Day's Short Volume as a Percentage of the Ten-day Average Daily Short Volume. It is Calculated by dividing the Day's Short Volume by One Percent of the Ten-day Average Daily Short Volume. Formula:

Col O÷[Col AQ×0.01]

BJ) Change in the Sum of Total Daily Short Volume for Current Short Interest Report Period and Most Recent Previous Short Interest from the Previous Sum of Total Daily Short Volume for Current Short Interest Report Period and Most Recent Previous Short Interest . . . [Col BB−(Col BB−1)] This is the Change in the sum of the Total Daily Short Volume for the Current Short Interest Report Period (Col BA) added to the Most Recent Previous Short Interest (Col M 1) from the Previous Sum of Total Daily Short Volume for Current Short Interest Report Period and Most Recent Previous Short Interest (Col BB−1). Formula:

[Col BB−(Col BB−1)]

BK) Sum of Daily Trading Volume for Current Short Interest Report Period (Sum Col F of Col M Period) This is the Sum of Daily Trading Volume during normal trading hours for the entire current Short Interest Report Period. It is calculated by adding all the Daily Trading Volume for the current Short Interest Report Period. Formula:

(Sum Col F of Col M Period)

BL) Subtraction of Sum of Total Daily Short Volume for Current Short Interest Report Period and Most Recent Previous Short Interest from Total Daily Trading Volume for Current Short Interest Report Period (Col BK−Col BB) This is the difference between the Sum of Total Daily Short Volume for Current Short Interest Report Period and Most Recent Previous Short Interest from Total Daily Trading Volume for Current Short Interest Report Period. Formula:

(Col BK−Col BB)

BM) Sum of the Total Daily Short Volume for the Current Short Interest Report Period minus the Change in Short Interest from the Previous Short Interest Report Period (Col BA−Col AR) This is the difference between the Sum of Total Daily Short Volume for Current Short Interest Report Period minus the Change in Short Interest from the Previous Short Interest Report Period. It is calculated by subtracting the Change in Short Interest in the Current Short Interest Report Period from the Previous Short Interest Report Period from the Sum of Total Daily Short Volume for Current Short Interest Report Period. Formula.

(Col BA−Col AR)

BN) The Closing Price on the Last Trade Date for the Current Short Interest Report Period (Col E at Col W/SILTD)* This is the Closing Price recorded in Col E for the Last Trade Date of the Current Short Interest Report Period. It is a simple repeat of that cell's entry for that specific date, recorded here on that same date. Recorded in the spreadsheet on each SILTD for this Column. *SILTD: Short Interest Last Trade Date see Col W sub-entry Short Interest Last Trade Date (SILDT) above.

BO) Change in the Closing Price of the Last Trade Date of the Current Short Interest Report Period from the Closing Price of the Last Trade Date of the Previous Short Interest Report Period [Col BN−(Col BN−1)] This is the Change in Closing Price of the Last Trade Date of the Current Short Interest Report Period from the Closing Price of the Last Trade Date of the Previous Short Interest Report Period. It is calculated by subtracting the Closing Price of the Last Trade Date of the Previous Short Interest Report Period from the Closing Price of the Last Trade Date of the Current Short Interest Report Period. Recorded in the spreadsheet on each SILTD for this Column. Formula:

[Col BN−(Col BN−1)]

BP) Change in the Closing Price of the Last Trade Date of the Current Short Interest Report Period from the Closing Price of the Last Trade Date of the Previous Short Interest Report Period as a Percentage of that Closing Price of the Last Trade Date of the Previous Short Interest Report Period [Col BO % of (Col BN−1)] This is the Percentage of the Change in the Closing Price of the Last Trade Date of the Current Short Interest Report Period from the Closing Price of the Last Trade Date of the Previous Short Interest Report Period to that Closing Price of the Last Trade Date of the Previous Short Interest Report Period Recorded in the spreadsheet on each SILTD for this Column. It is calculated by dividing that Change by 1% of the prior entry for Col BN or (Col BN−1). Formula:

Col BO−[(Col BN−1)×0.01]

BQ) Five-day Net Change in Closing Price [Col E−(Col E−4)] This is the Net Change in Closing Price over the most Recent Five Trading Days, Including this Day's Close. It is calculated by subtracting the Close of Four Trading Days Prior from this Day's Close. Formula:

Col E−(Col E−4)

BR) Ten-Day Net Change in Closing Price [Col E−(Col E−9)] This is the Net Change in Closing Price over the most Recent Ten Trading Days, Including this Day's Close. It is calculated by subtracting the Close of Nine Trading Days Prior from this Day's Close. Formula:

Col E−(Col E−9)

Note 31: In several sections to follow, a limited series of selected columnar Changes of Direction will be logged. These Changes of Direction are only referent to each entry's most prior entry and do not necessarily infer either a continuation of or a change of any change from the entry immediately prior to its own prior entry.

Note 32: What follows is a set of basic indicators for noting changes in cell entry data. These designating indicators can be any set of three preassigned possibilities, so long as they are predefined and consistent in their usage. Each is a measure of the Direction of Change from its most recent cell entry. Each is simply an indicator of: a change up (1); a change down (2); or, no change (0) but the “no change (0)” covers a small range from its previous entry of (±0.02%). Anything that exceeds that range of change is automatically classified as a change up (1) or a change down (2), respectively.

Note 33: In this section, there are occasionally options of which Columnar Identification is used for determination of Direction of Change. For instance, to identify the Direction of Change in the Low (Col D), the option to use Change in Low Price (Col AJ) exists, but for expediency and consistency in the approach of this Process Description, in most cases the initial or most basic source of a specific entry change from its most immediate prior is to be used. The option to use another Column that would achieve the same results is up to the constructor, so long as the results are the same.

Note 34: Regardless of what specific designations are used, there is no inferred valuation by any specific choice of indicator, so long as consistency is maintained. The indicators could just as easily be arrows (↑, ↓, [symbol] ); punctuation marks (!, “, #); geometric shapes (▴, ▾, ♦) or any other set, so long as it is accurately defined and consistently used.

Note 35: This series commences with Column Designation “CA”

CA) Direction of Change in the High Entry: “1”; “2”; “0” (DirCng Col C)

CB) Direction of Change in the Low Entry: “1”; “2”; “0” (DirCng Col D)

CC) Direction of Change in the Close Entry: “1”; “2”; “0” (DirCng Col E)

CD) Direction of Change in the Daily Volume Entry: “1”; “2”; “0” (DirCng Col F)

CE) Direction of Change in the Fails to Deliver Entry: “1”; “2”; “0” (DirCng Col I)

CF) Direction of Change in the Short Interest Entry: “1”; “2”; “0” (DirCng Col M)

CG) Direction of Change in the Short Volume Entry: “1”; “2”; “0” (DirCng Col O)

CH) Direction of Change in the Open Entry: “1”; “2”; “0” (DirCng Col B)

CI) Direction of Change in the Open Price to Prior Close Entry: “1”; “2”; “0” (DirCng Col AO)

CJ) Direction of Change in the The Closing Price on the Last Trade Date for the Current Short Interest Report Period Entry: “1”; “2”; “0” (DirCng Col BN)

(Column designations CK thru DZ are held in reserve.)

This concludes the Secondary Level of Assembling spreadsheet Columns that comprise a non-definitive, non-conclusive variety or array of the Inter- and/or Infra-Row and/or Inter- and/or Infra-Columnar Pre-algorithmic and/or Algorithmic analyses of date-specific entry results as each relational specification requires following the Primary Level of Assembling the Various Data Bases of Individual Stock Equities and Attendant Matters and Issues that Facilitate A Process for the Detection and Identification of Idiosyncratic Valuations by Intent in Equities Commerce and Other Illegal Equity Trades in U.S. Domestic Stock Markets.

### Tertiary Level

What follows is the Tertiary Level of Assembling spreadsheet Columns, one that comprises a non-definitive, non-conclusive variety or array of the Inter- and/or Infra-Row and/or Inter- and/or Infra-Columnar Pre-algorithmic and/or Algorithmic analyses of date-specific entries, particularly those that compare entries from additional Rows and/or Columns not Trade Date-identical to the individual Row or Column in comparison but rather Inter-Trade Date-relational within the formula-specific entry Columnar or Row field. Relevant Descriptions, Explanations and Notes from prior Sections above also apply below. These calculations assist in whole, in part and/or in conjunction with other Column and/or Row entries with specific entries in refining, defining, clarifying and/or specifying A Process for the Detection and Identification of Idiosyncratic Valuations by Intent in Equities Commerce and Other Illegal Equity Trades in U.S. Domestic Stock Markets.

Note 36: In this Section and subsequent sections, the primary focus will be the establishment of time-relational factors and the effects they elicit in, to, on and from the Trading Data.

Note 37: In this Section and subsequent sections, there will be significant yet limited related serial comparisons of various Trading Data and the changes associated with that data leading up to, on, after and cumulative Trade Date relevance, as well as facilitating these comparisons to specific Items*. *Items can include but are not limited to: Dates/Times; Prices; Share Volumes; Company SEC Filings including both Filing and Reference Dates and those with multiple Reference Dates; Company Press Releases; the multitude of Listed and Potential External Events; etc. Referred to as “Items of Focus” or “Items of Interest”.

Note 38: In this Section and subsequent sections, the use of the term “current Trade Date” is the specific Trade Date (Row) the Item being serially compared (in its appropriate Column) as entered in the Company-specific Spreadsheet and in the relevant Company-specific Appendix.

Note 39: In this Section and subsequent sections, multiple sequences from multiple Column entries are to facilitate serial comparisons and their potential relationship(s) to the Items of Focus.

Note 40: In this Section and subsequent sections, in the majority of related serial comparisons, serialization will be in seven-day sequences: from four days prior to two days after with the current day's entry (the seventh day by number but near the middle of the sequence) included.

Note 41: In this Section and subsequent sections, most if not all of the relative daily changes are likely to have been previously entered in the appropriate Columns, respectively.

If not, then an appropriate Column shall be created to facilitate that respective relational change as well.

Note 42: In this Section and subsequent sections, where appropriate or necessary, percentages of change and/or ratio comparison will be provided their own Columns.

Note 43: In this Section and subsequent sections, after the initial Column entry and attendant description, the remaining serial component subject entries shall be designated by the single- or double-letter Column I.D., the specific Col x along with the appropriate “−” or “+” sign and the specific numeric designation indicating the number of days prior or after, respectively, but any further description is foregone as self-explanatory by previous and current Sectional Notes, Rules and Descriptions and should therefore be unnecessary.

Note 44: In most cases in this Section and subsequent sections, the initial Entry Column for each serial comparison segment will be aligned to the earliest comparison Trade Date (not necessarily the latest Trade Date the equity itself traded on) and progress through the series.

Note 45: In this Section and subsequent sections, the Column designation for the current Trade Date shall be a “+0” indicating neither a subtractional nor additional change to the current Trade Date entry for the series.

Note 46: In this Section and subsequent sections, when formula are necessary, the Notes, Rules and Descriptions of and for Formulas in prior Sections shall apply as well.

Note 47: In this Section and subsequent sections, each entire serial comparison set shall begin with the initial, oldest Column entry for the Daily Value in that Column's serial segment.

Note 48: In this Section and subsequent sections, there will be three “value” sets: Closing Price; High Price; and Low Price. Each of these will have seven Columns followed by four Columns, the first being the nominal Trading Range of the first four serial days including the respective Columnar entry from the Trade Date immediately prior to that earliest Trading Date (Trade Date−4) of the current serial comparison, the second being the percentage of that adjusted nominal Trading Range to the respective Columnar entry of the Trade Date immediately prior to that earliest Trading Date (Trade Date−4) of the current serial comparison (See Note: 49 for “Adjustment of the Trading Range”), the third being the adjusted nominal Trading Range of the two days immediately following the close of the current Trade Date including the respective Columnar entry of the current Trade Date, and the fourth being the percentage of that adjusted nominal Trading Range to the respective Columnar entry of the Trade Date of the current serial comparison. (This four Column component is described further in Note: 49 below.) These eleven Columns will be followed by two additional Columns, the first consisting of the Trading Range of the entire seven-day period including the respective Columnar entry from the earliest Trading Date (Trade Date 4) of the current serial comparison and the last being a final Column that displays the percentage that change represents to the respective Columnar entry immediately prior to that current seven-day Trading Range. These three “value” sets are followed by three “volume” sets: Daily Volume; Quantity of Fails to Deliver (FTDs); Daily Short Volume; each consisting of the same seven-day initial entry comparison series. Sub-note: The direction of change noted elsewhere in other earlier and subsequent columns related to each section segment includes one designated as “Col x−4” is for purposes of establishing a “trend” immediately prior to the relevant Trade Date minus 3 retroactive alteration for the current Trade Date Item immediacy and its influence on the Trading Data being evaluated for that given Trade Date.

Note 49: In this Section, when calculating each of the Trading Ranges noted above, the net direction shall also function as a cap or limiter or boundary on the high or low prices, depending on the direction indicated but only for determining the percentage of that nominal Trading Range to its respective comparative. In the first segment, consisting of five trading days, if the net direction is down, then any trading prices within that period that are higher than the Columnar entry Price of that earliest Trading Date of the current serial comparison (Trade Date−4) shall be ignored or not included. If the net direction is up, then any trading prices within that period that are lower than the Columnar entry Price of that earliest Trading Date of the current serial comparison (Trade Date−4) shall be ignored or not included. That adjusted range shall be the Trading Range used to determine the percentage of that nominal Trading Range to the respective Columnar entry of that earliest Trading Date of the current serial comparison (Trade Date−4). Like-wise, in the second segment, consisting of two trading days, if the net direction is down, then any trading prices within that period that are higher than the Closing Price of the current Trade Date serial comparison entry (Col x+0) shall be ignored or not included. If the net direction is up, then any trading prices within that period that are lower than the Closing Price of the current Trade Date serial comparison (Col x+0) shall be ignored or not included. That adjusted range shall be the Trading Range used to determine the percentage of that nominal Trading Range to the respective Columnar entry of the Trade Date of the current serial comparison.

Note 50: In this Section, other than in the formula used to calculate that adjustment, it shall be assumed in all other reference to the Trading Range described in Notes 48 & 49 is the Adjusted Trading Range being referred to but only those that are referring to those specific trading ranges, not other Trading Ranges.

Note 51: In this Section, the first (four-day) Adjusted Trading Range shall be designated in the abbreviated Columnar Names as well as in the abbreviated Columnar entries and used in Formula as “TR-A of Col x” or simply “TR-A of x” or simplest “TRA x” and the second (two-day) Adjusted trading range as “TR-B of Col x” or simply “TR-B of x” or simplest “TRB x”. In any case, the intended resulting value is the same.

Note 52: In this Section, the use of the simplified designation of either Adjusted Trading Range in the designation of such or calculating its respective percentage to its respective comparative shall be considered the same as though used in full title.

Note 53: In this Section and subsequent sections, the number of Columns for each serial comparison of Price-Related Data—Closing Price; Daily High; Daily Low—will be thirteen, comprised of: seven days of specific columnar Trading Data; two nominal Trading Range figures; two relational percentage calculations; one Column noting the total seven-day serial net change in Column-specific Prices from the Column-specific Price of the first Trading Date of the current serial comparison to the Column-specific Price of the last Trading Date of the current serial comparison; and, a final Column that displays the percentage that change represents. Treatment of the Trading Range of the full seven-day period shall be the same as the five-day and two day periods, including the use of an Adjusted Trading Range for comparative net percentage change.

Note 54: In this Section and subsequent sections, the number of serial comparisons will be six, comprised of and in regards to: Closing Price; Daily High; Daily Low; Daily Volume; Quantity of Failure to Deliver Shares (FTDs); Daily Short Volume. Additional serial comparisons may/will be constructed in future serial comparison versions to include other Company-specific spreadsheet data as well as non-Company-specific spreadsheet data such as various Stock Sector and Exchange Indices' data, compiled once the full spectrum of data bases are acquired and initially run for each Trading Date for each equity. Also, internal (same equity) Standard Deviations will be established for statistically significant variance in each Column for comparative purposes in one or more successor process description levels but only after these initial columnar data are run, thus establishing the criteria for calculating any standard deviation of the subject field.

Note 55: In this Section and subsequent sections, serial comparisons (Daily Volume; FTDs; Daily Short Volume; etc.) that are not specifically Price-Related (Closing Price; Daily High; Daily Low; etc. or Trading Range) will normally have seven Columns per series that correspond to the first seven Columns in the Price-related serial comparisons, also referred to as Daily Trading Date Relationals below, plus three Columns indicating a numeric Change in each of the volumes from Col x−4 to Col x+0; and, Col x+0 to Col x+2; and, Col x−4 to Col x+2, also known as Multi-Trade Date Relationals below. The other Price-Related-type comparisons are not particularly revealing as configured in these non-specifically Price-Related serial comparisons.

Note 56: In this Section, while other serial comparisons that are not specifically price related are not particularly revealing as configured in the types of serial comparisons presented in this, the Tertiary Level, their corresponding daily percentage changes having been calculated in previous or succeeding Columns can reveal pertinent information, when used in focused, full, time-relative context. However, those uses will be better seen and have greater impact in the Quaternary and Quinary Levels so are foregone here.

Note 57: Columnar Identification from the Secondary Level above, CK thru DZ, are held in reserve.

Note 58: In this Section and subsequent sections, while daily changes have been noted in earlier sections in prior levels, they have been independent of each other, both vertically and horizontally. It is in this and subsequent sections that a wider scope of cause, influence and effect are drawn yet still within the bounds of relevance—to themselves, to each other and to entire sections, based on relative proximity to each Trade Date being examined. It is in this grouping of prior entries that patterns and relevance begin to be revealed.

Note 59: This is the first phase of determining base comparisons of change and the first seven columns of each set are only simple numeric changes. The second set of full “percentage of change” phase follows and the third set of full “directional indicators” follows after that.

Note 60: In this section and all following sections in all subsequent levels, under circumstances of comparative ranges, aggregation collections, multi-trading date changes, etc. where there are considerations of X−4 (“X” being a given Trading Date under consideration and the given category of that Trading Date) on or after Sep. 5, 2017, the oldest initial Trading Date (X−x) will be the specific Trading Date and category minus three (X−3) since it was that date that the Settlement Date was changed from Trade Date+3 to Trade Date+2. All necessary adjustments will be presumed to have been taken into account to accommodate this change.

Note 61: Columnar Identification will proceed with double-alphabetic designation Column Ex beginning here.

### Trade Date Serial Comparison Columns as Follows First Phase Determining Base Comparisons of Change Base Comparisons for Change Columns Array

EA thru EM) Item: Company Specific Series Change Part One—Daily Closing Price This Series (Part One or Col E Daily Closing Price) compares the Daily Closing Price Change beginning with the change in Closing Price of the current Trade Date minus four Trade Dates from its previous Closing Price entry (current Trade Date minus five Trading Dates or Col E−5) thru the Closing Price of the current Trade Date plus two Trade Dates. It also includes: the adjusted trading ranges A and B and their respective percentages of respective Closing Prices as described in the note(s) above; the total serial net Closing Price change from first (Col E−4) to last (Col E+2) Closing Prices; and, the percentage that change represents from the first Closing Price (Col E−4). Columnar Designations are:

EA) Col E−4 (E−4); EB) Col E−3 (E−3); EC) Col E−2 (E−2);

ED) Col E−1 (E−1); EE) Col E±0 (E±0); EF) Col E+1 (E+1);

EG) Col E+2 (E+2); EH) TR-A of Col E (TR-A of E);

EI) TRA E % of Col E−4 (TRA E % of E−4); EJ) TR-B of Col E (TR-B of E);

EK) TRB E % of Col E (TRB E % of E); EL) Col E−4 to Col E+2 (E−4 to E+2);

EM) Col EL % of Col E−4 [EL % (E−4)]

EN thru EZ) Item: Company Specific Series Change Part Two—Daily High Price This Series (Part Two or Col C Daily High Price) compares the Daily High Price Change beginning with the change in High Price of the current Trade Date minus four Trade Dates from its previous High Price entry (current Trade Date minus five Trading Dates or Col C−5) thru the High Price of the current Trade Date plus two Trade Dates. It also includes: the adjusted trading ranges A and B and their respective percentages of respective High Prices as described in the note(s) above; the total serial net High Price change from first (Col C−4) to last (Col C+2) High Prices; and, the percentage that change represents from the first High Price (Col C−4). Columnar Designations are:

EN) Col C−4 (C−4); EO) Col C−3 (C−3); EP) Col C−2 (C−2);

EQ) Col C−1 (C−1); ER) Col C+0 (C+0); ES) Col C+1 (C+1);

ET) Col C+2 (C+2); EU) TR-A of Col C (TR-A of C);

EV) TRA C % of Col C−4 (TRA C % of C−4); EW) TR-B of Col C (TR-B of C);

EX) TRB C % of Col C (TRB C % of C); EY) Col C−4 to Col C+2 (C−4 to C+2);

EZ) Col EY % of Col C−4 [EY % (C−4)]

FA thru FM) Item: Company Specific Series Change Part Three—Daily Low Price This Series (Part Three or Col D Daily Low Price) compares the Daily Low Price Change beginning with the change in Low Price of the current Trade Date minus four Trade Dates from its previous Low Price entry (current Trade Date minus five Trading Dates or Col D−5) thru the Low Price of the current Trade Date plus two Trade Dates. It also includes: the adjusted trading ranges A and B and their respective percentages of respective Low Prices as described in the note(s) above; the total serial net Low Price change from first (Col D−4) to last (Col D+2) Low Prices; and, the percentage that change represents from the first Low Price (Col D−4). Columnar Designations are:

FA) Col D−4 (D−4); FB) Col D−3 (D−3); FC) Col D−2 (D−2);

FD) Col D−1 (D−1); FE) Col D+0 (D+0); FF) Col D+1 (D+1);

FG) Col D+2 (D+2); FH) TR-A of Col D (TR-A of D);

FI) TRA D % of Col D−4 (TRA D % of D−4); FJ) TR-B of Col D (TR-B of D);

FK) TRB D % of Col D (TRB D % of D); FL) Col D−4 to Col D+2 (D−4 to D+2);

FM) Col FL % of Col D−4 [FL % (D−4)]

FN thru FW) Item: Company Specific Series Change Part Four—Daily Volume This Series (Part Four or Col F−Daily Volume) compares the Daily Volume Change beginning with the change in Daily Volume of the current Trade Date minus four Trade Dates from its previous Daily Volume entry (current Trade Date minus five Trading Dates or Col F−5) thru the Daily Volume of the current Trade Date plus two Trade Dates. Columnar Designations are:

FN) Col F−4 (F−4); FO) Col F−3 (F−3); FP) Col F−2 (F−2); FQ) Col F−1 (F−1);

FR) Col F+0 (F+0); FS) Col F+1 (F+1); FT) Col F+2 (F+2);

FU) Col F−4 to Col F±0 (F−4 to F+0); FV) Col F+0 to Col F+2 (F+0 to F+2);

FW) Col F−4 to F+2 (F−4 to F+2)

FX thru GG) Item: Company Specific Series Change Part Five—Fails to Deliver This Series (Part Five or Col I Fails to Deliver or FTDs) compares the FTDs Change beginning with the change in FTDs of the current Trade Date minus four Trade Dates from its previous FTDs entry (current Trade Date minus five Trading Dates or Col I−5) thru the FTDs of the current Trade Date plus two Trade Dates. Columnar Designations are:

FX) Col I−4 (I−4); FY) Col I−3 (I−3); FZ) Col I−2 (I−2); GA) Col I−1 (I−1);

GB) Col I+0 (I+0); GC) Col I+1 (I+1); GD) Col I+2 (I+2);

GE) Col I−4 to Col I+0 (I−4 to I+0); GF) Col I±0 to Col I+2 (I+0 to I+2);

GG) Col I−4 to I+2 (I−4 to I+2)

GH thru GQ) Item: Company Specific Series Change Part Six—Daily Short Volume This Series (Part Six or Col O—Daily Short Volume) compares the Daily Short Volume Change beginning with the change in Daily Short Volume of the current Trade Date minus four Trade Dates from its previous Daily Short Volume entry (current Trade Date minus five Trading Dates or Col O−5) thru the Daily Short Volume of the current Trade Date plus two Trade Dates. Columnar Designations are:

GH) Col O−4 (O−4); GI) Col O−3 (O−3); GJ) Col O−2 (O−2);

GK) Col O−1 (O−1); GL) Col O±0 (O+0); GM) Col O+1 (O+1);

GN) Col O+2 (O+2); GO) Col O−4 to Col O+0 (O−4 to O+0);

GP) Col O±0 to Col O+2 (O±0 to O+2);

GQ) Col O−4 to O+2 (O−4 to O+2)

### Second Phase of Base Comparisons of Change

### Base Comparisons for Percentages of Change Columns Array

Note 62: In this section, the Percentages of Change for each of the seven comparatives plus the multi-date trading ranges net changes for each of the six Parts above are entered. It is these percentage numbers as well as the Adjusted Trading Range Percentages of Change in the first three Parts that are to be of importance in the Quaternary Level. While there are entries of percentage of change existing in earlier Columns for many or most of the entries to follow, those and the others not calculated to this point will be entered here as a set. For simplification purposes, only the Column information entries will be shown as explanations should be unnecessary.

GR thru HA) Item: Company Specific Series Percentages of Change Part One—Daily Closing Price This Series (Part One or Col E Daily Closing Price) calculates the Percentages of Change the numeric changes series shown above represent. Only percentages are calculated and shown. Specific Formula are implied by “Percent Change” and “(% Cng)” from previous columnar entry being implied to each entry.

GR) Col E−4% Cng (E−4% Cng); GS) Col E−3% Cng (E−3% Cng);

GT) Col E−2% Cng (E−2% Cng); GU) Col E−1% Cng (E−1% Cng);

GV) Col E±0% Cng (E±0% Cng); GW) Col E+1% Cng (E+1% Cng);

GX) Col E+2% Cng (E+2% Cng);

GY) Col E−4 to Col E±0% Cng (E−4 to E±0% Cng);

GZ) Col E±0 to Col E+2% Cng (E+0 to E+2% Cng);

HA) Col E−4 to Col E+2% Cng (E−4 to E+2% Cng)

HB thru HK) Item: Company Specific Series Percentages of Change Part Two—Daily High Price This Series (Part Two or Col C Daily High Price) calculates the Percentages of Change the numeric changes series shown above represent. Only percentages are calculated and shown. Specific Formula are implied by “Percent Change” and “(% Cng)” from previous columnar entry being implied to each entry.

HB) Col C−4% Cng (C−4% Cng); HC) Col C−3% Cng (C−3% Cng);

HD) Col C−2% Cng (C−2% Cng); HE) Col C−1% Cng (C−1% Cng);

HF) Col C±0% Cng (C±0% Cng); HG) Col C+1% Cng (C+1% Cng);

HH) Col C+2% Cng (C+2% Cng);

HI) Col C−4 to Col C±0% Cng (C−4 to C±0% Cng);

HJ) Col C±0 to Col C+2% Cng (C+0 to C+2% Cng);

HK) Col C−4 to Col C+2% Cng (C−4 to C+2% Cng)

HL thru HU) Item: Company Specific Series Percentages of Change Part Three—Daily Low Price This Series (Part Three or Col D Daily Low Price) calculates the Percentages of Change the numeric changes series shown above represent. Only percentages are calculated and shown. Specific Formula are implied by “Percent Change” and “(% Cng)” from previous columnar entry being implied to each entry.

HL) Col D−4% Cng (D−4% Cng); HM) Col D−3% Cng (D−3% Cng);

HN) Col D−2% Cng (D−2% Cng); HO) Col D−1% Cng (D−1% Cng);

HP) Col D±0% Cng (D±0% Cng); HQ) Col D+1% Cng (D+1% Cng);

HR) Col D+2% Cng (D+2% Cng);

HS) Col D−4 to Col D±0% Cng (D−4 to D±0% Cng);

HT) Col D±0 to Col D+2% Cng (D±0 to D+2% Cng);

HU) Col D−4 to Col D+2% Cng (D−4 to D+2% Cng)

HV thru IE) Item: Company Specific Series Percentages of Change Part Four—Daily Volume This Series (Part Four or Col F—Daily Volume) calculates the Percentages of Change the numeric changes series shown above represent. Only percentages are calculated and shown. Specific Formula are implied by “Percent Change” and “(% Cng)” from previous columnar entry being implied to each entry.

HV) Col F−4% Cng (F−4% Cng); HW) Col F−3% Cng (F−3% Cng);

HX) Col F−2% Cng (F−2% Cng); HY) Col F−1% Cng (F−1% Cng);

HZ) Col F±0% Cng (F±0% Cng); IA) Col F+1% Cng (F+1% Cng);

IB) Col F+2% Cng (F+2% Cng);

IC) Col F−4 to Col F±0% Cng (F−4 to F±0% Cng);

ID) Col F to Col F+2% Cng (F±0 to F+2% Cng);

IE) Col F−4 to F+2% Cng (F−4 to F+2% Cng)

IF thru IO) Item: Company Specific Series Percentages of Change Part Five—Fails to Deliver This Series (Part Five or Col I Fails to Deliver or FTDs) calculates the Percentages of Change the numeric changes series shown above represent. Only percentages are calculated and shown. Specific Formula are implied by “Percent Change” and “(% Cng)” from previous columnar entry being implied to each entry.

IF) Col I−4% Cng (I−4% Cng); IG) Col I−3% Cng (I−3% Cng);

IH) Col I−2% Cng (I−2% Cng); II) Col I−1% Cng (I−1% Cng);

IJ) Col I±0% Cng (I±0% Cng); IK) Col I+1% Cng (I+1% Cng);

IL) Col I+2% Cng (I+2% Cng);

IM) Col I−4 to Col I±0% Cng (I−4 to I±0% Cng);

IN) Col I±0 to Col I+2% Cng (I±0 to I+2% Cng);

IO) Col I−4 to I+2% Cng (I−4 to I+2% Cng)

IP thru IY) Item: Company Specific Series Percentages of Change Part Six—Daily Short Volume This Series (Part Six or Col O—Daily Short Volume) calculates the Percentages of Change the numeric changes series shown above represent. Only percentages are calculated and shown. Specific Formula are implied by “Percent Change” and “(% Cng)” from previous columnar entry being implied to each entry.

IP) Col O−4% Cng (O−4% Cng); IQ) Col O−3% Cng (O−3% Cng);

IR) Col O−2% Cng (O−2% Cng); IS) Col O−1% Cng (O−1% Cng);

IT) Col O 0% Cng (O±0% Cng); IU) Col O+1% Cng (O+1% Cng);

IV) Col O+2% Cng (O+2% Cng)

IW) Col O−4 to Col O±0% Cng (O−4 to O±0% Cng);

IX) Col O±0 to Col O+2% Cng (O±0 to O+2% Cng);

IY) Col O−4 to O+2% Cng (O−4 to O+2% Cng)

(“Column designate ‘IZ’ has been skipped for convenience only. It is not by accidental omission.)

### Third Phase of Base Comparisons of Change

### Base Comparisons of Change Designation Indicators-Only Columns Array

Note 63: See Notes 31 thru 34, above for the descriptions of Change Designation Indicators, also referred to elsewhere in this Process Description as “Directional Indicators” or “DI” or “DIs”.

JA thru JJ) Item: Company Specific Series Change Designation Indicators-Only Part One—Daily Closing Price This Series (Part One or Col E Daily Closing Price) only displays the Change Designation Indicators appropriate to the relative entries in the First Phase of Determining Base Comparisons for Change Columns Array calculated by the numeric changes in the First Phase series shown above. Only the direction of change is shown, by “1” or “2” or “0” indicating “up” or “down” or “no change”, respectively. Column Title and Formula are as previous but with “Dir Cng” following initial Columnar entry.

JA) Col E−4 Dir Cng (E−4 Dir Cng); JB) Col E−3 Dir Cng (E−3 Dir Cng);

JC) Col E−2 Dir Cng (E−2 Dir Cng); JD) Col E−1 Dir Cng (E−1 Dir Cng);

JE) Col E+0 Dir Cng (E+0 Dir Cng); JF) Col E+1 Dir Cng (E+1 Dir Cng);

JG) Col E+2 Dir Cng (E+2 Dir Cng);

JH) Col E−4 to Col E+0 Dir Cng (E−4 to E+0 Dir Cng);

JI) Col E+0 to Col E+2 Dir Cng (E+0 to E+2 Dir Cng);

JJ) Col E−4 to Col E+2 Dir Cng (E−4 to E+2 Dir Cng)

JK thru JT) Item: Company Specific Series Change Designation Indicators-Only Part Two—Daily High Price This Series (Part Two or Col C Daily High Price) only displays the Change Designation Indicators appropriate to the relative entries in the First Phase of Determining Base Comparisons for Change Columns Array calculated by the numeric changes in the First Phase series shown above. Only the direction of change is shown, by “1” or “2” or “0” indicating “up” or “down” or “no change”, respectively. Column Title and Formula are as previous but with “Dir Cng” following initial Columnar entry.

JK) Col C−4 Dir Cng (C−4 Dir Cng); JL) Col C−3 Dir Cng (C−3 Dir Cng);

JM) Col C−2 Dir Cng (C−2 Dir Cng); JN) Col C−1 Dir Cng (C−1 Dir Cng);

JO) Col C+0 Dir Cng (C+0 Dir Cng); JP) Col C+1 Dir Cng (C+1 Dir Cng);

JQ) Col C+2 Dir Cng (C+2 Dir Cng);

JR) Col C−4 to Col C+0 Dir Cng (C−4 to C±0 Dir Cng);

JS) Col C to Col C+2 Dir Cng (C±0 to C+2 Dir Cng);

JT) Col C−4 to Col C+2 Dir Cng (C−4 to C+2 Dir Cng)

JU thru KD) Item: Company Specific Series Change Designation Indicators-Only Part Three—Daily Low Price This Series (Part Three or Col D Daily Low Price) only displays the Change Designation Indicators appropriate to the relative entries in the First Phase of Determining Base Comparisons for Change Columns Array calculated by the numeric changes in the First Phase series shown above. Only the direction of change is shown, by “1” or “2” or “0” indicating “up” or “down” or “no change”, respectively. Column Title and Formula are as previous but with “Dir Cng” following initial Columnar entry.

JU) Col D−4 Dir Cng (D−4 Dir Cng); JV) Col D−3 Dir Cng (D−3 Dir Cng);

JW) Col D−2 Dir Cng (D−2 Dir Cng); JX) Col D−1 Dir Cng (D−1 Dir Cng);

JY) Col D+0 Dir Cng (D+0 Dir Cng); JZ) Col D+1 Dir Cng (D+1 Dir Cng);

KA) Col D+2 Dir Cng (D+2 Dir Cng);

KB) Col D−4 to Col D+0 Dir Cng (D−4 to D+0 Dir Cng);

KC) Col D+0 to Col D+2 Dir Cng (D+0 to D+2 Dir Cng);

KD) Col D−4 to Col D+2 Dir Cng (D−4 to D+2 Dir Cng)

KE thru KN) Item: Company Specific Series Change Designation Indicators-Only Part Four—Daily Volume This Series (Part Four or Col F—Daily Volume) only displays the Change Designation Indicators appropriate to the relative entries in the First Phase of Determining Base Comparisons for Change Columns Array calculated by the numeric changes in the First Phase series shown above. Only the direction of change is shown, by “1” or “2” or “0” indicating “up” or “down” or “no change”, respectively. Column Title and Formula are as previous but with “Dir Cng” following initial Columnar entry.

KE) Col F−4 Dir Cng (F−4 Dir Cng); KF) Col F−3 Dir Cng (F−3 Dir Cng);

KG) Col F−2 Dir Cng (F−2 Dir Cng); KH) Col F−1 Dir Cng (F−1 Dir Cng);

KI) Col F+0 Dir Cng (F+0 Dir Cng); KJ) Col F+1 Dir Cng (F+1 Dir Cng);

KK) Col F+2 Dir Cng (F+2 Dir Cng);

KL) Col F−4 to Col F±0 Dir Cng (F−4 to F±0 Dir Cng);

KM) Col F to Col F+2 Dir Cng (F±0 to F+2 Dir Cng);

KN) Col F−4 to F+2 Dir Cng (F−4 to F+2 Dir Cng)

KO thru KX) Item: Company Specific Series Change Designation Indicators-Only Part Five—Fails to Deliver This Series (Part Five or Col I Fails to Deliver or FTDs) only displays the Change Designation Indicators appropriate to the relative entries in the First Phase of Determining Base Comparisons for Change Columns Array calculated by the numeric changes in the First Phase series shown above. Only the direction of change is shown, by “1” or “2” or “0” indicating “up” or “down” or “no change”, respectively. Column Title and Formula are as previous but with “Dir Cng” following initial Columnar entry.

KO) Col I−4 Dir Cng (I−4 Dir Cng); KP) Col I−3 Dir Cng (I−3 Dir Cng);

KQ) Col I−2 Dir Cng (I−2 Dir Cng); KR) Col I−1 Dir Cng (I−1 Dir Cng);

KS) Col I±0 Dir Cng (I+0 Dir Cng); KT) Col I+1 Dir Cng (I+1 Dir Cng);

KU) Col I+2 Dir Cng (I+2 Dir Cng);

KV) Col I−4 to Col I+0 Dir Cng (I−4 to I+0 Dir Cng);

KW) Col I±0 to Col I+2 Dir Cng (I±0 to I+2 Dir Cng);

KX) Col I−4 to I+2 Dir Cng (I−4 to I+2 Dir Cng)

KY thru LH) Item: Company Specific Series Change Designation Indicators-Only Part Six—Daily Short Volume This Series (Part Six or Col O—Daily Short Volume) only displays the appropriate Change Designation Indicators appropriate to the entries in the First Phase of Determining Base Comparisons for Change Columns Array calculated by the numeric changes in the First Phase series shown above. Only the direction of change is shown, by “1” or “2” or “0” indicating “up” or “down” or “no change”, respectively. Column Title and Formula are as previous but with “Dir Cng” following initial Columnar entry.

KY) Col O−4 Dir Cng (O−4 Dir Cng); KZ) Col O−3 Dir Cng (O−3 Dir Cng);

LA) Col O−2 Dir Cng (O−2 Dir Cng); LB) Col O−1 Dir Cng (O−1 Dir Cng);

LC) Col O±0 Dir Cng (O±0 Dir Cng); LD) Col O+1 Dir Cng (O+1 Dir Cng);

LE) Col O+2 Dir Cng (O+2 Dir Cng);

LF) Col O−4 to Col O DirCng (O−4 to O±0 Dir Cng);

LG) Col O±0 to Col O+2 Dir Cng (O±0 to O+2 Dir Cng);

LH) Col O−4 to O+2 Dir Cng (O−4 to O+2 Dir Cng)

This concludes the Tertiary Level of Assembling spreadsheet Columns that comprise a non-definitive, non-conclusive variety or array of the Inter- and/or Infra-Row and/or Inter- and/or Infra-Columnar Pre-algorithmic and/or Algorithmic analyses of date-specific entry, particularly those that compare entries from additional Rows and/or Columns not Trade Date-identical to the individual Row or Column in comparison but rather Inter-Trade Date-relational within the formula-specific entry Columnar or Row field. These calculations assisted in whole, in part and/or in conjunction with other Column and/or Row entries with specific entries in refining, defining, clarifying and/or specifying A Process for the Detection and Identification of Idiosyncratic Valuations by Intent in Equities Commerce and Other Illegal Equity Trades in U.S. Domestic Stock Markets.

### Quaternary Level

What follows is the Quaternary Level of Assembling spreadsheet Columns, one that comprises a non-definitive, non-conclusive variety or array of the Inter- and/or Infra-Row and/or Inter- and/or Infra-Columnar Pre-algorithmic and/or Algorithmic analyses of date-specific entries, particularly those that compare entries from the Tertiary Level Change Designation Indicators identifying parameters that establish patterns affiliated with non-trading specifics, previously noted as Items of Focus. The principal measures to be undertaken in this level will be calculating a range of Standard Deviations, some to determine normal patterns and others to determine deviant patterns. These calculations assist in whole, in part and/or in conjunction with other Column and/or Row entries with specific entries in refining, defining, clarifying and/or specifying A Process for the Detection and Identification of Idiosyncratic Valuations by Intent in Equities Commerce and Other Illegal Equity Trades in U.S. Domestic Stock Markets.

Note 64: In this section, a basic Standard Deviation is performed on most of the relevant percentages of change noted in the Primary, Secondary and Tertiary Levels. The Column titles in this section shall be simplified to indicate Standard Deviation “SD” of Column “x”, Column “x” simply being the various columns denoting referent percentages of change in their subject entries. Typical titling as well as Column entries' suggested abbreviations is as: Standard Deviation of Col O−FTD Percentage Change (SD of Col Q) indicates the Standard Deviation of Percentage of Change in FTDs from its immediately preceding entry in Col I; Col Q being the column in which the percentage of change in FTDs (Fails to Deliver) of the Trade Date being examined from its most previous entry was entered in the Company Specific Spreadsheet.

Note 65: Columnar Identification will proceed with double-alphabetic designation Column Mx beginning here.

MA) Standard Deviation of Col Q−FTD Percentage Change (SD of Col Q)

MB) Standard Deviation of Col S−Volume Percentage Change (SD of Col S)

MC) Standard Deviation of Col AA−Day's Short Volume Percentage Change (SD of Col AA)

MD) Standard Deviation of Col AB−Day's Short Volume as Percentage of Daily Volume (SD of Col AB)

ME) Standard Deviation of Col AC−Failures to Deliver (FTDs) as Percentage of Day's Volume (SD of Col AC)

MF) Standard Deviation of Col AD−FTD Change as Percentage of Day's Volume (SD of Col AD)

MG) Standard Deviation of Col AE−Price Range as Percentage of the Close

MH) Standard Deviation of Col AG−Closing Price Change As Percentage of Previous

Closing Price (SD of Col AG)

MI) Standard Deviation of Col AM−Day's Low as Percentage of Five-Day Max High Price (SD of Col AM)

MJ) Standard Deviation of Col AU−Change in Short Interest from Previous Report Period as Percentage of Total Report Period Volume (SD of Col AU)

MK) Standard Deviation of Col AZ−Day's Price Range as Percentage of Previous Close (SD of Col AZ)

ML) Standard Deviation of Col AE−Price Range as Percentage of the Close (SD of Col AE)

Note 66: In this section, the first Standard Deviation of Tertiary Level data will be calculated. In this part it will be the specific Percentages of Change in each of the Trade Date Serial Comparison Columns' Second Phase of Base Comparisons of Change, the Base Comparisons for Percentages of Change. Each column will represent the entry for the specific Trade Date Relational (Trade Date−4; Trade Date−3; etc. thru to Trade Date+2). As such, it will be assumed in this section that the relevant descriptives are included but are omitted here as they should be obvious. [Example: In calculating the Standard Deviation (SD) of Trade Date Relational Percentage of Change of Trade Date−2 for the Closing Price Part, the Column title would be “SD of Col GT” and it will represent the Standard Deviation of that specific Trade Date Relational specific entry (Closing Price) to the Trade Date being examined (Trade Date+0) in comparison to all other Trade Date Relationals in that specific category (Col E) relational (Trade Date−2).] This is not to declare this is the only possible method of specifying the column title but is only for convenience and consistency in this Process Descriptive. Otherwise, no matter the column title variance a constructor might choose or create, the meaning and intent is the same as is the specific relation it would have to the trade dates and other columns in the Process construct.

Note 67: Columnar Identification will proceed with double-alphabetic designation Column Nx beginning here.

NA thru NJ) Item: Company Specific Series Standard Deviation of Percentages of Change Part One—Daily Closing Price This Series (Part One or Col E Daily Closing Price) calculates the Standard Deviation of the percentages of change the numeric changes series shown above represent. Only the Standard Deviation of percentages of change relative to all of the Company-specific Daily Closing Prices are calculated and shown. Specific Formula are implied as described in Notes above.

NA) SD of Col GR (SD of Col E−4% Cng);

NB) SD of Col GS (SD of Col E−3% Cng);

NC) SD of Col GT (SD of Col E−2% Cng);

ND) SD of Col GU (SD of Col E−1% Cng);

NE) SD of Col GV (SD of Col E±0% Cng);

NF) SD of Col GW (SD of Col E+1% Cng);

NG) SD of Col GX (SD of Col E+2% Cng);

NH) SD of Col GY (SD of Col E−4 to Col E±0% Cng);

NI) SD of Col GZ (SD of Col E±0 to Col E+2% Cng);

NJ) SD of Col HA (SD of Col E−4 to Col E+2% Cng)

NK thru NT) Item: Company Specific Series Standard Deviation of Percentages of Change Part Two—Daily High Price This Series (Part Two or Col C Daily High Price) calculates the Standard Deviation of the percentages of change the numeric changes series shown above represent. Only the Standard Deviation of percentages of change relative to all of the Company-specific Daily High Prices are calculated and shown. Specific Formula are implied as described in Notes above.

NK) SD of Col HB (SD of Col C−4% Cng);

NL) SD of Col HC (SD of Col C−3% Cng);

NM) SD of Col HD (SD of Col C−2% Cng);

NN) SD of Col HE (SD of Col C−1% Cng);

NO) SD of Col HF (SD of Col C±0% Cng);

NP) SD of Col HG (SD of Col C+1% Cng);

NQ) SD of Col HH (SD of Col C+2% Cng);

NR) SD of Col HI (SD of Col C−4 to Col C±0% Cng);

NS) SD of Col HJ (SD of Col C+0 to Col C+2% Cng);

NT) SD of Col HK (SD of Col C−4 to Col C+2% Cng)

NU thru OD) Item: Company Specific Series Standard Deviation of Percentages of Change Part Three—Daily Low Price This Series (Part Three or Col D Daily Low Price) calculates the Standard Deviation of the percentages of change the numeric changes series shown above represent. Only the Standard Deviation of percentages of change relative to all of the Company-specific Daily Low Prices are calculated and shown. Specific Formula are implied as described in Notes above.

NU) SD of Col HL (SD of Col D−4% Cng);

NV) SD of Col HM (SD of Col D−3% Cng);

NW) SD of Col HN (SD of Col D−2% Cng);

NX) SD of Col HO (SD of Col D−1% Cng);

NY) SD of Col HP (SD of Col D±0% Cng);

NZ) SD of Col HQ (SD of Col D+1% Cng);

OA) SD of Col HR (SD of Col D+2% Cng);

OB) SD of Col HS (SD of Col D−4 to Col D±0% Cng);

OC) SD of Col HT (SD of Col D±0 to Col D+2% Cng);

OD) SD of Col HU (SD of Col D−4 to Col D+2% Cng)

OE thru ON) Item: Company Specific Series Standard Deviation of Percentages of Change Part Four—Daily Volume This Series (Part Four or Col F—Daily Volume) calculates the Standard Deviation of the percentages of change the numeric changes series shown above represent. Only the Standard Deviation of the percentages of change relative to all of the Company-specific Daily Volume are calculated and shown. Specific Formula are implied as described in Notes above.

OE) SD of Col HV (SD of Col F−4% Cng);

OF) SD of Col HW (SD of Col F−3% Cng);

OG) SD of Col HX(SD of Col F−2% Cng);

OH) SD of Col HY (SD of Col F−1% Cng);

OI) SD of Col HZ (SD of Col F±0% Cng);

OJ) SD of Col IA (SD of Col F+1% Cng);

OK) SD of Col IB (SD of Col F+2% Cng);

OL) SD of Col IC (SD of Col F−4 to Col F±0% Cng);

OM) SD of Col ID (SD of Col F±0 to Col F+2% Cng);

ON) SD of Col IE (SD of Col F−4 to Col F+2% Cng)

OO) thru OX) Item: Company Specific Series Standard Deviation of Percentages of Change Part Five—Fails to Deliver This Series (Part Five or Col I Fails to Deliver or FTDs) calculates the Standard Deviation of the percentages of change the numeric changes series shown above represent. Only the Standard Deviation of the percentages of change relative to all of the Company specific Fails to Deliver are calculated and shown. Specific Formula are implied as described in Notes above.

OO) SD of Col IF (SD of Col I−4% Cng);

OP) SD of Col IG (SD of Col I−3% Cng);

OQ) SD of Col IH (SD of Col I−2% Cng);

OR) SD of Col II (SD of Col I−1% Cng);

OS) SD of Col IJ (SD of Col I±0% Cng);

OT) SD of Col IK (SD of Col I+1% Cng);

OU) SD of Col IL (SD of Col I+2% Cng);

OV) SD of Col IM (SD of Col I−4 to Col I±0% Cng);

OW) SD of Col IN (SD of Col I±0 to Col I+2% Cng);

OX) SD of Col IO (SD of Col I−4 to Col I+2% Cng)

OY thru PH) Item: Company Specific Series Standard Deviation of Percentages of Change Part Six—Daily Short Volume This Series (Part Six or Col O—Daily Short Volume) calculates the Standard Deviation of the percentages of change the numeric changes series shown above represent. Only the Standard Deviation of the percentages of change relative to all of the Company-specific Daily Short Volume are calculated and shown. Specific Formula are implied as described in Notes above.

OY) SD of Col IP (SD of Col O−4% Cng);

OZ) SD of Col IQ (SD of Col O−3% Cng);

PA) SD of Col IR (SD of Col O−2% Cng);

PB) SD of Col IS (SD of Col O−1% Cng);

PC) SD of Col IT (SD of Col O±0% Cng);

PD) SD of Col IU (SD of Col O+1% Cng);

PE) SD of Col IV (SD of Col O+2% Cng);

PF) SD of Col IW (SD of Col O−4 to Col O±0% Cng);

PG) SD of Col IX (SD of Col O±0 to Col O+2% Cng);

PH) SD of Col IY (SD of Col O−4 to Col O+2% Cng)

Note 68: In this section, the same form of calculating the Standard Deviation used above for determining the SD of the specific Percentages of Change in each of the Trade Date Serial Comparison Columns' Second Phase of Base Comparisons of Change, the Base Comparisons for Percentages of Change, will be applied to the Direction of Change each column from the Third Phase of Base Comparisons of Change, Base Comparisons of Change Designation Indicators-Only Columns Array. Likewise, the manner of Column title and implied Column listing formulary are the same as well.

Note 69: Columnar Identification will proceed with double-alphabetic designation Column Qx beginning here.

QA thru QJ) Item: Company Specific Series Standard Deviation of Change Designation Indicators-Only Part One—Daily Closing Price This Series (Part One or Col E Daily Closing Price) calculates the Standard Deviation of the Designation Indicators of change (Direction of Change) derived from the numeric and percentage changes series shown above represent. Only the Standard Deviation of the Designation Indicators of change relative to all of the Company-specific Daily Closing Prices are calculated and shown. Specific Formula are implied as described in Notes above.

QA) SD of Col JA (SD of Col E−4 Dir Cng);

QB) SD of Col JB (SD of Col E−3 Dir Cng);

QC) SD of Col JC (SD of Col E−2 Dir Cng);

QD) SD of Col JD (SD of Col E−1 Dir Cng);

QE) SD of Col JE (SD of Col E±0 Dir Cng);

QF) SD of Col JF (SD of Col E+1 Dir Cng);

QG) SD of Col JG (SD of Col E+2 Dir Cng);

QH) SD of Col JH (SD of Col E−4 to Col E±0 Dir Cng);

QI) SD of Col JI (SD of Col E±0 to Col E+2 Dir Cng);

QJ) SD of Col JJ (SD of Col E−4 to Col E+2 Dir Cng)

QK thru QT) Item: Company Specific Series Standard Deviation of Change Designation Indicators-Only Part Two—Daily High Price This Series (Part Two or Col C Daily High Price) calculates the Standard Deviation of the Designation Indicators of change (Direction of Change) derived from the numeric and percentage changes series shown above represent. Only the Standard Deviation of the Designation Indicators of change relative to all of the Company-specific Daily High Prices are calculated and shown. Specific Formula are implied as described in Notes above.

QK) SD of Col JK (SD of Col C−4 Dir Cng);

QL) SD of Col JL (SD of Col C−3 Dir Cng);

QM) SD of Col JM (SD of Col C−2 Dir Cng);

QN) SD of Col JN (SD of Col C−1 Dir Cng);

QO) SD of Col JO (SD of Col C±0 Dir Cng);

QP) SD of Col JP (SD of Col C+1 Dir Cng);

QQ) SD of Col JO (SD of Col C+2 Dir Cng);

QR) SD of Col JR (SD of Col C−4 to Col C±0 Dir Cng);

QS) SD of Col JS (SD of Col C±0 to Col C+2 Dir Cng);

QT) SD of Col JT (SD of Col C−4 to Col C+2 Dir Cng)

QU thru RD) Item: Company Specific Series Standard Deviation of Change Designation Indicators-Only Part Three—Daily Low Price This Series (Part Three or Col D Daily Low Price) calculates the Standard Deviation of the Designation Indicators of change (Direction of Change) derived from the numeric and percentage changes series shown above represent. Only the Standard Deviation of the Designation Indicators of change relative to all of the Company-specific Daily Low Prices are calculated and shown. Specific Formula are implied as described in Note 66 above.

QU) SD of Col JU (SD of Col D−4 Dir Cng);

QV) SD of Col JV (SD of Col D−3 Dir Cng);

QW) SD of Col JW (SD of Col D−2 Dir Cng);

QX) SD of Col JX (SD of Col D−1 Dir Cng);

QY) SD of Col JY (SD of Col D±0 Dir Cng);

QZ) SD of Col JZ (SD of Col D+1 Dir Cng);

RA) SD of Col KA (SD of Col D+2 Dir Cng);

RB) SD of Col KB (SD of Col D−4 to Col D±0 Dir Cng);

RC) SD of Col KC (SD of Col D±0 to Col D+2 Dir Cng);

RD) SD of Col KD (SD of Col D−4 to Col D+2 Dir Cng)

RE thru RN) Item: Company Specific Series Standard Deviation of Change Designation Indicators-Only Part Four—Daily Volume This Series (Part Four or Col F—Daily Volume) calculates the Standard Deviation of the Designation Indicators of change (Direction of Change) derived from the numeric and percentage changes series shown above represent. Only the Standard Deviation of the Designation Indicators of change relative to all of the Company-specific Daily Volume are calculated and shown. Specific Formula are implied as described in Notes above.

RE) SD of Col KE (SD of Col F−4 Dir Cng);

RF) SD of Col KF (SD of Col F−3 Dir Cng);

RG) SD of Col KG (SD of Col F−2 Dir Cng);

RH) SD of Col KH (SD of Col F−1 Dir Cng);

RI) SD of Col KI (SD of Col F±0 Dir Cng);

RJ) SD of Col KJ (SD of Col F+1 Dir Cng);

RK) SD of Col KK (SD of Col F+2 Dir Cng);

RL) SD of Col KL (SD of Col F−4 to Col F±0 Dir Cng);

RM) SD of Col KM (SD of Col F±0 to Col F+2 Dir Cng);

RN) SD of Col KN (SD of Col F−4 to Col F+2 Dir Cng)

RO thru RX) Item: Company Specific Series Standard Deviation of Change Designation Indicators-Only Part Five—Fails to Deliver This Series (Part Five or Col I Fails to Deliver or FTDs) calculates the Standard Deviation of the Designation Indicators of change (Direction of Change) derived from the numeric and percentage changes series shown above represent. Only the Standard Deviation of the Designation Indicators of change relative to all of the Company-specific Fails to Deliver are calculated and shown. Specific Formula are implied as described in Notes above.

RO) SD of Col KO (SD of Col I−4 Dir Cng);

RP) SD of Col KP (SD of Col I−3 Dir Cng);

RQ) SD of Col KQ (SD of Col I−2 Dir Cng);

RR) SD of Col KR (SD of Col I−1 Dir Cng);

RS) SD of Col KS (SD of Col I±0 Dir Cng);

RT) SD of Col KT SD of Col I+1 Dir Cng);

RU) SD of Col KU (SD of Col I+2 Dir Cng);

RV) SD of Col KV (SD of Col I−4 to Col I±0 Dir Cng);

RW) SD of Col KW (SD of Col I±0 to Col I+2 Dir Cng);

RX) SD of Col KX (SD of Col I−4 to Col I+2 Dir Cng)

RY thru SH) Item: Company Specific Series Standard Deviation of Change Designation Indicators-Only Part Six—Daily Short Volume This Series (Part Six or Col O—Daily Short Volume) calculates the Standard Deviation of the Designation Indicators of change (Direction of Change) derived from the numeric and percentage changes series shown above represent. Only the Standard Deviation of the Designation Indicators of change relative to all of the Company-specific Daily Short Volume are calculated and shown. Specific Formula are implied as described in Notes above.

RY) SD of Col KY (SD of Col O−4 Dir Cng);

RZ) SD of Col KZ (SD of Col O−3 Dir Cng);

SA) SD of Col LA (SD of Col O−2 Dir Cng);

SB) SD of Col LB (SD of Col O−1 Dir Cng);

SC) SD of Col LC (SD of Col O±0 Dir Cng);

SD) SD of Col LD (SD of Col O+1 Dir Cng);

SE) SD of Col LE (SD of Col O+2 Dir Cng);

SF) SD of Col LF (SD of Col O−4 to Col O±0 Dir Cng);

SG) SD of Col LG (SD of Col O±0 to Col O+2 Dir Cng);

SH) SD of Col LH (SD of Col O−4 to Col O+2 Dir Cng)

Note 70: In the sections that follow, there will be a combining of SDs as additive “sum” and multiplicative “product” calculations for each series and each of Percentages of Change and Directional Indicators, for both sets—Daily Trading Date Relationals—Full Range as well as Precessive and Successive multi-day, and; Multi-Trade Date Relationals, specific to the Trade Date being examined.

Note 71: Full Range is defined as being the range of multi-day periods of Trade Dates from Col x−4 thru Col x+2. Precessive Range is defined as being the range of multi-day periods of Trade Dates from Col x−4 thru Col x+0, adjusted for Pre- and Post-shortening of Settlement Date as of Sep. 5, 2017. Successive Range is defined as being the range of multi-day periods of Trade Dates from Col x+0 thru Col x+2. Multi-Trade Date Relationals are the combined column entries each comprised of multi-Trade Date components (Col x−4 to Col x+0), (Col x+0 to Col x+2) and (Col x−4 to Col x+2).

Note 72: In the first section, the First Part shall be in a series that comprises Standard Deviations Sum of multi-day periods of Trade Dates—Daily Trading Date Relationals—Full Range as well as Precessive and Successive and Multi-Trade Date Relationals Percentages of Change. This will be done for each category—Close, High, Low, Daily Volume, Fails to Deliver, and Daily Short Volume. The Second Part shall be in a series that comprises Standard Deviations Sum of multi-day periods of Trade Dates—Daily Trading Date Relationals—Full Range as well as Precessive and Successive and Multi-Trade Date Relationals Directional Indicators of Change. This will be done for each category—Close, High, Low, Daily Volume, Fails to Deliver, and Daily Short Volume. In both parts, there will be adjustment for Pre- and Post-shortening of Settlement Date as of Sep. 5, 2017.

Note 73: In the second section, the First Part shall be in a series that comprises Standard Deviations Product of multi-day periods of Trade Dates—Daily Trading Date Relationals—Full Range as well as Precessive and Successive and Multi-Trade Date Relationals Percentages of Change. This will be done for each category—Close, High, Low, Daily Volume, Fails to Deliver, and Daily Short Volume. The Second Part shall be in a series that comprises Standard Deviations Product of multi-day periods of Trade Dates—Daily Trading Date Relationals—Full Range as well as Precessive and Successive and Multi-Trade Date Relationals Directional Indicators of Change. This will be done for each category—Close, High, Low, Daily Volume, Fails to Deliver, and Daily Short Volume. In both parts, there will be adjustment for Pre- and Post-shortening of Settlement Date as of Sep. 5, 2017.

### Standard Deviation Combination Series

### Part One: Additive Sum

### Daily Trading Date Relationals—Percentages of Change—Full Range—Sum

SI) Sum of SDs of Columns NA thru NG—Daily Closing Prices (Sum SDs Cols NA thru NG) This is where the Standard Deviations calculated for Company-specific Daily Closing Prices Trading Date Relationals' Percentages of Change Columns NA thru NG are added together

SJ) Sum of SDs of Columns NK thru NQ—Daily High Prices (Sum SDs Cols NK thru NQ) This is where the Standard Deviations calculated for Company-specific Daily High Prices Trading Date Relationals' Percentages of Change Columns NK thru NQ are added together

SK) Sum of SDs of Columns NU thru OA—Daily Low Prices (Sum SDs Cols NU thru OA) This is where the Standard Deviations calculated for Company-specific Daily Low Prices Trading Date Relationals' Percentages of Change Columns NU thru OA are added together

SL) Sum of SDs of Columns OE thru OK—Daily Volume (Sum SDs Cols OE thru OK) This is where the Standard Deviations calculated for Company-specific Daily Volume Trading Date Relationals' Percentages of Change Columns OE thru OK are added together

SM) Sum of SDs of Columns OO thru OU—Fails to Deliver (Sum SDs Cols OO thru OU) This is where the Standard Deviations calculated for Company-specific Fails to Deliver Trading Date Relationals' Percentages of Change Columns OO to OUare added together

SN) Sum of SDs of Columns OY thru PE—Daily Short Volume (Sum SDs Cols OY thru PE) This is where the Standard Deviations calculated for Company-specific Daily Short Volume Trading Date Relationals' Percentages of Change Columns OY thru PE are added together.

### Daily Trading Date Relationals—Percentages of Change—Precessive—Sum

SO) Sum of SDs of Precessive Columns NA thru NE—Daily Close Prices (Sum SDs Cols NA thru NE) This is where the Standard Deviations calculated for Company-specific Precessive Daily Closing Prices Trading Date Relationals' Percentages of Change Columns NA thru NE are added together

SP) Sum of SDs of Precessive Columns NK thru NO—Daily High Prices (Sum SDs Cols NK thru NO) This is where the Standard Deviations calculated for Company-specific Precessive Daily High Prices Trading Date Relationals' Percentages of Change Columns NK thru NO are added together

SQ) Sum of SDs of Precessive Columns NU thru NY—Daily Low Prices (Sum SDs Cols NU thru NY) This is where the Standard Deviations calculated for Company-specific Precessive Daily Low Prices Trading Date Relationals' Percentages of Change Columns NU thru NY are added together.

SR) Sum of SDs of Precessive Columns OE thru OI—Daily Volume (Sum SDs Cols OE thru OI) This is where the Standard Deviations calculated for Company-specific Precessive Daily Volume Trading Date Relationals' Percentages of Change Columns OE thru OI are added together.

SS) Sum of SDs of Precessive Columns OO thru OS—Fails to Deliver (Sum SDs Cols OO thru OS) This is where the Standard Deviations calculated for Company-specific Precessive Fails to Deliver Trading Date Relationals' Percentages of Change Columns OO thru OS are added together.

ST) Sum of SDs of Precessive Columns OY thru PC—Daily Short Volume (Sum SDs Cols OY thru PC) This is where the Standard Deviations calculated for Company-specific Precessive Fails to Deliver Trading Date Relationals' Percentages of Change Columns OO thru OS are added together.

### Daily Trading Date Relationals—Percentages of Change—Successive—Sum

SU) Sum of SDs of Successive Columns NE thru NG—Daily Close Prices (Sum SDs Cols NE thru NG) This is where the Standard Deviations calculated for Company-specific Successive Daily Closing Prices Trading Date Relationals' Percentages of Change Columns NE thru NG are added together

SV) Sum of SDs of Successive Columns NO thru NO—Daily High Prices (Sum SDs Cols NO thru NQ) This is where the Standard Deviations calculated for Company-specific Successive Daily High Prices Trading Date Relationals' Percentages of Change Columns NO thru NQ are added together

SW) Sum of SDs of Successive Columns NY thru OA—Daily Low Prices (Sum SDs Cols NY thru OA) This is where the Standard Deviations calculated for Company-specific Successive Daily Low Prices Trading Date Relationals' Percentages of Change Columns NY thru OA are added together.

SX) Sum of SDs of Successive Columns OI thru OK—Daily Volume (Sum SDs Cols OI thru OK) This is where the Standard Deviations calculated for Company-specific Successive Daily Low Volume Trading Date Relationals' Percentages of Change Columns OI thru OK are added together.

SY) Sum of SDs of Successive Columns OS thru OU—Fails to Deliver (Sum SDs Cols OS thru OU) This is where the Standard Deviations calculated for Company-specific Successive Fails to Deliver Trading Date Relationals' Percentages of Change Columns OS thru OU are added together.

SZ) Sum of SDs of Successive Columns PC thru PE—Daily Short Volume (Sum SDs Cols PC thru PE) This is where the Standard Deviations calculated for Company-specific Successive Daily Short Volume Trading Date Relationals' Percentages of Change Columns PC thru PE are added together

### Multi-Trade Date Relationals—Percentages of Change—Sum

TA) Sum of SDs of Multi-Trade Date Relationals Columns NH thru NJ—Daily Close Prices (Sum SDs Cols NH thru NJ) This is where the Standard Deviations calculated for Company-specific Multi-Trade Date Relationals' Closing Prices Trading Date Relationals' Percentages of Change Columns NH thru NJ are added together.

TB) Sum of SDs of Multi-Trade Date Relationals Columns NR thru NT—Daily High Prices (Sum SDs Cols NR thru NT) This is where the Standard Deviations calculated for Company-specific Multi-Trade Date Relationals' Daily High Prices Trading Date Relationals' Percentages of Change Columns NR thru NT are added together

TC) Sum of SDs of Multi-Trade Date Relationals Columns OB thru OD—Daily Low Prices (Sum SDs Cols OB thru OD) This is where the Standard Deviations calculated for Company-specific Multi-Trade Date Relationals' Daily Low Prices Trading Date Relationals' Percentages of Change Columns OB thru OD are added together.

TD) Sum of SDs of Multi-Trade Date Relationals Columns OL thru ON—Daily Volume (Sum SDs Cols OL thru ON) This is where the Standard Deviations calculated for Company-specific Multi-Trade Date Relationals' Daily Volume Trading Date Relationals' Percentages of Change Columns OL thru ON are added together.

TE) Sum of SDs of Multi-Trade Date Relationals Columns OV thru OX−Fails to Deliver (Sum SDs Cols OV thru OX) This is where the Standard Deviations calculated for Company-specific Multi-Trade Date Relationals' Fails to Deliver Trading Date Relationals' Percentages of Change Columns OV thru OX are added together.

TF) Sum of SDs of Multi-Trade Date Relationals Columns PF thru PH—Daily Short Volume (Sum SDs Cols PF thru PH) This is where the Standard Deviations calculated for Company-specific Multi-Trade Date Relationals' Daily Short Volume Trading Date Relationals' Percentages of Change Columns PF thru PH are added together

### Standard Deviation Combination Series

### Part Two: Additive Sum

Daily Trading Date Relationals—Directional Indicators of Change—Full Range—Sum

TG) Sum of SDs of Columns QA thru QG—Daily Closing Prices (Sum SDs Cols QA thru QG) This is where the Standard Deviations calculated for Company-specific Daily Closing Prices Trading Date Relationals' Directional Indicators of Change Columns QA thru QG are added together.

TH) Sum of SDs of Columns QK thru OO—Daily High Prices (Sum SDs Cols QK thru QQ) This is where the Standard Deviations calculated for Company-specific Daily High Prices Trading Date Relationals' Directional Indicators of Change Columns QK thru QQ are added together.

TI) Sum of SDs of Columns QU thru RA—Daily Low Prices (Sum SDs Cols QU thru RA) This is where the Standard Deviations calculated for Company-specific Daily Low Prices Trading Date Relationals' Directional Indicators of Change Columns QU thru RA are added together.

TJ) Sum of SDs of Columns RE thru RJ—Daily Volume Sum SDs Cols RE thru RJ) This is where the Standard Deviations calculated for Company-specific Daily Volume Trading Date Relationals' Directional Indicators of Change Columns RE thru RI are added together.

TK) Sum of SDs of Columns RO thru RU—Fails to Deliver (Sum SDs Cols RO thru RU) This is where the Standard Deviations calculated for Company-specific Fails to Deliver Trading Date Relationals' Directional Indicators of Change Columns RO thru RU are added together.

TL) Sum of SDs of Columns RY thru SE—Daily Short Volume (Sum SDs Cols RY thru SE) This is where the Standard Deviations calculated for Company-specific Daily Short Volume Trading Date Relationals' Directional Indicators of Change Columns RY thru SE are added together.

### Daily Trading Date Relationals—Directional Indicators of Change—Precessive—Sum

TM) Sum of SDs of Precessive Columns QA thru QE—Daily Close Prices (Sum SDs Cols QA thru QE) This is where the Standard Deviations calculated for Company-specific Precessive Daily Closing Prices Trading Date Relationals' Directional Indicators of Change Columns QA thru QE are added together.

TN) Sum of SDs of Precessive Columns OK thru QO—Daily High Prices (Sum SDs Cols QK thru QO) This is where the Standard Deviations calculated for Company-specific Precessive Daily High Prices Trading Date Relationals' Directional Indicators of Change Columns QK thru QO are added together.

TO) Sum of SDs of Precessive Columns QU thru QY—Daily Low Prices (Sum SDs Cols QU thru QY) This is where the Standard Deviations calculated for Company-specific Precessive Daily Low Prices Trading Date Relationals' Directional Indicators of Change Columns QU thru QY are added together.

TP) Sum of SDs of Precessive Columns RE thru RI—Daily Volume (Sum SDs Cols RE thru RI) This is where the Standard Deviations calculated for Company-specific Precessive Daily Volume Trading Date Relationals' Directional Indicators of Change Columns RE thru RI are added together.

TQ) Sum of SDs of Precessive Columns RO thru RS—Fails to Deliver (Sum SDs Cols RO thru RS) This is where the Standard Deviations calculated for Company-specific Precessive Fails to Deliver Trading Date Relationals' Directional Indicators of Change Columns RO thru RS are added together.

TR) Sum of SDs of Precessive Columns RY thru SC—Daily Short Volume (Sum SDs Cols RY thru SC) This is where the Standard Deviations calculated for Company-specific Precessive Daily Short Volume Trading Date Relationals' Directional Indicators of Change Columns RY thru SC are added together.

### Daily Trading Date Relationals—Directional Indicators of Change—Successive—Sum

TS) Sum of SDs of Successive Columns QE thru OG—Daily Close Prices (Sum SDs Cols QE thru QG) This is where the Standard Deviations calculated for Company-specific Successive Daily Closing Prices Trading Date Relationals' Directional Indicators of Change Columns QE thru QG are added together.

TT) Sum of SDs of Successive Columns QO thru QQ—Daily High Prices (Sum SDs Cols QO thru QQ) This is where the Standard Deviations calculated for Company-specific Successive Daily High Prices Trading Date Relationals' Directional Indicators of Change Columns QO thru QQ are added together.

TU) Sum of SDs of Successive Columns QY thru RA—Daily Low Prices (Sum SDs Cols QY thru RA) This is where the Standard Deviations calculated for Company-specific Successive Daily Low Prices Trading Date Relationals' Directional Indicators of Change Columns QY thru RA are added together.

TV) Sum of SDs of Successive Columns RI thru RK—Daily Volume (Sum SDs Cols RI thru RK) This is where the Standard Deviations calculated for Company-specific Successive Daily Volume Trading Date Relationals' Directional Indicators of Change Columns RI thru RK are added together.

TW) Sum of SDs of Successive Columns RS thru RU—Fails to Deliver (Sum SDs Cols RS thru RU) This is where the Standard Deviations calculated for Company-specific Successive Fails to Deliver Trading Date Relationals' Directional Indicators of Change Columns RS thru RU are added together

TX) Sum of SDs of Successive Columns SC thru SE—Daily Short Volume (Sum SDs Cols SC thru SE) This is where the Standard Deviations calculated for Company-specific Successive Daily Short Volume Trading Date Relationals' Directional Indicators of Change Columns SC thru SE are added together

### Multi-Trade Date Relational—Directional Indicators of Change—Sum

TY) Sum of SDs of Columns QH thru OJ—Daily Closing Prices (Sum SDs Cols QH thru QJ) This is where the Standard Deviations calculated for Company-specific Daily Closing Prices Multi-Trade Date Relationals' Directional Indicators of Change Columns QH thru QJ are added together.

TZ) Sum of SDs of Columns OR thru OT—Daily High Prices (Sum SDs Cols QR thru QT) This is where the Standard Deviations calculated for Company-specific Daily High Prices Multi-Trade Date Relationals' Directional Indicators of Change Columns QR thru QT are added together.

UA) Sum of SDs of Columns RB thru RD—Daily Low Prices (Sum SDs Cols RB thru RD) This is where the Standard Deviations calculated for Company-specific Daily Low Prices Multi-Trade Date Relationals' Directional Indicators of Change Columns RB thru RD are added together.

UB) Sum of SDs of Columns RL thru RN—Daily Volume (Sum SDs Cols RL thru RN) This is where the Standard Deviations calculated for Company-specific Daily Volume Multi-Trade Date Relationals' Directional Indicators of Change Columns RL thru RN are added together.

UC) Sum of SDs of Columns RV thru RX−Fails to Deliver (Sum SDs Cols RV thru RX) This is where the Standard Deviations calculated for Company-specific Fails to Deliver Multi-Trade Date Relationals' Directional Indicators of Change Columns RV thru RX are added together.

UD) Sum of SDs of Columns SF thru SH—Daily Short Volume (Sum SDs Cols SF thru SH) This is where the Standard Deviations calculated for Company-specific Daily Short Volume Multi-Trade Date Relationals' Directional Indicators of Change Columns SF thru SH are added together.

### Standard Deviation Combination Series

### Part One: Multiplicative Product

Daily Trading Date Relationals—Percentages of Change—Full Range—Product

UE) Product of SDs of Columns NA thru NG—Daily Closing Prices (Product SDs Cols NA thru NG) This is where the Standard Deviations calculated for Company-specific Daily Closing Prices Trading Date Relationals' Percentages of Change in Columns NA thru NG are multiplied together to form a single product.

UF) Product of SDs of Columns NK thru NO—Daily High Prices (Product SDs Cols NK thru NQ) This is where the Standard Deviations calculated for Company-specific Daily High Prices Trading Date Relationals' Percentages of Change in Columns NK thru NQ are multiplied together to form a single product.

UG) Product of SDs of Columns NU thru OA—Daily Low Prices (Product SDs Cols NQ thru OA) This is where the Standard Deviations calculated for Company-specific Daily Low Prices Trading Date Relationals' Percentages of Change in Columns NQ thru OA are multiplied together to form a single product.

UH) Product of SDs of Columns OE thru OK—Daily Volume (Product SDs Cols OE thru OK) This is where the Standard Deviations calculated for Company-specific Daily Volume Trading Date Relationals' Percentages of Change in Columns OE thru OK are multiplied together to form a single product.

UI) Product of SDs of Columns OO thru OU—Fails to Deliver (Product SDs Cols OO thru OU) This is where the Standard Deviations calculated for Company-specific Fails to Deliver Trading Date Relationals' Percentages of Change in Columns OO thru OU are multiplied together to form a single product.

UJ) Product of SDs of Columns OY thru PE—Daily Short Volume (Product SDs Col OY thru PE) This is where the Standard Deviations calculated for Company-specific Daily Short Volume Trading Date Relationals' Percentages of Change in Columns OY thru PE are multiplied together to form a single product.

### Daily Trading Date Relationals—Percentages of Change—Precessive—Product

UK) Product of SDs of Precessive Columns NA thru NE—Daily Closing Prices (Product SDs Cols NA thru NE) This is where the Standard Deviations calculated for Company-specific Precessive Daily Closing Prices Trading Date Relationals' Percentages of Change in Columns NA thru NE are multiplied together to form a single product.

UL) Product of SDs of Precessive Columns NK thru NO—Daily High Prices (Product SDs Cols NK thru NO) This is where the Standard Deviations calculated for Company-specific Precessive Daily High Prices Trading Date Relationals' Percentages of Change in Columns NK thru NO are multiplied together to form a single product.

UM) Product of SDs of Precessive Columns NU thru NY—Daily Low Prices (Product SDs Cols NQ thru NY) This is where the Standard Deviations calculated for Company-specific Precessive Daily Low Prices Trading Date Relationals' Percentages of Change in Columns NQ thru NY are multiplied together to form a single product.

UN) Product of SDs of Precessive Columns OE thru OI—Daily Volume (Product SDs Cols OE thru OI) This is where the Standard Deviations calculated for Company-specific Precessive Daily Volume Trading Date Relationals' Percentages of Change in Columns OE thru OI are multiplied together to form a single product.

UO) Product of SDs of Precessive Columns OO thru OS—Fails to Deliver (Product SDs Cols OO thru OS) This is where the Standard Deviations calculated for Company-specific Precessive Fails to Deliver Trading Date Relationals' Percentages of Change in Columns OO thru OS are multiplied together to form a single product.

UP) Product of SDs of Precessive Columns OY thru PC—Daily Short Volume (Product SDs Col OY thru PC) This is where the Standard Deviations calculated for Company-specific Precessive Daily Short Volume Trading Date Relationals' Percentages of Change in Columns OY thru PC are multiplied together to form a single product.

### Daily Trading Date Relationals—Percentages of Change—Successive—Product

UQ) Product of SDs of Successive Columns NE thru NG—Daily Close Prices (Product SDs Cols NE thru NG) This is where the Standard Deviations calculated for Company-specific Successive Daily Closing Prices Trading Date Relationals' Percentages of Change Columns NE thru NG are multiplied together to form a single product.

UR) Product of SDs of Successive Columns NO thru NO—Daily High Prices (Product SDs Cols NO thru NQ) This is where the Standard Deviations calculated for Company-specific Successive Daily High Prices Trading Date Relationals' Percentages of Change Columns NO thru NQ are multiplied together to form a single product.

US) Product of SDs of Successive Columns NY thru OA—Daily Low Prices (Product SDs Cols NY thru OA) This is where the Product of the Standard Deviations calculated for Company-specific Successive Daily Low Prices Trading Date Relationals' Percentages of Change Columns NY thru OA are multiplied together to form a single product.

UT) Product of SDs of Successive Columns OI thru OK—Daily Volume (Product SDs Cols OI thru OK) This is where the Standard Deviations calculated for Company-specific Successive Daily Volume Trading Date Relationals' Percentages of Change Columns OI thru OK are multiplied together to form a single product.

UU) Product of SDs of Successive Columns OS thru OU—Fails to Deliver (Product SDs Cols OS thru OU) This is where the Standard Deviations calculated for Company-specific Successive Fails to Deliver Trading Date Relationals' Percentages of Change Columns OS thru OU are multiplied together to form a single product.

UV) Product of SDs of Successive Columns PC thru PE—Daily Short Volume (Product SDs Cols PC thru PE) This is where the Standard Deviations calculated for Company-specific Successive Daily Short Volume Trading Date Relationals' Percentages of Change Columns PC thru PE are multiplied together to form a single product.

### Multi-Trade Date Relational—Percentages of Change—Product

UW) Product of SDs of Columns NH thru NJ—Daily Closing Prices (Product SDs Cols NH thru NJ) This is where the Standard Deviations calculated for Company-specific Daily Closing Prices Multi-Trade Date Relationals' Percentages of Change Columns NH thru NJ are multiplied together to form a single product.

UX) Product of SDs of Columns NR thru NT—Daily High Prices (Product SDs Cols NR thru NT) This is where the Standard Deviations calculated for Company-specific Daily High Prices Multi-Trade Date Relationals' Percentages of Change Columns NR thru NT are multiplied together to form a single product.

UY) Product of SDs of Columns OB thru OD—Daily Low Prices (Product SDs Cols OB thru OD) This is where the Standard Deviations calculated for Company-specific Daily Low Prices Multi-Trade Date Relationals' Percentages of Change Columns OB thru OD are multiplied together to form a single product.

UZ) Product of SDs of Columns OL thru ON—Daily Volume (Product SDs Cols OL thru ON) This is where the Standard Deviations calculated for Company-specific Daily Volume Multi-Trade Date Relationals' Percentages of Change Columns OL thru ON are multiplied together to form a single product.

VA) Product of SDs of Columns OV thru OX−Fails to Deliver (Product SDs Cols OV thru OX) This is where the Standard Deviations calculated for Company-specific Fails to Deliver Multi-Trade Date Relationals' Percentages of Change Columns OV thru OX are multiplied together to form a single product.

VB) Product of SDs of Columns PF thru PH—Daily Short Volume (Product SDs Cols PF thru PH) This is where the Standard Deviations calculated for Company-specific Daily Short Volume Multi-Trade Date Relationals' Percentages of Change Columns PF thru PH are multiplied together to form a single product.

### Standard Deviation Combination Series

### Part Two: Multiplicative Product

### Daily Trading Date Relationals—Directional Indicators of Change—Full Range—Product

VC) Product of SDs of Columns QA thru QG—Daily Closing Prices (Product SDs Cols QA thru QG) This is where the Standard Deviations calculated for Company-specific Daily Closing Prices Trading Date Relationals' Directional Indicators of Change in Columns QA thru QG are multiplied together to form a single product.

VD) Product of SDs of Columns QK thru OO—Daily High Prices (Product SDs Cols QK thru QQ) This is where the Standard Deviations calculated for Company-specific Daily High Prices Trading Date Relationals' Directional Indicators of Change in Columns QK thru QQ are multiplied together to form a single product.

VE) Product of SDs of Columns QU thru RA—Daily Low Prices (Product SDs Cols QU thru RA) This is where the Standard Deviations calculated for Company-specific Daily Low Prices Trading Date Relationals' Directional Indicators of Change in Columns QU thru RA are multiplied together to form a single product.

VF) Product of SDs of Columns RE thru RK—Daily Volume (Product SDs Cols RE thru RK) This is where the Standard Deviations calculated for Company-specific Daily Volume Trading Date Volume Trading Date Relationals' Directional Indicators of Change in Columns RE thru RK are multiplied together to form a single product.

VG) Product of SDs of Columns RO thru RU—Fails to Deliver (Product SDs Cols RO thru RU) This is where the Standard Deviations calculated for Company-specific Fails to Deliver Trading Date Relationals' Directional Indicators of Change in Columns RO thru RU are multiplied together to form a single product.

VH) Product of SDs of Columns RY thru SE—Daily Short Volume (Product SDs Cols RY thru SE) This is where of the Standard Deviations calculated for Company-specific Daily Short Volume Trading Date Relationals' Directional Indicators of Change in Columns RY thru SE are multiplied together to form a single product.

### Daily Trading Date Relationals—Directional Indicators of Change—Precessive—Product

VI) Product of SDs of Precessive Columns QA thru QE—Daily Close Prices (Product SDs Cols QA thru QE) This is where the Standard Deviations calculated for Company-specific Precessive Daily Closing Prices Trading Date Relationals' Percentages of Change Columns QA thru QE are multiplied together to form a single product.

VJ) Product of SDs of Precessive Columns OK thru QO—Daily High Prices (Product SDs Cols QK thru QO) This is where the Standard Deviations calculated for Company-specific Precessive Daily High Prices Trading Date Relationals' Directional Indicators of Change Columns QK thru QO are multiplied together to form a single product.

VK) Product of SDs of Precessive Columns QU thru QY—Daily Low Prices (Product SDs Cols QU thru QY) This is where the Standard Deviations calculated for Company-specific Precessive Daily Low Prices Trading Date Relationals' Directional Indicators of Change Columns QU thru QY are multiplied together to form a single product.

VL) Product of SDs of Precessive Columns RE thru RI—Daily Volume (Product SDs Cols RE thru RI) This is where the Standard Deviations calculated for Company-specific Precessive Daily Volume Trading Date Relationals' Directional Indicators of Change Columns RE thru RI are multiplied together to form a single product.

VM) Product of SDs of Precessive Columns RO thru RS—Fails to Deliver (Product SDs Cols RO thru RS) This is where the Standard Deviations calculated for Company-specific Precessive Fails to Deliver Trading Date Relationals' Directional Indicators of Change Columns RO thru RS are multiplied together to form a single product.

VN) Product of SDs of Precessive Columns RY thru SC—Daily Short Volume (Product SDs Cols RY thru SC) This is where the Standard Deviations calculated for Company-specific Precessive Daily Short Volume Trading Date Relationals' Directional Indicators of Change Columns RY thru SC are multiplied together to form a single product.

### Daily Trading Date Relationals—Directional Indicators of Change—Successive—Product

VO) Product of SDs of Successive Columns OE thru OG—Daily Close Prices (Product SDs Cols QE thru QG) This is where the Standard Deviations calculated for Company-specific Successive Daily Closing Prices Trading Date Relationals' Directional Indicators of Change Columns QE thru QG are multiplied together to form a single product.

VP) Product of SDs of Successive Columns OO thru QQ—Daily High Prices (Product SDs Cols QO thru QQ) This is where the Standard Deviations calculated for Company-specific Successive Daily High Prices Trading Date Relationals' Directional Indicators of Change Columns QO thru QQ are multiplied together to form a single product.

VQ) Product of SDs of Successive Columns OY thru RA—Daily Low Prices (Product SDs Cols QY thru RA) This is where the Product of the Standard Deviations calculated for Company-specific Successive Daily Low Prices Trading Date Relationals' Directional Indicators of Change Columns QY thru RA are multiplied together to form a single product.

VR) Product of SDs of Successive Columns RI thru RK—Daily Volume (Product SDs Cols RI thru RK) This is where the Standard Deviations calculated for Company-specific Successive Daily Volume Trading Date Relationals' Directional Indicators of Change Columns RI thru RK are multiplied together to form a single product.

VS) Product of SDs of Successive Columns RS thru RU—Fails to Deliver (Product SDs Cols RS thru RU) This is where the Standard Deviations calculated for Company-specific Successive Fails to Deliver Trading Date Relationals' Directional Indicators of Change Columns RS thru RU are multiplied together to form a single product.

VT) Product of SDs of Successive Columns SC thru SE—Daily Short Volume (Product SDs Cols SC thru SE) This is where the Standard Deviations calculated for Company-specific Successive Daily Short Volume Trading Date Relationals' Directional Indicators of Change Columns SC thru SE are multiplied together to form a single product.

### Multi-Trade Date Relational—Directional Indicators of Change—Product

VU) Product of SDs of Columns OH thru QJ—Daily Closing Prices (Product SDs Cols QH thru QJ) This is where the Standard Deviations calculated for Company-specific Daily Closing Prices Multi-Trade Date Relationals' Directional Indicators of Change in Columns QH thru QJ are multiplied together to form a single product.

VV) Product of SDs of Columns OR thru QT—Daily High Prices (Product SDs Cols QR thru QT) This is where the Standard Deviations calculated for Company-specific Daily High Prices Multi-Trade Date Relationals' Directional Indicators of Change in Columns QR thru QT are multiplied together to form a single product.

VW) Product of SDs of Columns RB thru RD—Daily Low Prices (Product SDs Cols RB thru RD) This is where the Standard Deviations calculated for Company-specific Daily Low Prices Multi-Trade Date Relationals' Directional Indicators of Change in Columns RB thru RD are multiplied together to form a single product.

VX) Product of SDs of Columns RL thru RN—Daily Volume (Product SDs Cols RL thru RN) This is where the Standard Deviations calculated for Company-specific Daily Volume Multi-Trade Date Relationals' Directional Indicators of Change in Columns RL thru RN are multiplied together to form a single product.

VY) Product of SDs of Columns RV thru RX−Fails to Deliver (Product SDs Cols RV thru RX) This is where the Standard Deviations calculated for Company-specific Fails to Deliver Multi-Trade Date Relationals' Directional Indicators of Change in Columns RV thru RX are multiplied together to form a single product.

VZ) Product of SDs of Columns SF thru SH—Daily Short Volume (Product SDs Cols SF thru SH) This is where the Standard Deviations calculated for Daily Short Volume Multi-Trade Date Relationals' Directional Indicators of Change in Columns SF thru SH are multiplied together to form a single product.

This concludes the Quaternary Level of Assembling spreadsheet Columns that comprise a non-definitive, non-conclusive variety or array of the Inter- and/or Infra-Row and/or Inter- and/or Infra-Columnar Pre-algorithmic and/or Algorithmic analyses of date-specific entry, particularly those that compare entries from the Tertiary Level Directionals identifying parameters that begin the establishment of identifiable Trade Date-related patterns affiliated with non-trading specifics, previously noted as Items of Focus. These calculations assisted in whole, in part and/or in conjunction with other Column and/or Row entries with specific entries in refining, defining, and/or specifying A Process for the Detection and Identification of Idiosyncratic Valuations by Intent in Equities Commerce and Other Illegal Equity Trades in U.S. Domestic Stock Markets.

### Quinary Level

What follows is the Quinary Level of Assembling spreadsheet Columns, one that comprises a non-definitive, non-conclusive variety or array of the Inter- and/or Infra-Row and/or Inter- and/or Infra-Columnar Pre-algorithmic and/or Algorithmic analyses of date-specific entries, particularly those that compare entries from the Tertiary and Quaternary Level Directional Indicators identifying parameters that establish patterns affiliated with certain non-trading specifics, noted earlier as Items of Focus. Before doing this, a weighing must be performed on some of the data entered in the four previous levels, as raw data; as results from comparatives; as sequential combinations. The principal measures to be undertaken in this level will be: establishing bases to be used in subsequent calculations; composing a range of Standard Deviations; determining normal patterns—ambiguous, primarily random—as well as deviant patterns—deliberate, with intent beyond mere acquisition or disposition of derivative assets. These bases and subsequent Standard Deviation calculations assist in whole, in part and/or in conjunction with other Column and/or Row entries with specific entries in refining, defining, clarifying and/or specifying A Process for the Detection and Identification of Idiosyncratic Valuations by Intent in Equities Commerce and Other Illegal Equity Trades in U.S. Domestic Stock Markets.

(See Note 60 for adjusting to the changes in Settlement Date as of Sep. 5, 2017.)

Note 74: To accomplish what follows, the specific Directional Indicators must first be translated into a single cell, as a single digit. As noted earlier, since there are three possibilities for each specific, instead of a binary “0” or “1”, it must be a tenary of “O” or “1” or “2”. For demonstration purposes and consistency in this Process Description, a “1” represents an up directional indicator; a “2” represents a down directional indicator and a “0” represents a relative no-change indicator (no-change or “indeterminate” covers a small range of + 1/50th of 1% or 0.02% change either up or down and be equal to a ‘no change’ designation. It amounts to a 1/25th of 1% range as being equal to ‘no change’ effect. (See Notes 31 thru 34, above) The actual representational symbols used are not particularly relevant outside of their specific use as Directional Indicators and only that they be consistent. Each could as easily be random symbols, so long as they are used consistent to their definitions. That numeric symbols might be used would not confer value outside of the immediate similarity/difference they represent.

Note 75: In this section, all of the Directional Indicators of a given subject's trading date's date-relational factors or categories, those being the Close; the High; the Low, the Daily Volume; the Fails to Deliver and the Daily Short Volume will be applied. To accomplish this, the specific Directional Indicators' combinations or Aggregates must first be entered into a single cell, as a single series of digits, comprised of appropriate 0's, 1's and 2's. (See Notes: 31 thru 34 and 74 above.) This combination entry shall be listed, each single combining entry to a given cell being separated by a punctuation mark or other chosen separator. As an example: In a given 7-day series for all seven Directional Indicator Aggregates (DIAs) used in the Second Phase of Trade Date Serial Comparison Column_Directional Indicator Aggregation_Layer One—Individual Trade Dates: for a Close (See below) (Col E) category, with Col E−4 is up; Col E−3 is up; Col E−2 is down; Col E−1 is no change; Col E+0 is down; Col E+1 is up; Col E+2 is down, the resulting entry into the specific cell for that Trade Date Relational Series would be:
“1-1-2-0-2-1-2”
   Or it could just as easily be:
“1:1:2:0:2:1:2”
   Or some other version. So long as clearly defined designations and separations are used and followed, particulars aren't specifically relevant.

Note 76: In this section, specific formula are unnecessary as the specific results of each is obvious.

Note 77: For Columnar abbreviation, Directional Indicator Aggregation shall be shortened to DIA.

Note 78: In the First Phase, Each Part (One thru Six−Close thru Short Volume) shall be divided into two Layers. The First Layer shall be in a series that comprises DIAs of multi-day periods of Trade Dates (five Trade Date entries, from Col x−4 thru Col x+0) comprising the first five date-relational entries (referred to as the Precessive Directional Indicator Aggregation or Pre-DIA or P-DIA) followed by the Second Layer DIAs of multi-day periods of Trade Date (three Trade Date entries, from Col x+0 thru Col x+2) comprising the last three date-relational entries (referred to as the Successive Directional Indicator Aggregation or Suc-DIA or S-DIA). A Third Layer would be a combining of the first two Layers, without internal repetition of the Col x+0 entry; in this Process Description that entire seven-day period follows in the Second Phase of Trade Date Serial Comparison Column_Directional Indicator Aggregation_Layer One—Individual Trade Dates. The sequence for each Layer as being separated into two sections before combining for the third Layer is not to exclude the option of listing individual Trade Dates for each Part followed immediately by its complementary multi-Trade Date periods, in effect a weaving of the two. That is the option of the spreadsheet constructor, so long as relational consistency is maintained.

Note 79: In the Second Phase, Each Part (One thru Six−Close thru Short Volume) shall be divided into two Layers. The first Layer shall be in a series that comprises DIAs for individual Trade Dates (the entire seven Trade Date entries, from Col x−4 thru Col x+2) followed by the second Layer DIAs of multi-day periods of Trade Date (three Trade Date-related entries) change.

Note 80: Once all Layers have been entered, there will be additional columns that represent comparatives and aggregations that utilize the data described above. That will require an appendicied spreadsheet that arises from a template described below.

Note 81: Columnar Identification will proceed with double-alphabetic designation Column Wx beginning here.

### First Phase of Trade Date Serial Comparison Column

### Precessive Directional Indicator Aggregation

WA) Company Specific Series—Precessive Directional Indicator Aggregation Part One—Daily Closing Price (Pre-DIA Col JA thru Col JE) or (Pre-DIA JE thru JE) This is where the Precessive Directional Indicators (Pre-DIs) of entries in Column JA thru Column JE are aggregated into a single cell.

WB) Company Specific Series—Precessive Directional Indicator Aggregation Part Two—Daily High Price (Pre-DIA Col JK thru Col JO) or (Pre-DIA JK thru JO) This is where the Precessive Directional Indicators (Pre-Dls) of entries in Column JK thru Column JO are aggregated into a single cell.

WC) Company Specific Series—Precessive Directional Indicator Aggregation Part Three—Daily Low Price (Pre-DIA Col JU thru Col JY) or (Pre-DIA JU thru JY) This is where the Precessive Directional Indicators (Pre-DIs) of entries in Column JU thru Column JY are aggregated into a single cell.

WD) Company Specific Series—Precessive Directional Indicator Aggregation Part Four—Daily Volume (Pre-DIA Col KE thru Col KI) or (Pre-DIA KE thru KI) This is where the Precessive Directional Indicators (Pre-DIs) of entries in Column KE thru Column KI are aggregated into a single cell.

WE) Company Specific Series—Precessive Directional Indicator Aggregation Part Five—Fails to Deliver (Pre-DIA Col KO thru Col KS) or (Pre-DIA KO thru KS) This is where the Precessive Directional Indicators (Pre-DIs) of entries in Column KO thru Column KS are aggregated into a single cell.

WF) Company Specific Series—Precessive Directional Indicator Aggregation Part Six—Daily Short Volume (Pre-DIA Col KY thru Col LC) or (Pre-DIA KY thru LC) This is where the Precessive Directional Indicators (Pre-DIs) of entries in Column KY thru Column LC are aggregated into a single cell.

### First Phase of Trade Date Serial Comparison Column

### Successive Directional Indicator Aggregation

WG) Company Specific Series—Successive Directional Indicator Aggregation Part One—Daily Closing Price (Suc-DIA Col JE thru Col JG) or (Suc-DIA JE thru JG) This is where the Successive Directional Indicators (Suc-DIs) of entries in Column JE thru Column JG are aggregated into a single cell.

WH) Company Specific Series—Successive Directional Indicator Aggregation Part Two—Daily High Price (Suc-DIA Col JO thru Col JQ) or (Suc-DIA JO thru JQ) This is where the Successive Directional Indicators (Suc-DIs) of entries in Column JO thru Column JQ are aggregated into a single cell.

WI) Company Specific Series—Successive Directional Indicator Aggregation Part Three—Daily Low Price (Suc-DIA Col JY thru Col KA) or (Suc-DIA JY thru KA) This is where the Successive Directional Indicators (Suc-DIs) of entries in Column JY thru Column KA are aggregated into a single cell.

WJ) Company Specific Series—Successive Directional Indicator Aggregation Part Four—Daily Volume Price (Suc-DIA Col KI thru Col KK) or (Suc-DIA KI thru KK) This is where the Successive Directional Indicators (Suc-DIs) of entries in Column KI thru Column KK are aggregated into a single cell.

WK) Company Specific Series—Successive Directional Indicator Aggregation Part Five—Fails to Deliver (Suc-DIA Col KS thru Col KU) or (Suc-DIA KS thru KU) This is where the Successive Directional Indicators (Suc-DIs) of entries in Column KS thru Column KU are aggregated into a single cell.

WL) Company Specific Series—Successive Directional Indicator Aggregation Part Six—Daily Short Volume (Suc-DIA Col LC thru Col LE) or (Suc-DIA LC thru LE) This is where the Successive Directional Indicators (Suc-DIs) of entries in Column LC thru Column LE are aggregated into a single cell.

### Second Phase of Trade Date Serial Comparison Column

### Directional Indicator Aggregation

### Layer One—Individual Trade Dates

WM) Company Specific Series—Directional Indicator Aggregation Part One—Daily Closing Price (DIA Col JA thru Col JG) or (DIA JA thru JG) This is where the Directional Indicators (DIs) of entries in Column JA thru Column JG are aggregated into a single cell.

WN) Company Specific Series—Directional Indicator Aggregation Part Two—Daily High Price (DIA Col JK thru Col JQ) or (DIA JK thru JQ) This is where the Directional Indicators (DIs) of entries in Column JK thru Column JQ are aggregated into a single cell.

WO) Company Specific Series—Directional Indicator Aggregation Part Three—Daily Low Price (DIA Col JU thru Col KA) or (DIA JU thru KA) This is where the Directional Indicators (DIs) of entries in Column JU thru Column KA are aggregated into a single cell.

WP) Company Specific Series—Directional Indicator Aggregation Part Four—Daily Volume (DIA Col KE thru Col KK) or (DIA KE thru KK) This is where the Directional Indicators (DIs) of entries in Column KE thru Column KK are aggregated into a single cell.

WQ) Company Specific Series—Directional Indicator Aggregation Part Five—Fails to Deliver (DIA Col KO thru Col KU) or (DIA KO thru KU) This is where the Directional Indicators (DIs) of entries in Column KO thru Column KU are aggregated into a single cell.

WR) Company Specific Series—Directional Indicator Aggregation Part Six—Daily Short Volume (DIA Col KY thru Col LE) or (DIA KY thru LE) This is where the Directional Indicators (DIs) of entries in Column KY thru Column LE are aggregated into a single cell.

### Second Phase of Trade Date Serial Comparison Column

### Directional Indicator Aggregation

### Layer Two—Multi-Trade Date Sequences

WS) Company Specific Series—Directional Indicator Aggregation of Multi-Trade Date Sequences Part One—Daily Closing Price (DIA Col JH thru Col JJ) or (DIA JH thru JJ) This is where the Directional Indicators (DIs) of entries in Column JH thru Column JJ are aggregated into a single cell.

WT) Company Specific Series—Directional Indicator Aggregation of Multi-Trade Date Sequences Part Two—Daily High Price (DIA Col JR thru Col JT) or (DIA JR thru JT) This is where the Directional Indicators (DIs) of entries in Column JR thru Column JT are aggregated into a single cell.

WU) Company Specific Series—Directional Indicator Aggregation of Multi-Trade Date Sequences Part Three—Daily Low Price (DIA Col KB thru Col KD) or (DIA KB thru KD) This is where the Directional Indicators (DIs) of entries in Column KB thru Column KD are aggregated into a single cell.

WV) Company Specific Series—Directional Indicator Aggregation of Multi-Trade Date Sequences Part Four—Daily Volume (DIA Col KL thru Col KN) or (DIA KL thru KN) This is where the Directional Indicators (DIs) of entries in Column KL thru Column KN are aggregated into a single cell.

WW) Company Specific Series—Directional Indicator Aggregation of Multi-Trade Date Sequences Part Five—Fails to Deliver (DIA Col KV thru Col KX) or (DIA KV thru KX) This is where the Directional Indicators (DIs) of entries in Column KV thru Column KX are aggregated into a single cell.

WX) Company Specific Series—Directional Indicator Aggregation of Multi-Trade Date Sequences Part Six—Daily Short Volume (DIA Col LF thru Col LH) or (DIA LF thru LH) This is where the Directional Indicators (DIs) of entries in Column LF thru Column LH are aggregated into a single cell.

Note 82: In this section, since all prior Directional Indicator Aggregates were Columnar oriented (vertically) or category-specific, a modified application of DIAs must be made to the collective daily changes horizontally as well. In this case, there will only be single entries representing the specific Trade Date's one-day Directional Change Indicator details of Open (CJ), High (CA), Low (CB), and Close (CC) for an “-of-Four” series and the specific Trade Date's one-day DIA details of Daily Volume (CD), Daily Fails to Deliver (CE), and Daily Short Volume (CG) for an “-of-Three” series.

Note 83: In this section, the same rules and processes applied to columnar DIAs will be applied here.

WY) Company Specific Day's Price Data Directional Indicator Aggregation—including Open. High, Low and Close (DIA of Row Details for Col CJ, CA, CB, CC) This is where the Directional Indicators for the day's trading price data of the Trade Date being examined is entered.

WZ) Company Specific Day's Volumetric Data Directional Indicator Aggregation—including Daily Volume. Fails to Deliver and Short Volume (DIA of Row Details for Col CD, CE, CG) This is where the Directional Indicators for the day's volumetric data of the Trade Date being examined is entered.

It is at this point in the Quinary Level of Assembling spreadsheet Columns that it is both possible and necessary to construct several separate spreadsheets and accompanying tables as Company-specific Appendices and Display Tables—(as well as Pop-up Tables, Charts and Displays for electronic spreadsheet formats) that will perform the following operations.

The above noted creation of necessitated additional spreadsheets requires the designs of templates for these specialized informational constructs. It is these designs which are to be described below.

### APPENDIX TEMPLATE AND TABLES ASSEMBLY TO QUINARY LEVEL

### Notes, Reference Tables/Data, Processes

### COMPANY-SPECIFIC APPENDIX TABLE—1

### Repeated in the Appropriate Appendices for Reference

Note 01-A: What follows is a description of a spreadsheet template for the applied resulting table, referred to as: Company-specific Appendix Table—1, used to perform certain measures regarding the results from the various Directional Indicator Aggregates from both Phases of Trade Date Serial Comparison Columns. The template will start with the usual organization similar to the one described in the Primary Level.
Alpha Column Title entries are initially Alphabetic (for brevity and to distinguish from Row entries) and entered in full on Row 0.
Alpha Row entries are initially Numeric and are entered in full on Column 0, are whole-number sequential and progress downward.

Note 02-A: In the sections that follow, the first section of the template will inform on the number of possible unique tenary base (0, 1, 2) combinations utilizing all seven of the sequences for all seven Directional Indicator Aggregates (DIAs) used in the Second Phase of Trade Date Serial Comparison Column_Directional Indicator Aggregation_Layer One—Individual Trade Dates; the possible unique combinations of sequences for all five Directional Indicator Aggregates (DIAs) used in the First Phase of Trade Date Serial Comparison Column_Precessive Directional Indicator Aggregation; the possible unique combinations of sequences for all three Directional Indicator Aggregates (DIAs) used in First Phase of Trade Date Serial Comparison Column_Successive Directional Indicator Aggregation as well as all three Directional Indicator Aggregates (DIAs) used in Second Phase of Trade Date Serial Comparison Column_Directional Indicator Aggregation_Layer Two—Multi-Trade Date Sequences.

Note 03-A: In this section, the Potential Number of Directional Indicator Aggregate Matches of each Trade Date Relational Series will be determined. It will begin with finding how many possible tenary base (0, 1, 2) combinations there could be. This will be determined for the Trade Date Relational Series having seven Directional Indicators of the seven-digit entry sets, then six-of-seven, then five-of-seven, four-of-seven, three-of-seven and two-of-seven. Each of these possible combinations will be calculated noting both position and tenary base unit. (Example is for five-of-seven: “x-1-0-2-2-x-1” being a unique possible where the “x” is a non-matchable entry yet exists to maintain the positional relationship of the other entries in this example. (See Note 06-A below for full description of “space-holding” entries.) This shown entry will be considered different from another five of seven “x-x-1-0-2-2-1” which uses the same tenary base entries and order yet by being in different positions signify a different seven-digit entry as a unique five-of-seven set. Therefore, when calculating the potential unique combinations of seven-digit tenary base entries with five matches in the same five of the seven positions and not matching in the other two positions, these distinctions must be considered and accounted for Thus, for any given five-of-seven entry from the trading data, there will exist four different possible, matchable entries from the whole of the “-of-seven” trading data entries. Each will be treated as a separate “matchable” (See Row ID description details below). This will be followed by the various sets that involve five Directional Indicators, noting those with all five-of-five, four-of-five, three-of-five and two-of-five. These requirements will be true also for all other sets and parts of sets.) Once the “of-seven” series is determined there will follow the various sets that involve five Directional Indicator series, noting those with all five-of-five, then four-of-five, three-of-five and two-of-five and finishing with the three Directional Indicator series, noting those with all three-of-three, then two-of-three. Any of the -of-seven, -of-five or -of-three sets that have only “one-of-” potential match is deemed too minimal to be of value to this process, nearly on a par with those of any set with no matchable entries.

Note 04-A: In this section, the -of-seven” series will be documented by entering every one of the possible seven-entry columns with a regimented process in order to assign a specific row number identifier to each possible seven-digit tenary base combination, beginning with 0-0-0-0-0-0-0, proceeding with 0-0-0-0-0-0-1, then 0-0-0-0-0-0-2, and then 0-0-0-0-0-1-0, then 0-0-0-0-0-1-1 and so on and concluding with 2-2-2-2-2-2-2. In effect, it will act the same as a decimal system (base 10) or a binary system (base 2) but using three digits: “0”, “1”, and “2” as described elsewhere. This will require 37 number of rows, or 2187 rows, indicating there will be 2187 possible combinations using three digits (tenary base) in all seven columns. The purpose of this listing of possible tenary combinations is to assign a number (Row number—always in decimal base or base 10 for this process description) specific to a specific unique combination.

Note 05-A: In this section, because all seven column entry combinations are listed with identifying Row numbers it is now possible to use the same Row-assigning process of unique combinations to identify instances where there are less than seven-of-seven entry matchables, to assign unique matchless combinations within seven non-totally matching entries and to determine how many possible combinations where six-of-seven, five-of-seven, four-of-seven, three-of-seven, two-of-seven there would exist from any given range of series' entries. Thus, there would be 3⁶×2=1458 six-of-seven possible unique combinations that would display without having a seven-of-seven digit match as well. So for five-of-seven here would be 3⁵×22=972 possible unique combinations that would display without having a seven-of-seven or six-of-seven digit match. This progression continues in the same manner: where four-of-seven digit unique combination displays are 3⁴×2³=648; three-of-seven digit displays are 3³×2⁴=432; and two-of-seven digit display entries would be 32×2⁵=288 possible displays where sevens- sixes- fives- fours- or threes-of-seven, respectively, in the same positions, respectively, displays where any of the other three, four or five do not, respectively.

Note 06-A: In this section, where all “six” or lower order “-of-seven” series are being Row Number Identified, it must be noted that when listing all possible lower order sets, the non-matching entries must be included by a non-numeric place holder and there must be two of them (two non-matching placeholders for a tenary system). For purposes of this process description, a “y” and a “z” will be used. Exactly which one (or optional others) is used by a constructor is up to the individual. In each case, the “y” or “z” will represent the non-matching column entry. This facilitates the accounting for all non-matching positional variables of a given set while still allowing for an accurate count of each possible “-of-seven” non-matches for Row Identification.

Note 07-A: In this section, just as the process for seven-digit entries went through the identifying schema of unique seven-digit combinations were each assigned an identifying decimal base Row number, so too, that same process will be done with five-column series and three-column series. And since there will come as of Sep. 5, 2017, a shortened seven-column entry to a six-column entry and the five-column entry will become a four-column entry, both the six-column and four-column calculations and identification numbering process must be conducted. (Since the three-column entries are not affected by the change in Settlement Dates, there is no need to have a two-column entry series constructed. In the earlier sections where seven and five Multi-Trade Date Sequences were determined, they themselves were changed regarding their respective sizes at the appropriate spreadsheet entry points, also specific to Sep. 5, 2017 and after) Furthermore, there is neither continuation of nor inclusion to the “-of-Seven” entries with the entirety of the “-of-Six” entries and the same holds true regarding the “-of-Five” having no association with the entries under the “-of-Four” entries, either direction. They do not mix. Therefore,
For six-column entries, there will be 3⁶=729 possible unique six-of-six-column entries; 3⁵×2=486 possible unique five-of-six-column entries that would not have a six-digit match; 3⁴×22=324 possible unique four-of-six-column entries that would not have a six-digit or five-digit match; 3³×2³=216 possible unique three-of-six-column entries that would not have a six-digit or five-digit or four-digit match; and 32×2⁴=144 possible unique two-of-six-column entries that would not have a six- or five- or four- or three-digit match.
For five-column entries, there will be 3⁵=243 possible unique five-of-five-column entries; 3⁴×2=162 possible unique four-of-five-column matching entries that would not have a five-digit match; 3³×22=108 possible unique three-of-five-column entries that would not have a five-digit or four-digit match; and 32×2³=72 possible unique two-of-five-column entries that would not have a five-digit or a four-digit or a three-digit match.
For four-column entries, there would be 3⁴=81 possible unique four-of-four-column entries; 3³×2=54 possible unique three-of-four-column entries that would not have a four-of-four-digit match; and 32×22=36 possible unique two-of-four-column entries that would not have a four-digit or three-digit match.
For three-column entries, there would be 3³=27 possible unique three-of-three column entries; and 32×2=18 possible unique two-of-three column entries that would not have a three-of-three-digit match.

Note 08-A: In this section, given the procedures described above in Notes 01-A thru 07-A there is now a means of labeling the Columns. This will also give full nature to the specific identification of each potential tenary combination specific to its circumstances. Since this is both a template and a table and the Quinary Columns listing halted at this point, a random prefix for the following might be TT-Ax, being Template/Table Col x with the “x” being the specific Column in question, abbreviated to TT-Ax so for Column A it would be TT-AA, followed by TT-AB, TT-AC and so on. It could be whatever the constructor decides but for brevity and consistency in this Process Description that is what will be used. For this series, all internal Template/Table Column identifications are Template/Table referent only.

Following the rules stated in the Notes above, thus:

TT-AA) Seven-of-Seven Tenary [(7/7) 2187] This is the column where every possible seven-of-seven-digit tenary base entry will be listed. Each cell will have its own spreadsheet identification and will, by Row number, represent all possible seven-of-seven combinations.

TT-AB) Six-of-Seven Tenary [(6/7) 1458] This is the column where every possible six-of-seven-digit tenary base entry will be listed. Each cell will have its own spreadsheet identification and will, by Row number, represent all possible six-of-seven combinations.

TT-AC) Five-of-Seven Tenary [(5/7) 972] This is the column where every possible five-of-seven-digit tenary base entry will be listed. Each cell will have its own spreadsheet identification and will, by Row number, represent all possible five-of-seven combinations.

TT-AD) Four-of-Seven Tenary [(4/7) 648] This is the column where every possible four-of-seven-digit tenary base entry will be listed. Each cell will have its own spreadsheet identification and will, by Row number, represent all possible four-of-seven combinations.

TT-AE) Three-of-Seven Tenary [(3/7) 432] This is the column where every possible three-of-seven-digit tenary base entry will be listed. Each cell will have its own spreadsheet identification and will, by Row number, represent all possible three-of-seven combinations.

TT-AF) Two-of-Seven Tenary [(2/7) 288] This is the column where every possible two-of-seven-digit tenary base entry will be listed. Each cell will have its own spreadsheet identification and will, by Row number, represent all possible two-of-seven combinations.

TT-AG) Six-of-Six Tenary [(6/6) 729] This is the column where every possible six-of-six-digit tenary base entry will be listed. Each cell will have its own spreadsheet identification and will, by Row number, represent all possible six-of-six combinations.

TT-AH) Five-of-Six Tenary [(5/6) 486] This is the column where every possible five-of-six-digit tenary base entry will be listed. Each cell will have its own spreadsheet identification and will, by Row number, represent all possible five-of-six combinations.

TT-AI) Four-of-Six Tenary [(4/6) 324] This is the column where every possible four-of-six-digit tenary base entry will be listed. Each cell will have its own spreadsheet identification and will, by Row number, represent all possible four-of-six combinations.

TT-AJ) Three-of-Six Tenary [(3/6) 216] This is the column where every possible three-of-six-digit tenary base entry will be listed. Each cell will have its own spreadsheet identification and will, by Row number, represent all possible three-of-six combinations.

TT-AK) Two-of-Six Tenary [(2/6) 144] This is the column where every possible two-of-six-digit tenary base entry will be listed. Each cell will have its own spreadsheet identification and will, by Row number, represent all possible two-of-six combinations.

TT-AL) Five-of-Five Tenary [(5/5) 243] This is the column where every possible five-of-five-digit tenary base entry will be listed. Each cell will have its own spreadsheet identification and will, by Row number, represent all possible five-of-five combinations.

TT-AM) Four-of-Five Tenary [(4/5) 162] This is the column where every possible four-of-five-digit tenary base entry will be listed. Each cell will have its own spreadsheet identification and will, by Row number represent all possible four-of-five combinations.

TT-AN) Three-of-Five Tenary [(3/5) 108] This is the column where every possible three-of-five-digit tenary base entry will be listed. Each cell will have its own spreadsheet identification and will, by Row number represent all possible three-of-five combinations.

TT-AO) Two-of-Five Tenary [(2/5) 72] This is the column where every possible two-of-five-digit tenary base entry will be listed. Each cell will have its own spreadsheet identification and will, by Row number, represent all possible two-of-five combinations.

TT-AP) Four-of-Four Tenary [(4/4) 81] This is the column where every possible four-of-four-digit tenary base entry will be listed. Each cell will have its own spreadsheet identification and will, by Row number, represent all possible four-of-four combinations.

TT-AQ) Three-of-Four Tenary [(3/4) 54] This is the column where every possible three-of-four-digit tenary base entry will be listed. Each cell will have its own spreadsheet identification and will, by Row number represent all possible three-of-four combinations.

TT-AR) Two-of-Four Tenary [(2/4) 36] This is the column where every possible two-of-four-digit tenary base entry will be listed. Each cell will have its own spreadsheet identification and will, by Row number, represent all possible two-of-four combinations.

TT-AS) Three-of-Three Tenary [(3/3) 27] This is the column where every possible three-of-three-digit tenary base entry will be listed. Each cell will have its own spreadsheet identification and will, by Row number represent all possible three-of-three combinations.

TT-AT) Two-of-Three Tenary [(2/3) 18] This is the column where every possible two-of-three-digit tenary base entry will be listed. Each cell will have its own spreadsheet identification and will, by Row number represent all possible two-of-three combinations.

Note 09-A: In this section, there will be an adjusted listing of the counts shown above of the full sets of potential unique matchless possible entries for each of the prior TT-Ax series. (See Notes 01-A thru 08-A.) They are shown in Note 05-A for the “-of-seven” series and in the bullet points of Note 07-A. These numeric results can be placed in their own column(s) or row(s); or, before or after the listing of each category in that category's specific column, as was done in this process description above.

Note 10-A: Since it is possible, appropriate and necessary to decimalize these numbers by moving the decimal point one or two or more spaces to the left; or, both, (seven-of-seven=2187 becomes 218.7 and/or 21.87) here and/or in subsequent listings, as long as they all receive the same relative treatment and each represents the same category, respectively, it should be done. And better, it can be decimalized in a descending order of hierarchy per “-of-x” series sets, one decimal point per hierarchical step lower. As an example: for the “-of-seven” series, starting with the seven-of-seven being 2187, moving the decimal one column left for the six-of-seven, it would then become 145.8 instead of the full 1458; the five-of-seven would become 9.72 instead of its original 972; the four-of-seven would be 0.648 instead of 648; the three-of-seven would become 0.0432 and the two-of-seven would be 0.00288. For the “-of-six” series, the process would be six-of-six remains 729; the five-of-six becomes 48.6; the four-of-six would be 3.24; the three-of-six would be 0.216 and the two-of-six translates into 0.0144. The same treatment for the whole series of sets by category is shown in full below. This decimalization in a descending order of hierarchy per “-of-x” series sets is the method used in this process. This decimalization in a descending order of hierarchy per “-of-x” series sets will produce a definitive distinction of valuation that forces each lower order “v-of-x” series to be appropriate for the field (-of-x) from which each is drawn. It gives greater value to a three-of-four set than a three-of-seven set. This can be done at the application point in the main spreadsheet or in the Appendix Template and Tables Assembly of which this is merely the template. It is done here at this point, for this process description.

Note 11-A: In this section, for purposes of this Process Description of the Appendix Template and Tables Assembly, the numerics* of each column shall be included. (*By “numerics” in this context, it is meant “the total numbers of” or “quantity of” for each category that fit the descriptions and requirements and limitations respective to each column entry date being examined. Therefore, for the given spreadsheet date, under each of the listed categories, the quantity of all seven-of-seven matches for the entire subject will be listed, then all six-of-seven combinations that match—to that specific date, from all the other spreadsheet entries for that subject in the same column, and so on. For specific entry counts, see Note 03-A thru Note 06-A plus bullet points in Note 06-A.)

Note 12-A: In this section, each of these possible series sets (seven-of-seven; six-of-seven; . . . three-of-three; two-of-three) will be listed in their own columns with the resultant matches derived from the Trade Date associative data (Col x−4 thru Col x+2) for each category (Close; High; Low; Daily Volume; Fails to Deliver and Daily Short Volume), displayed under their respective Columnar ID by category and set, listing each identifiable combination by Numeric Row ID and the number of components that match that specific set Numeric Row. [Examples: From a hypothetical Four-of-Six specific date entry (U.S. date notation) 10-10-17 Row I.D. 79 (Post-Sep. 5, 2017) with eleven matches in the entries column for that Trade Date's “Close” category, the entry for a Four-of-Six match set would read 79-11. A second yet different Four-of-Six match set with a specific Row I.D. of 32 with seven matches would be entered as 32-7 in the same Four-of-Six category column. Likewise, a Three-of-Seven specific date entry Row I.D. 91 with sixteen matches would be entered to the Three-of-Seven category column as 91-16 and a second Three-of-Seven match set to Three-of-Seven Row I.D. of 30 with twenty-one matches would be entered as 30-21.] For each Trade Date, the entire listing of each appropriate category will be run, one Trade Date at a time. The column count will be large. [For example: For the Close, with the Pre-September 5, “-of-seven” series there would be six separate columns—six since there is no “one-of-x” columns, each listing the appropriate matching combinations for a given Trade Date being examined. Likewise, since there are also “-of-five” series sets (for Trade Dates on or after Sep. 5, 2017 “-of-six” series sets and “-of-four” series sets instead of the “-of-seven” and “-of-five” series sets, respectively) as well as “-of-three” series sets—both before and after Sep. 5, 2017, each would be columnarly listed for all of the respective Close data for each Trade Date. This process will continue for each of the other categories.]

Note 13-A: In this section, each match in each category for each date being examined should be entered by specific Row I.D. delineated in the TT-AA thru TT-AT columns, followed by the specific number of matches of each specific qualifying sequence in that category. These Row I.D.s and their respective counts could be placed in a separate spreadsheet that acts as a Table and held in a Quinary Level Table or alternative section of the current one and referenced by a single column number for each category for each specific date and the specific matches count along side.

Note 14-A: In this section, when each quantity for each appropriate Row I.D. is tallied and noted, the total is then multiplied by its appropriate set multiplier and entered at the bottom, either at the bottom of each Row I.D. tally or, preferably, at the bottom of each category section set match tallies, (Column location) using the Row I.D. and then the multiplied results. [Per example above: in Note 12-A Four-of-Six specific date entry Row I.D. 79 (Post-Sep. 5, 2017) with eleven matches in the entries column for that category, the entry for a Four-of-Six match set would read 79-11, the multiplier being 3.24, the results would be 35.64 and be entered as 79*35.64 (the “*” symbol is arbitrary but should be distinguishable from other symbols used elsewhere). The 32-7 would then be entered, the results of its multiplier 3.24 being 22.68 it would be entered as 32*22.68 or both could be entered once all the appropriate set matches are entered in the column. Adding the Trade Date and “Close” to that final entry would further identify it, as in “10-10-17 Close 4/6 32*22.68”. The previous Four-of-Six specific date entry Row I.D. 79*35.64 results would be entered as “10-10-17 Close 4/6 79*35.64.] When all such category section set match tallies' multiplied results are entered, a final entry for sum of the entire set matches is entered, properly identified as such. [As per example above, the 79-11 results of 79*35.64 would be added to the 32-7 results of 32*22.68 whose sum would be entered as 4/6**58.32. (Again, the “**” being arbitrary but demonstrates a needed distinction from other symbols used and in this application would identify it as a combined category set total.) Adding the Trade Date and “Close” to that final entry would further identify it, as in “10-10-17 Close 4/6**58.32” (U.S. date notation) for future reference.]

Note 15-A: In this section, it requires the emphasis that the following is to be performed for each Trade Date, Columns TT-BA thru TT-GT, in the construction of the Tables Assembly. The most effective application is likely to display each successive Trade Date by Row, appropriately labeled, with each Column entered across the Top Row (Pre- or Post-Sep. 5, 2017, appropriately/respectively) with the “Pre-” being the “-of-seven” (Col x−4 thru Col x+2); the “-of-five” (Col x−4 thru Col x+0); and the “-of-three” (Col x+0 thru Col x+2) and the “Post-” being the “-of-six” (Col x−3 thru Col x+2); the “-of-four” (Col x−3 thru Col±0) and the “-of-three” (Col x+0 thru Col x+2).

Note 16-A: It should be noted that each entry match will be entered in/for each date for which the match exists. Matches need to be recorded to each date with searchable reveal since each represents an identifiable pattern and the locations and thus context of the components of each pattern is one of the principle detection techniques or tools of this entire process. There are various common techniques for designing this reveal, much like those for determining Standard Deviations, and any one or another would suffice so long as it is searchable by date; by category; by Row I.D.; by first, second and subsequent valuations; by multiples; etc.

### Close

TT-BA) Seven-of-Seven Tenary Close [C(7/7) 2187]

TT-BB) Six-of-Seven Tenary Close [C(6/7) 145.8];

TT-BC) Five-of-Seven Tenary Close [C(5/7) 9.72]

TT-BD) Four-of-Seven Tenary Close [C(4/7) 0.648]

TT-BE) Three-of-Seven Tenary Close [C(3/7) 0.0432]

TT-BF) Two-of-Seven Tenary Close [C(2/7) 0.00288]

TT-BG) Six-of-Six Tenary Close [C(6/6) 729]

TT-BH) Five-of-Six Tenary Close [C(5/6) 48.6]

TT-BI) Four-of-Six Tenary Close [C(4/6) 3.24]

TT-BJ) Three-of-Six Tenary Close [C(3/6) 0.216]

TT-BK) Two-of-Six Tenary Close [C(2/6) 0.0144]

TT-BL) Five-of-Five Tenary Close [C(5/5) 243]

TT-BM) Four-of-Five Tenary Close [C(4/5) 16.2]

TT-BN) Three-of-Five Tenary Close [C(3/5) 1.08]

TT-BO) Two-of-Five Tenary Close [C(2/5) 0.072]

TT-BP) Four-of-Four Tenary Close [C(4/4) 81]

TT-BQ) Three-of-Four Tenary Close [C(3/4) 5.4]

TT-BR) Two-of-Four Tenary Close [C(2/4) 0.36]

TT-BS) Three-of-Three Tenary Close [C(3/3) 27]

TT-BT) Two-of-Three Tenary Close [C(2/3) 1.8]

### High

TT-CA) Seven-of-Seven Tenary High [H(7/7) 2187]

TT-CB) Six-of-Seven Tenary High [H(6/7) 145.8]

TT-CC) Five-of-Seven Tenary High [H(5/7) 9.72]

TT-CD) Four-of-Seven Tenary High [H(4/7) 0.648]

TT-CE) Three-of-Seven Tenary High [H(3/7) 0.0432]

TT-CF) Two-of-Seven Tenary High [H(2/7) 0.00288]

TT-CG) Six-of-Six Tenary High [H(6/6) 729]

TT-CH) Five-of-Six Tenary High [H(5/6) 48.6]

TT-CI) Four-of-Six Tenary High [H(4/6) 3.24]

TT-CJ) Three-of-Six Tenary High [H(3/6) 0.216]

TT-CK) Two-of-Six Tenary High [H(2/6) 0.0144]

TT-CL) Five-of-Five Tenary High [H(5/5) 243]

TT-CM) Four-of-Five Tenary High [H(4/5) 16.2]

TT-CN) Three-of-Five Tenary High [H(3/5) 1.08]

TT-CO) Two-of-Five Tenary High [H(2/5) 0.072]

TT-CP) Four-of-Four Tenary High [H(4/4) 81]

TT-CQ) Three-of-Four Tenary High [H(3/4) 5.4]

TT-CR) Two-of-Four Tenary High [H(2/4) 0.36]

TT-CS) Three-of-Three Tenary High [H(3/3) 27]

TT-CT) Two-of-Three Tenary High [H(2/3) 1.8]

### Low

TT-DA) Seven-of-Seven Tenary Low [L(7/7) 2187]

TT-DB) Six-of-Seven Tenary Low [L(6/7) 145.8]

TT-DC) Five-of-Seven Tenary Low [L(5/7) 9.72]

TT-DD) Four-of-Seven Tenary Low [L(4/7) 0.648]

TT-DE) Three-of-Seven Tenary Low [L(3/7) 0.0432]

TT-DF) Two-of-Seven Tenary Low [L(2/7) 0.00288]

TT-DG) Six-of-Six Tenary Low [L(6/6) 729]

TT-DH) Five-of-Six Tenary Low [L(5/6) 48.6]

TT-DI) Four-of-Six Tenary Low [L(4/6) 3.24]

TT-DJ) Three-of-Six Tenary Low [L(3/6) 0.216]

TT-DK) Two-of-Six Tenary Low [L(2/6) 0.0144]

TT-DL) Five-of-Five Tenary Low [L(5/5) 243]

TT-DM) Four-of-Five Tenary Low [L(4/5) 16.2]

TT-DN) Three-of-Five Tenary Low [L(3/5) 1.08]

TT-DO) Two-of-Five Tenary Low [L(2/5) 0.072]

TT-DP) Four-of-Four Tenary Low [L(4/4) 81]

TT-DQ) Three-of-Four Tenary Low [L(3/4) 5.4]

TT-DR) Two-of-Four Tenary Low [L(2/4) 0.36]

TT-DS) Three-of-Three Tenary Low [L(3/3) 27]

TT-DT) Two-of-Three Tenary Low [L(2/3) 1.8]

### Volume

TT-EA) Seven-of-Seven Tenary Volume [V(7/7) 2187]

TT-EB) Six-of-Seven Tenary Volume [V(6/7) 145.8]

TT-EC) Five-of-Seven Tenary Volume [V(5/7) 9.72]

TT-ED) Four-of-Seven Tenary Volume [V(4/7) 0.648]

TT-EE) Three-of-Seven Tenary Volume [V(3/7) 0.0432]

TT-EF) Two-of-Seven Tenary Volume [V(2/7) 0.00288]

TT-EG) Six-of-Six Tenary Volume [V(6/6) 729]

TT-EH) Five-of-Six Tenary Volume [V(5/6) 48.6]

TT-EI) Four-of-Six Tenary Volume [V(4/6) 3.24]

TT-EJ) Three-of-Six Tenary Volume [V(3/6) 0.216]

TT-EK) Two-of-Six Tenary Volume [V(2/6) 0.0144]

TT-EL) Five-of-Five Tenary Volume [V(5/5) 243]

TT-EM) Four-of-Five Tenary Volume [V(4/5) 16.2]

TT-EN) Three-of-Five Tenary Volume [V(3/5) 1.08]

TT-EO) Two-of-Five Tenary Volume [V(2/5) 0.072]

TT-EP) Four-of-Four Tenary Volume [V(4/4) 81]

TT-EQ) Three-of-Four Tenary Volume [V(3/4) 5.4]

TT-ER) Two-of-Four Tenary Volume [V(2/4) 0.36]

TT-ES) Three-of-Three Tenary Volume [V(3/3) 27]

TT-ET) Two-of-Three Tenary Volume [V(2/3) 1.8]

### Fails to Deliver

TT-FA) Seven-of-Seven Tenary Fails to Deliver [FTD(7/7) 2187]

TT-FB) Six-of-Seven Tenary Fails to Deliver [FTD(6/7) 145.8]

TT-FC) Five-of-Seven Tenary Fails to Deliver[FTD(5/7) 9.72]

TT-FD) Four-of-Seven Tenary Fails to Deliver [FTD(4/7) 0.648]

TT-FE) Three-of-Seven Tenary Fails to Deliver [FTD(3/7) 0.0432]

TT-FF) Two-of-Seven Tenary Fails to Deliver [FTD(2/7) 0.00288]

TT-FG) Six-of-Six Tenary Fails to Deliver [FTD(6/6) 729]

TT-FH) Five-of-Six Tenary Fails to Deliver [FTD(5/6) 48.6]

TT-FI) Four-of-Six Tenary Fails to Deliver [FTD(4/6) 3.24]

TT-FJ) Three-of-Six Tenary Fails to Deliver [FTD(3/6) 0.216]

TT-FK) Two-of-Six Tenary Fails to Deliver [FTD(2/6) 0.0144]

TT-FL) Five-of-Five Tenary Fails to Deliver [FTD(5/5) 243]

TT-FM) Four-of-Five Tenary Fails to Deliver [FTD(4/5) 16.2]

TT-FN) Three-of-Five Tenary Fails to Deliver [FTD(3/5) 1.08]

TT-FO) Two-of-Five Tenary Fails to Deliver [FTD(2/5) 0.072]

TT-FP) Four-of-Four Tenary Fails to Deliver [FTD(4/4) 81]

TT-FQ) Three-of-Four Tenary Fails to Deliver [FTD(3/4) 5.4]

TT-FR) Two-of-Four Tenary Fails to Deliver [FTD(2/4) 0.36]

TT-FS) Three-of-Three Tenary Fails to Deliver [FTD(3/3) 27]

TT-FT) Two-of-Three Tenary Fails to Deliver [FTD(2/3) 1.8]

### Short Volume

TT-GA) Seven-of-Seven Tenary Short Volume [SV(7/7) 2187]

TT-GB) Six-of-Seven Tenary Short Volume [SV(6/7) 145.8]

TT-GC) Five-of-Seven Tenary Short Volume [SV(5/7) 9.72]

TT-GD) Four-of-Seven Tenary Short Volume [SV(4/7) 0.648]

TT-GE) Three-of-Seven Tenary Short Volume [SV(3/7) 0.0432]

TT-GF) Two-of-Seven Tenary Short Volume [SV(2/7) 0.00288]

TT-GG) Six-of-Six Tenary Short Volume [SV(6/6) 729]

TT-GH) Five-of-Six Tenary Short Volume [SV(5/6) 48.6]

TT-GI) Four-of-Six Tenary Short Volume [SV(4/6) 3.24]

TT-GJ) Three-of-Six Tenary Short Volume [SV(3/6) 0.216]

TT-GK) Two-of-Six Tenary Short Volume [SV(2/6) 0.0144]

TT-GL) Five-of-Five Tenary Short Volume [SV(5/5) 243]

TT-GM) Four-of-Five Tenary Short Volume [SV(4/5) 16.2]

TT-GN) Three-of-Five Tenary Short Volume [SV(3/5) 1.08]

TT-GO) Two-of-Five Tenary Short Volume [SV(2/5) 0.072]

TT-GP) Four-of-Four Tenary Short Volume [SV(4/4) 81]

TT-GQ) Three-of-Four Tenary Short Volume [SV(3/4) 5.4]

TT-GR) Two-of-Four Tenary Short Volume [SV(2/4) 0.36]

TT-GS) Three-of-Three Tenary Short Volume [SV(3/3) 27]

TT-GT) Two-of-Three Tenary Short Volume [SV(2/3) 1.8]

Note 17-A: The Matching Series above will also be appropriately applied specifically to both horizontal Directional Indicator Aggregation data: Column WY) Company Specific Day's Price Data Directional Indicator Aggregation—including Open. High. Low and Close by Four-of-Four; Three-of-Four; Two-of-Four; and Column WZ) Company Specific Day's Volumetric Data Directional Indicator Aggregation—including Daily Volume. Fails to Deliver and Short Volume by Three-of-Three and Two-of-Three.

Note 18-A: The Matching Series Four-of-Four; Three-of-Four; Two-of-Four; and Three-of-Three and Two-of-Three, applied respectively and to the same extent, of Columns WY) and WZ) should be shown in their own section since they are singularly different from the other Matching Series applications and should not be either lost/misplaced or overlooked. For purposes of this Process Description, these entries will be entered in Columns TT-XA thru TT-XC and TT-YA and TT-YB, respectively.

### Horizontal Day's Price Data DIAs

TT-XA) Four-of-Four Tenary DIAs Day's Price Data [DPD (4/4) 81]

TT-XB) Three-of-Four Tenary DIAs Day's Price Data [DPD (3/4) 5.4]

TT-XC) Two-of-Four Tenary DIAs Day's Price Data [DPD (2/4) 0.36]

### Horizontal Day's Volumetric Data DIAs

TT-YA) Three-of-Three Tenary DIAs Day's Volumetric Data [DVD (3/3)]

TT-YB) Two-of-Three Tenary DIAs Day's Volumetric Data [DVD (2/3)]

Note 19-A: Once all the Matching Series of Directional Indicator Assemblies (collectively Columns TT-BA thru TT-GT and Columns TT-XA thru TT-YB for the Horizontal DIAs as well) have been determined for each Trade Date, in each Category, a Standard Deviation for relative frequency of same-same patterns, that is: of each category—Open, High, Low, Close, Daily Volume, Fails to Deliver and Short Volume; of each type—Seven-of-Seven to Two-of-Three; of each Row I.D. matching set; including the Horizontal DIAs; to total entries of those same-same matches by Row entries' type. Also, those Row I.D.s that do not have matches outside the Date entry being examined count as a single entry, but like the Row I.D.'d matches here, are not multiplied by their respective decimalized potential factor above).

### Close

TT-HA) SD of Col TT-BA Match entries' for Seven-of-Seven Tenary Close [SD Of C(7/7)]

TT-HB) SD of Col TT-BB Match entries' for Six-of-Seven Tenary Close [SD of C(6/7)]

TT-HC) SD of Col TT-BC Match entries' for Five-of-Seven Tenary Close [SD of C(5/7)]

TT-HD) SD of Col TT-BD Match entries' for Four-of-Seven Tenary Close [SD of C(4/7)]

TT-HE) SD of Col TT-BE Match entries' for Three-of-Seven Tenary Close [SD of C(3/7)]

TT-HF) SD of Col TT-BF Match entries' for Two-of-Seven Tenary Close [SD of C(2/7)]

TT-HG) SD of Col TT-BG Match entries' for Six-of-Six Tenary Close [SD of C(6/6)]

TT-HH) SD of Col TT-BH Match entries' for Five-of-Six Tenary Close [SD of C(5/6)]

TT-HI) SD of Col TT-BI Match entries' for Four-of-Six Tenary Close [SD of C(4/6)]

TT-HJ) SD of Col TT-BJ Match entries' for Three-of-Six Tenary Close [SD of C(3/6)]

TT-HK) SD of Col TT-BK Match entries' for Two-of-Six Tenary Close [SD of C(2/6)]

TT-HL) SD of Col TT-BL Match entries' for Five-of-Five Tenary Close [SD of C(5/5)]

TT-HM) SD of Col TT-BM Match entries' for Four-of-Five Tenary Close [SD of C(4/5)]

TT-HN) SD of Col TT-BN Match entries' for Three-of-Five Tenary Close [SD of C(3/5)]

TT-HO) SD of Col TT-BO Match entries' for Two-of-Five Tenary Close [SD of C(2/5)]

TT-HP) SD of Col TT-BP Match entries' for Four-of-Four Tenary Close [SD of C(4/4)]

TT-HQ) SD of Col TT-BQ Match entries' for Three-of-Four Tenary Close [SD of C(3/4)]

TT-HR) SD of Col TT-BR Match entries' for Two-of-Four Tenary Close [SD of C(2/4)]

TT-HS) SD of Col TT-BS Match entries' for Three-of-Three Tenary Close [SD of C(3/3)]

TT-HT) SD of Col TT-BT Match entries' for Two-of-Three Tenary Close [SD of C(2/3)]

### High

TT-IA) SD of Col TT-CA Match entries' for Seven-of-Seven Tenary High [SD of H(7/7)]

TT-IB) SD of Col TT-CB Match entries' for Six-of-Seven Tenary High [SD of H(6/7)]

TT-IC) SD of Col TT-CC Match entries' for Five-of-Seven Tenary High [SD of H(5/7)]

TT-ID) SD of Col TT-CD Match entries' for Four-of-Seven Tenary High [SD of H(4/7)]

TT-IE) SD of Col TT-CE Match entries' for Three-of-Seven Tenary High [SD of H(3/7)]

TT-IF) SD of Col TT-CF Match entries' for Two-of-Seven Tenary High [SD of H(2/7)]

TT-IG) SD of Col TT-CG Match entries' for Six-of-Six Tenary High [SD of H(6/6)]

TT-IH) SD of Col TT-CH Match entries' for Five-of-Six Tenary High [SD of H(5/6)]

TT-II) SD of Col TT-CI Match entries' for Four-of-Six Tenary High [SD of H(4/6)]

TT-IJ) SD of Col TT-CJ Match entries' for Three-of-Six Tenary High [SD of H(3/6)]

TT-IK) SD of Col TT-CK Match entries' for Two-of-Six Tenary High [SD of H(2/6)]

TT-IL) SD of Col TT-CL Match entries' for Five-of-Five Tenary High [SD of H(5/5)]

TT-IM) SD of Col TT-CM Match entries' for Four-of-Five Tenary High [SD of H(4/5)]

TT-IN) SD of Col TT-CN Match entries' for Three-of-Five Tenary High [SD of H(3/5)]

TT-IO) SD of Col TT-CO Match entries' for Two-of-Five Tenary High [SD of H(2/5)]

TT-IP) SD of Col TT-CP Match entries' for Four-of-Four Tenary High [SD of H(4/4)]

TT-IQ) SD of Col TT-CO Match entries' for Three-of-Four Tenary High [SD of H(3/4)]

TT-IR) SD of Col TT-CR Match entries' for Two-of-Four Tenary High [SD of H(2/4)]

TT-IS) SD of Col TT-CS Match entries' for Three-of-Three Tenary High [SD of H(3/3)]

TT-IT) SD of Col TT-CT Match entries' for Two-of-Three Tenary High [SD of H(2/3)]

### Low

TT-JA) SD of Col TT-DA Match entries' for Seven-of-Seven Tenary Low [SD of L(7/7)]

TT-JB) SD of Col TT-DB Match entries' for Six-of-Seven Tenary Low [SD of L(6/7)]

TT-JC) SD of Col TT-DC Match entries' for Five-of-Seven Tenary Low [SD of L(5/7)]

TT-JD) SD of Col TT-DD Match entries' for Four-of-Seven Tenary Low [SD of L(4/7)]

TT-JE) SD of Col TT-DE Match entries' for Three-of-Seven Tenary Low [SD of L(3/7)]

TT-JF) SD of Col TT-DF Match entries' for Two-of-Seven Tenary Low [SD of L(2/7)]

TT-JG) SD of Col TT-DG Match entries' for Six-of-Six Tenary Low [SD of L(6/6)]

TT-JH) SD of Col TT-DH Match entries' for Five-of-Six Tenary Low [SD of L(5/6)]

TT-JI) SD of Col TT-DI Match entries' for Four-of-Six Tenary Low [SD of L(4/6)]

TT-JJ) SD of Col TT-DJ Match entries' for Three-of-Six Tenary Low [SD of L(3/6)]

TT-JK) SD of Col TT-DK Match entries' for Two-of-Six Tenary Low [SD of L(2/6)]

TT-JL) SD of Col TT-DL Match entries' for Five-of-Five Tenary Low [SD of L(5/5)]

TT-JM) SD of Col TT-DM Match entries' for Four-of-Five Tenary Low [SD of L(4/5)]

TT-JN) SD of Col TT-DN Match entries' for Three-of-Five Tenary Low [SD of L(3/5)]

TT-JO) SD of Col TT-DO Match entries' for Two-of-Five Tenary Low [SD of L(2/5)]

TT-JP) SD of Col TT-DP Match entries' for Four-of-Four Tenary Low [SD of L(4/4)]

TT-JQ) SD of Col TT-DO Match entries' for Three-of-Four Tenary Low [SD of L(3/4)]

TT-JR) SD of Col TT-DR Match entries' for Two-of-Four Tenary Low [SD of L(2/4)]

TT-JS) SD of Col TT-DS Match entries' for Three-of-Three Tenary Low [SD of L(3/3)]

TT-JT) SD of Col TT-DT Match entries' for Two-of-Three Tenary Low [SD of L(2/3)]

### Volume

TT-KA) SD of Col TT-EA Match entries' for Seven-of-Seven Tenary Volume [SD of V(7/7)]

TT-KB) SD of Col TT-EB Match entries' for Six-of-Seven Tenary Volume [SD of V(6/7)]

TT-KC) SD of Col TT-EC Match entries' for Five-of-Seven Tenary Volume [SD of V(5/7)]

TT-KD) SD of Col TT-ED Match entries' for Four-of-Seven Tenary Volume [SD of V(4/7)]

TT-KE) SD of Col TT-EE Match entries' for Three-of-Seven Tenary Volume [SD of V(3/7)]

TT-KF) SD of Col TT-EF Match entries' for Two-of-Seven Tenary Volume [SD of V(2/7)]

TT-KG) SD of Col TT-EG Match entries' for Six-of-Six Tenary Volume [SD of V(6/6)]

TT-KH) SD of Col TT-EH Match entries' for Five-of-Six Tenary Volume [SD of V(5/6)]

TT-KI) SD of Col TT-EI Match entries' for Four-of-Six Tenary Volume [SD of V(4/6)]

TT-KJ) SD of Col TT-EJ Match entries' for Three-of-Six Tenary Volume [SD of V(3/6)]

TT-KK) SD of Col TT-EK Match entries' for Two-of-Six Tenary Volume [SD of V(2/6)]

TT-KL) SD of Col TT-EL Match entries' for Five-of-Five Tenary Volume [SD of V(5/5)]

TT-KM) SD of Col TT-EM Match entries' for Four-of-Five Tenary Volume [SD of V(4/5)]

TT-KN) SD of Col TT-EN Match entries' for Three-of-Five Tenary Volume [SD of V(3/5)]

TT-KO) SD of Col TT-EO Match entries' for Two-of-Five Tenary Volume [SD of V(2/5)]

TT-KP) SD of Col TT-EP Match entries' for Four-of-Four Tenary Volume [SD of V(4/4)]

TT-KQ) SD of Col TT-EO Match entries' for Three-of-Four Tenary Volume [SD of V(3/4)]

TT-KR) SD of Col TT-ER Match entries' for Two-of-Four Tenary Volume [SD of V(2/4)]

TT-KS) SD of Col TT-ES Match entries' for Three-of-Three Tenary Volume [SD of V(3/3)]

TT-KT) SD of Col TT-ET Match entries' for Two-of-Three Tenary Volume [SD of V(2/3)]

### Fails to Deliver

TT-LA) SD of Col TT-FA Match entries' for Seven-of-Seven Tenary Fails to Deliver [SD of FTD(7/7)]

TT-LB) SD of Col TT-FB Match entries' for Six-of-Seven Tenary Fails to Deliver [SD of FTD(6/7)]

TT-LC) SD of Col TT-FC Match entries' for Five-of-Seven Tenary Fails to Deliver [SD of FTD(5/7)]

TT-LD) SD of Col TT-FD Match entries' for Four-of-Seven Tenary Fails to Deliver [SD of FTD(4/7)]

TT-LE) SD of Col TT-FE Match entries' for Three-of-Seven Tenary Fails to Deliver [SD of FTD(3/7)]

TT-LF) TSD of Col TT-FF Match entries' for Two-of-Seven Tenary Fails to Deliver [SD of FTD(2/7)]

TT-LG) SD of Col TT-FG Match entries' for Six-of-Six Tenary Fails to Deliver [SD of FTD(6/6)]

TT-LH) SD of Col TT-FH Match entries' for Five-of-Six Tenary Fails to Deliver [SD of FTD(5/6)]

TT-LI) SD of Col TT-FI Match entries' for Four-of-Six Tenary Fails to Deliver [SD of FTD(4/6)]

TT-LJ) SD of Col TT-FJ Match entries' for Three-of-Six Tenary Fails to Deliver [SD of FTD(3/6)]

TT-LK) SD of Col TT-FK Match entries' for Two-of-Six Tenary Fails to Deliver [SD of FTD(2/6)]

TT-LL) SD of Col TT-FL Match entries' for Five-of-Five Tenary Fails to Deliver [SD of FTD(5/5)]

TT-LM) SD of Col TT-FM Match entries' for Four-of-Five Tenary Fails to Deliver [SD of FTD(4/5)]

TT-LN) SD of Col TT-FN Match entries' for Three-of-Five Tenary Fails to Deliver [SD of FTD(3/5)]

TT-LO) SD of Col TT-FO Match entries' for Two-of-Five Tenary Fails to Deliver [SD of FTD(2/5)]

TT-LP) SD of Col TT-FP Match entries' for Four-of-Four Tenary Fails to Deliver [SD of FTD(4/4)]

TT-LQ) SD of Col TT-FQ Match entries' for Three-of-Four Tenary Fails to Deliver [SD of FTD(3/4)]

TT-LR) SD of Col TT-FR Match entries' for Two-of-Four Tenary Fails to Deliver [SD of FTD(2/4)]

TT-LS) SD of Col TT-FS Match entries' for Three-of-Three Tenary Fails to Deliver [SD of FTD(3/3)]

TT-LT) SD of Col TT-FT Match entries' for Two-of-Three Tenary Fails to Deliver [SD of FTD(2/3)]

Short Volume

TT-MA) SD of Col TT-GA Match entries' for Seven-of-Seven Tenary Short Volume [SD of SV(7/7)]

TT-MB) SD of Col TT-GB Match entries' for Six-of-Seven Tenary Short Volume [SD of SV(6/7)]

TT-MC) SD of Col TT-GC Match entries' for Five-of-Seven Tenary Short Volume [SD of SV(5/7)]

TT-MD) SD of Col TT-GD Match entries' for Four-of-Seven Tenary Short Volume [SD of SV(4/7)]

TT-ME) SD of Col TT-GE Match entries' for Three-of-Seven Tenary Short Volume [SD of SV(3/7)]

TT-MF) SD of Col TT-GF Match entries' for Two-of-Seven Tenary Short Volume [SD of SV(2/7)]

TT-MG) SD of Col TT-GG Match entries' for Six-of-Six Tenary Short Volume [SD of SV(6/6)]

TT-MH) SD of Col TT-GH Match entries' for Five-of-Six Tenary Short Volume [SD of SV(5/6)]

TT-MI) SD of Col TT-GI Match entries' for Four-of-Six Tenary Short Volume [SD of SV(4/6)]

TT-MJ) SD of Col TT-GJ Match entries' for Three-of-Six Tenary Short Volume [SD of SV(3/6)]

TT-MK) SD of Col TT-GK Match entries' for Two-of-Six Tenary Short Volume [SD of SV(2/6)]

TT-ML) SD of Col TT-GL Match entries' for Five-of-Five Tenary Short Volume [SD of SV(5/5)]

TT-MM) SD of Col TT-GM Match entries' for Four-of-Five Tenary Short Volume [SD of SV(4/5)]

TT-MN) SD of Col TT-GN Match entries' for Three-of-Five Tenary Short Volume [SD of SV(3/5)]

TT-MO) SD of Col TT-GO Match entries' for Two-of-Five Tenary Short Volume [SD of SV(2/5)]

TT-MP) SD of Col TT-GP Match entries' for Four-of-Four Tenary Short Volume [SD of SV(4/4)]

TT-MQ) SD of Col TT-GQ Match entries' for Three-of-Four Tenary Short Volume [SD of SV(3/4)]

TT-MR) SD of Col TT-GR Match entries' for Two-of-Four Tenary Short Volume [SD of SV(2/4)]

TT-MS) SD of Col TT-GS Match entries' for Three-of-Three Tenary Short Volume [SD of SV(3/3)]

TT-MT) SD of Col TT-GT Match entries' for Two-of-Three Tenary Short Volume [SD of SV(2/3]

### Horizontal Day's Price Data DIAs

TT-XD) SD of Col TT-XA Match entries' for Four-of-Four Tenary DIAs Day's Price Data [SD of DPD (4/4)]

TT-XE) SD of Col TT-XB Match entries' for Three-of-Four Tenary DIAs Day's Price Data [SD of DPD (3/4)]

TT-XF) SD of Col TT-XC Match entries' for Two-of-Four Tenary DIAs Day's Price Data [SD of DPD (2/4)]

### Horizontal Day's Volumetric Data DIAs

TT-YC) SD of Col TT-YA Match entries' for Three-of-Three Tenary DIAs Day's Volumetric Data [SD of DVD (3/3)]

TT-YD) SD of Col TT-YB Match entries' for Two-of-Three Tenary DIAs Day's Volumetric Data [SD of DVD (2/3)]

Note 19-A: A Standard Deviation can be calculated that determines the frequency of same-same patterns to a randomly selected set of Row:Column data for each type of Items of Interest to the entire same-same category of specific pattern appearance in the existing data for comparison to actual results.

It is at this point in the Quinary Level of Assembling spreadsheet Columns that it is both possible and necessary to construct several additional separate spreadsheets/tables as Company-specific Appendices and Display Tables—(Pop-up Tables, Charts and Displays for electronic spreadsheet formats) that will perform the following operations.

The above noted creation of a necessitated, additional group of secondary spreadsheets/tables that display as Date-specific Tables require the design of templates for the specialized informational construct. It is these template designs which are to be described here.

### APPENDIX TEMPLATE AND TABLES ASSEMBLY TO OUINARY LEVEL

### Notes, Reference Tables/Data, Processes

### COMPANY-SPECIFIC APPENDIX TABLES—2(A) & 2(B): COMBINED

### Repeated in that Appendix for Reference

Note 01-B: What follows is a description of a spreadsheet that will be a template for the applied resulting Company-specific table, referred to as: “Company-specific Appendix Tables—2(a) & 2(b): Combined”, used to perform certain measures regarding the individual Standard Deviation (SD) results for the six Categories of Trade Date Comparison (Close, High, Low, Daily Volume, Fails to Deliver, and Daily Short Volume) from the various Percentage of Change and Directional Indicator Relationals from both Phases of Trade Date Serial Relational Columns—Trade Date Relationals and Multi-Trade Date Relationals. The template will start with the usual organization similar to the one described in the Primary Level.
Alpha Column Title entries are initially Alphabetic (for brevity and to distinguish from Row entries) and entered in full on Row 0.
Alpha Row entries are initially Numeric and are entered in full on Column 0, are whole-number sequential and progress downward.

Note 02-B: In this section, Tables will be constructed, each a combination of four separate columnar Lists, two from existing data and two as results from the interactions of those two. Each Table shall be identified by the six Categories of Trade Date Comparison (Close, High, Low, Daily Volume, Fails to Deliver, and Daily Short Volume). Each Table shall contain Rows, singularly designated for each of the respective Trade Date Relationals (Col x−4); (Col x−3); (Col x−2); (Col x−1); (Col x+0); (Col x+1); (Col x+2) and Multi-Trade Date Relationals (Col x−4 to Col x+0); (Col x+0 to Col x+2); and (Col x−4 to Col x+2), totaling ten Rows. In each case, the Row identifier's “Col ‘x’” shall indicate the appropriate Primary Level column category for the respective cell each will occupy. The “source(s)” for each Standard Deviation numeric entry can be drawn from the Standard Deviation of Percentage of Change Trade Date Comparisons Close, High, Low, Daily Volume, Fails to Deliver, Daily Short Volume, respectively, created in the individual entries for the Standard Deviations for each in Quaternary Level Columns NA thru PH; and the Standard Deviation of Directional Indicator Trade Date Comparisons Close, High, Low, Daily Volume, Fails to Deliver; Daily Short Volume, respectively, created in the individual entries for the Standard Deviations for each in Quaternary Level Columns QA thru SH without having to re-calculate the respective SDs a second time but the origins of the basic Column designations should be from the most basic source of each: Close—Column ‘E’; High—Column ‘C’; Low—Column ‘D’; Daily Volume—Column ‘F’; Fails to Deliver—Column ‘I’; Daily Short Volume—Column ‘O’.

Note 03-B: The four Columnar Lists shall be designated left to right as (List 1) Table 1—“% of C”—Standard Deviations of Percentage of Change Trade Date Relationals'-Close, High, Low, Daily Volume, Fails to Deliver, Daily Short Volume, respectively (collectively shortened to “SD % of Change Col ‘x’”); (List 2) Table 2(a)—“Sum”—Sum of Standard Deviations of Trade Date Relationals'—Close, High, Low, Daily Volume, Fails to Deliver, and Daily Short Volume, respectively (collectively shortened to “SD Sum Col ‘x’”); (List 3) Table 2(b)—“Product”—Product of Standard Deviations of Trade Date Relationals'—Close, High, Low, Daily Volume, Fails to Deliver, and Daily Short Volume, respectively (collectively shortened to “SD Product Col ‘x’”); and, (List 4) Table 4—DI of C−Standard Deviations of Directional Indicators of Change Trade Date Relationals'—Close, High, Low, Daily Volume, Fails to Deliver, Daily Short Volume, respectively (collectively shortened to “SD DI of C Col ‘x’”).

Note 04-B: In these tables, the contents of each cell under List 2 Table 2(a)—Sum of Standard Deviations of Trade Date Relationals' by category—Close, High, Low, Daily Volume, Fails to Deliver, and Daily Short Volume, respectively, shall be the respective entry from List 1 added to the corresponding respective entry from List 4. The contents of each cell under List 3 Table 3(a)—Product of Standard Deviations of Trade Date Relationals'—Close, High, Low, Daily Volume, Fails to Deliver, and Daily Short Volume, respectively, shall be the respective entry from List 1 multiplied by the corresponding respective entry from List 4.

Note 05-B: In these tables, the Rows shall be singularly designated (1) Col x−4; (2) Col x−3; (3) Col x−2; (4) Col x−1; (5) Col x+0; (6) Col x+1; (7) Col x+2; (8) Col x−4 to Col x+0; (9) Col x+0 to Col x+2; and (10) Col x−4 to Col x+2, corresponding to each position in the Trade Date Relationals Quaternary Level, where the Standard Deviation of Tertiary Level data was calculated from the specific Percentages of Change in each of the Trade Date Serial Comparison Columns' Second Phase of Base Comparisons of Change, the Base Comparisons for Percentages of Change, entered on the left, in List 1) Table 1—% of C; and the Trade Date Relationals Quaternary Level where the Standard Deviation of Tertiary Level data calculated from the specific Directional Indicators of Change in each of the Trade Date Serial Comparison Columns' Third Phase of Base Comparisons of Change, Base Comparisons of Change Designation Indicators-Only Columns Array, entered on the right, in List 4) Table 4—DI o C.

Note 06-B: These tables may be held/displayed singularly/separately, or may be stacked one atop the next, or side-by-side, for efficiency, since each only requires ten cells vertically and four horizontally, per category.

Note 07-B: While it is possible to construct these tables combining all six categories by column designation per each of the four Lists, the complexity of tables organized as such would have the potential of leading to confusion upon examination. Hence, the choice to create separate tables for each category of Trade Date Comparison—Cols E; C; D; F; I; O.

Note 08-B: In this section, in the above Table construct, appropriate adjustment shall be made relating to the reduction in the number of days between Trade Date and Settlement Date to reflect that change made as of Sep. 5, 2017. [There will be no entries for Row 1 (Col x−4), for or post-Sep. 5, 2017].

Note 09-B: The above Table and collective Set of Tables will be constructed, like everything else described and elaborated within this Process, for each Trade Date for/thru each Category of Trade Date Relationals—Close, High, Low, Daily Volume, Fails to Deliver, and Daily Short Volume—being examined.

It is at this point in the Quinary Level of Assembling spreadsheet Columns that it is both possible and necessary to construct several additional separate spreadsheets/tables/charts and displays as Company-specific Appendices and Pop-up Display Charts (for electronic spreadsheet formats) that will perform the following operations.

The above noted creation of a necessitated, additional group of second spreadsheet displays that function as charts; as full-length charts that display the changes of entire Columns; as multi-display charts combining various Columns' results, either as layered displays or as compounding displays; as Date-specific charts that display a limited section of Trade Date Relationals and/or Standard Deviations of the various sets of data entered, either as stand alone displays with or without time/date related contents [i.e.: Items of Interest (a.k.a. Items of Focus)] not specific to the columnar entry being charted, or, in various columnar combinations with or without time/date related contents (i.e.: Items of Interest) not specific to the columnar entry(ies) being charted require the design of a template for the specialized informational charting display constructs. It is these designs which are to be described now.

Note 1-C: With few exceptions, the “production” and “holding” of the various charts are intended for electronic spreadsheet-related construct as manual construction, while not impossible, would require significant time and labor.

Note 2-C: With few exceptions, the primary list of charts would entail each specific column of trading data for Columns: B; C; D; E; F; I; M; O; P; Q; T; AA; AB; AC; AD; AE; AF; AG; AI; AJ; AO; AR; BN; BO; BP; MA; MB; MC; MD; ME; MF; MG; MH; MI; MJ; MK; ML; and Each Standard Deviation of the Multi-Trade Date Relationals Percentage of Change: NH; NI; NJ; NR; NS; NT; OB; OC; OD; OL; OM; ON; OV; OW; OX; PF; PG; PH; and Each Standard Deviation of the Directional Indicators of Change: QH; QI; QJ; QR; QS; QT; RB; RC; RD; RL; RM; RN; RV; RW; RX; SF; SG; SH. They would also include for Each of the above listed charts optional additional entries, such as: One or more types of Items of Interest; Items of Interest Reference Dates/Periods; Multipliers [Weighting factors: Standard Deviation results multiplied to the specific Trade Date data for the specific column being charted—either or both SD Sums and/or Products as multiplier(s)]; Overlays of Column-appropriate results of TT-BA thru TT-BT, TT-CA thru TT-CT, TT-DA thru TT-DT, TT-EA thru TT-ET, TT-FA thru TT-FT, or TT-GA thru TT-GT, by specific y-of-z Match-line numbering and/or specific Match count multiples, both singularly by or collectively thru the Match results appropriate for the Column topic/type; or various combination overlays of other Column topic/type, as always oriented to matching Trade Dates.

Note 3-C: With few if any exceptions, the list of Charts produced from Note 2-C above can and will have (a) sub-routine(s) which produce(s) (a) subsidiary chart(s) that isolate and/or magnify far shorter sequences of the parent chart(s) that act as (a) “pop-up” or “call-up” chart(s) revealing in more intimate detail the daily chart results for a given (range-optional) number of Trade Dates centering on a cursor screen-position [regardless of method of how that cursor is maneuvered (touch, mouse, keyboard, etc.)], or, a calendar-based numeric input, with either a specific focusing Trade Date or “Begin” and “End” Trade Date entries. Each sub-chart would include whatever optional data had been included in the parent chart.

Note 4-C: With few if any exceptions, the list of Charts produced from Notes 2-C and 3-C above can utilize the assorted Overlays of Column-appropriate results of TT-BA thru TT-BT, TT-CA thru TT-CT, TT-DA thru TT-DT, TT-EA thru TT-ET, TT-FA thru TT-FT, or TT-GA thru TT-GT, by specific y-of-z Match-line numbering and/or specific Match count multiples, both singularly by or collectively thru the Match-line numbering results appropriate for the Column topic/type; or various combination overlays of other Column topic/type, as always oriented to matching Trade Dates. This is in order to locate and identify any specific Row-numbered Match-line patterning oriented to externally (non-trading) related and/or determined Trade Date positioned Items of Interest and/or their respective Reference Dates or Periods.

Note 5-C: A filter or screen can be utilized that specifically focuses on Items of Interest and/or their respective Reference Dates or Periods to seek specific Row-numbered Match-line sequences and/or collections of Row-numbered Match-line sequences that precede and/or succeed specific externally-related (non-trading) and/or specific externally-determined Trade Date positioned Items of Interest and/or their respective Reference Dates or Periods and how these Row-numbered Match-line sequences relate to the proximate Trade Date(s) they accompany.

Note 6-C: The charting procedures listed in Notes 1-C thru 5-C above are also applied to the entire Horizontal sets as well, where applicable.

Note 7-C: It is the results of actions taken from each of the above Notes 1-C thru 5-C that will provide the visual evidence of illegal activity, both by themselves as well as in conjunction with much of the data that precedes and/or contributes to their construct. Many of those illegal activities will be explained in the Senary Level.

This concludes the Quinary Level of Assembling spreadsheet Columns, one that comprises a non-definitive, non-conclusive variety or array of the Inter- and/or Infra-Row and/or Inter- and/or Infra-Columnar Pre-algorithmic and/or Algorithmic analyses of date-specific entries, particularly those that compare entries from the Tertiary and Quaternary Level Directional Indicators identifying parameters that establish patterns affiliated with certain non-trading specifics, noted earlier as Items of Focus. This Level also created templates for the construction of Company-specific Appendices and Display Tables—(Pop-up Tables, Charts and Displays for electronic spreadsheet formats) of necessitated additional spreadsheets and the designs of templates for these specialized informational constructs. These bases and subsequent Standard Deviation calculations assist in whole, in part and/or in conjunction with other Column and/or Row entries with specific entries in refining, defining, clarifying and/or specifying A Process for the Detection and Identification of Idiosyncratic Valuations by Intent in Equities Commerce and Other Illegal Equity Trades in U.S. Domestic Stock Markets.

### Senary Level

What follows is the Senary Level of Assembling Spreadsheet Columns, in whole, in part and/or in conjunction with Column and/or Row entries with specific entries, including those designated as Company-specific Appendices and Display Tables (Pop-up Tables, Charts and Displays for electronic spreadsheet formats) of necessitated additional spreadsheets and the designs of templates for specialized informational constructs for attendant analysis of the respective results in refining, defining, clarifying and/or specifying A Process for the Detection and Identification of Idiosyncratic Valuations by Intent in Equities Commerce and Other Illegal Equity Trades in U.S. Domestic Stock Markets.

Throughout human existence, knowledge has been gained by the observation of events, both large and small. These events, if repeated, can sometimes lend themselves to what sentience is informed to sense—as patterns. This holds true regardless of whether it's a young fish swimming in a school of its kind noticing it escapes the mouths of predators by hiding among the structure of coral while its swim-mates out in the open get devoured or a proto-human noticing sparks flying off a rock that was struck by another rock, igniting the dry grass nearby thus trying it deliberately to find, if persistent enough, a source for starting fire. Patterns—be they the seeming arc of the sun across the sky, the phases of the moon, the movements of what became the planets, the seasons of the year or the passing of great herds of prey animals. Patterns—by repetition, the source of insight into how (and often why) something happens. Patterns—can be observed, created by an event in nature or created by attempting to replicate an observed event. The unique aspect of patterns is they all replicate an event that must occur more than once to be a pattern. Anything less is happenstance. It is the purpose of the Process for the Detection and Identification of Idiosyncratic Valuations by Intent in Equities Commerce and Other Illegal Equity Trades in U.S. Domestic Stock Markets to create a means of evaluation of specific sets of publicly available information in what has always officially been described as a random series of happenstance events, themselves subject only to all publicly available information; doing so in such a manner, without guile or subjective prejudice, sufficient to stand up in court proceedings and thorough challenge by rigorous testing of the results such that it survives the standards of reasonable doubt.

Given a large enough set of events, it is inevitable patterns of one kind or another arise. Therefore, some other factor or factors must be involved for patterns to be made relevant and in particular, factors independent of yet nonetheless related to the specific data being analyzed. In this regard, the single most relevant factor are points in time. Externally generated, trading valuation and volumetric independent time-related points in the data-flow create the factors that make patterns relevant. Once all the trading value and volume data is correctly aligned to the dates each is generated and not to camouflaging artificial “recognition” period(s), these externally generated, trading valuation and volumetric independent time-related points in the data-flow reveal nefarious and highly illegal activity. It is that revelation the time-related points in the data-flow create that is the specific subject the Senary Level will focus on. The principle types and natures of the externally generated, time-related points in the data-flow have been identified in this process description as the “Items of Interest” (a.k.a. “Items of Focus”) and the associated “Period(s) of Reference” noted in the Primary Level.

There are three basic types of these Items of Interest: Unpredictable, Semi-predictable, and Predictable. There are aspects of most of each of these three that can overlap, mainly in the Periods of Reference. This is most evident in the Quarterly, Semi-annual and Annual filings made by entities required to file the myriad forms each is appropriately assigned but also include various informational filings, most given certain grace periods between Period of Reference and the actual filing date, most of which are mandatory as “must file by” specific date or specific passage of time post-reference period event. Other examples of type-overlap are more subtle. One is referred to in this process description as Short Interest Last Trade Date, rarely mentioned in any publication of said Short Interest, to say nothing of the delay-by-regulatory-fiat of any publication of a “selective” Short Interest quantity for a given referent date for a given referent report period [noted in Short Interest (Report Period) and Short Interest Last Trade Date], Pre-September 2007 once a month and twice a month then and after that. The selective aspect of this in particular comes from the fact each publisher only publishes the highest X-number of [Companies with] Short Interest, limited by the space allocated for publication of such. There could be six thousand stocks with relatively high percentage of shares outstanding sold short and not yet covered but the lowest three thousand in nominal numbers of short sold shares not covered will remain unknown to the general public, unless a fee is paid and/or one consults a limited number of obscure and proprietary websites. This omission can be in spite of many of those so omitted having a higher percentage shares outstanding sold short and not yet covered than others that do get published.

Then there are the Fails to be Delivered counts. In spite of the actual terminology used in the Laws and Regulations regarding the average trading volume meeting or exceeding a minimum threshold necessary to qualify being included in what the SEC publishes, what the SEC actually publishes are only those corporate stocks with X-numbers or more of Fails to be Delivered. Those with fewer Fails are not included. (Yet another range of data one can access but only if one pays a subscription fee and even then only available in a limited number per subscription period.) [No irony in the fact that the minimum Average Daily Trading Volume and the (in practice) threshold number of Fails to be Delivered “eligible” for SEC publication electronically (on line) are the same. No. No irony at all!] Added to that is the additional delay in the actual publication of those stocks whose Fails to be Delivered do indeed exceed X-numbers' threshold. Then there is the confusing referent date each published entry of Fails to be Delivered is listed under, neither the Date of Trade nor the date a given share not delivered is accurately identified as such—the Settlement Date—but rather a randomly chosen date in between, yet never a mention of that irrelevant date being the focus of listing, or that it is irrelevant to the situation of those shares being Fails to be Delivered. Furthermore, these numbers are also delayed in their publication. Nor is there an accurate depiction of the number of “new” Fails to be Delivered as being different from the persistently not delivered. Nor is there any mention in the published numbers of Fails to be Delivered of those previously included which did get delivered in the given day's trading/settlement subject date, all of which, if included, would reveal pertinent, highly relevant data—of illegal activity!

Other crossovers between the three basic types of the Items of Interest: Unpredictable, Semi-predictable, and Predictable could include such as an announced Record Date [Semi-predictable or “expected soon” “Definitive” Proxy declaring the “Official” Record Date (Wholly Unpredictable) used to determine eligibility to vote on shareholder matters or receive a Declared Dividend or other “benefit” or “obligation” concerning shareholders' relationship with the company the shares represent] which is considered, until officially announced, like all other Company Filings' content with the SEC to be highly confidential—Unknown and Unknowable to the general public—until officially Filed and then Published, at least electronically, by the SEC.

Therefore, the following are the Senary Level of Assembling Spreadsheet Columns, Rows, Charts, Tables and Displays for attendant analysis of the respective results and that analysis. The following do not represent the entirety of all possible revelatory combinations, reference points, confirmatory and/or counter-argument evidence to challenges of analysis, nor do they represent the entire list of illegal trading activity the data and organized results demonstrate has/have occurred nor does/do it/they represent the entirety of the motives and rationales used by the perpetrators of such illegal activity. Nonetheless, they represent a significant starting point and all are based on the same premise: that it is the alignment to the Trade Date of ALL relevant data that reveal the patterns demonstrating intent—the mandatory prerequisite for successful prosecution and recovery of and from injustices suffered.

Senary Level Note-A: All previous Levels' directions concerning Notation; Column; Row; Cell; Formula; Description; etc. shall be continued in this Level as well, where applicable. This includes any instructions and/or directions in any of the Appendicied Templates and their Charts, Tables, and Displays and any combinations thereof. Should any additional descriptions or attendant explanations be necessary, they will be provided where appropriate.

Senary Level Note-B: Beginning with the simplest of revealing manipulation patterns:
The provisioning of “hypothetical” shares has been justified by the Markets and their respective oversighting and regulatory authorities, public and private, for several decades, but only for the expressed purposes of providing or facilitating “market liquidity” without ever defining what is meant by that term, to say nothing of the ambiguity of bi-directional liquidity or whether the same “liquidity facilitation” is applied to downward-trending vs upward-trending demand. There are rules that require making good by the end of a given Trade Date by the replacement of any of the hypothetical shares thus placed in trade on that given Trade Date. Brokers, Market Makers and Exchanges, and finally, the various Trust and Clearing Houses are ultimately responsible for seeing to it that that is accomplished “in a timely manner” so that no share-purchasing investor is harmed nor any existing shareholders are damaged in any way. The rationale for this requirement is for the simple reason that the purchasers of non-existent shares have no rights to any benefit share ownership confers. However, it furthermore implies such that should the existing shareholders experience a price change downward in the valuation of their rightful assets by the artificial imposition of perpetual ghost shares diluting the demand for shares, all shareholders of said same shares outstanding become harmed. Therefore, there is no justification or excuse for Failing to Deliver what has been sold. The Seller gets paid, regardless, at the end of trading on the respective Settlement Date. Some in the Markets: the Market Makers; the Exchanges; the Clearing Houses, the Regulators—both public and private (most of whom come from the other mentioned segments themselves)—and Market Media and its member commentors: Hedge, Private, and High-Frequency Dark Money Funds' Operators and Traders of and/or for same and each of the maj or and minor Wall Street Banks and Multi-National Corporations all have claimed such counterfeiting is a zero-sum gain, but they have never been victimized by these practices whose very existence and outcomes verify their own assertions that it is ONLY the collective Supply-to-Demand ratio which determines the values of anything. Their counter argument is that when these counterfeit shares, these artificial symbols of ownership do get replaced, that represents its own “demand” on the supply. But there is one problem with that argument. It ignores a fact of investing practices that has become the “practical rule”: Do NOT Lose Money. This has become manifest by the practice known as Stop-Loss. That is the imposition of a standing order with one's bank, brokerage or money manager to automatically sell one's holdings in a particular equity if it has fallen “X” percentage in trading price below its purchase price. In recent decades it been honed to a sharper edge by what is known as a “Rolling Stop-Loss” as well as tighter Stop-Loss percentage stops. There was a time when Stop-Loss was practiced wherein the popular “risk” was placed as high as 10-15% downward tolerance before imposing that stop-loss selling point but that was long ago. It has since been tightened to such a thin tolerance that trading has acquired a practice of making a hundredth's of a penny difference in price common, which in many circles is intolerable, thus triggering a sale of one's holdings in a particular equity inevitable. This triggering can be accomplished with minimal trading volume and has made tracking such trades for violating the “price manipulation by intent” next to impossible. It isn't so much that it is impossible to notice nor is it harmless activity. It is neither.
Because of the near universal practice of setting stop-loss selling in ever tighter limits of tolerance, the triggering of such selling has become a common practice, mainly among Market Makers and their operatives as well as many of their clients—the various Hedge Funds and Private Equity Funds, in particular those who practice high frequency trading and/or are what are known as “co-located” who mainly practice what is commonly referred to as unenforced front-running violations. But none of these practitioners of counterfeiting equities has ever posed a response to being questioned about their activity that amounts to a Stop-Loss opposite: a Go-Gain. While there may be a few individuals who have “practiced” such an investment strategy, it has never been demonstrated to be widely practiced or successful on anything like a par net gain results. The risk associated with such a buying strategy far outweighs any implied “simple and on-the-face-of-it” benefit or reward from such a practice. It's akin to betting against the house. The odds are not in one's favor.
All of this being a given, there are patterns associated with this practice of selling artificial shares, not delivering them when required and failing to provide their mandatory replacement even in the face of ample opportunity to do so, making a profit in the process. This deliberate practice, a practice undeniably with intent, clearly shows up and does so frequently, once the data is properly aligned.
Nor is this practice specifically aligned to Trading Dates with or near Items of Interest or their attendant Referent Periods, although it can be reflected in illegal trading that is; the false assumption likely being if it works under some minimal circumstances it couldn't under others a bit more complex.
Here is the first set or group of illegal trading types:
   I Basic Manipulative Action Initially noted in the details derived from Column WY: Company Specific Day's Price Data Directional Indicator Aggregation—including Open. High. Low and Close, Column WZ: Company Specific Day's Volumetric Data Directional Indicator Aggregation—including Daily Volume. Fails to Deliver and Short Volume, the appropriate Line-ID Numbered “x-of-y” Matches the Appendix “A” Templates (including the “x-of-Four” to the Column WY entries and “x-of-Three” to the Column WZ entries and the Standard Deviations of the results of both); the Trade Date Serial Comparison Relationals' Base Comparisons for Percentages of Change for Daily Closing Price—Columns GR thru HA; Daily High Price—Columns HB thru HK; Daily Low Price—Columns HL thru HU; Fails to Deliver—Columns IF thru IO; and Daily Short Volume—Columns IP thru IY; and the Base Comparisons of Change Designation Indicators-Only for Daily Closing Price—Columns JA thru JJ; Daily High Price—Columns JK thru JT; Daily Low Price—Columns JU thru KD; Fails to Deliver—Columns KO thru KX; and Daily Short Volume—Columns KY thru LH; as well as the Standard Deviations of same: Company Specific Series Standard Deviation of Percentages of Change for: Daily Closing Price—Columns NA thru NJ; Daily High Price—Columns NK thru NT; Daily Low Price—Columns NU thru OD; Fails to Deliver—Columns OO thru OX; and Daily Short Volume—Columns OY thru PH; and the Company Specific Series Standard Deviation of Change Designation Indicators-Only for: Daily Closing Price—Columns QA thru QJ; Daily High Price—Columns QK thru QT; Daily Low Price—Columns QU thru RD; Fails to Deliver—Columns RO thru RX; and Daily Short Volume—Columns RY thru SH.
The above collection of Row Directional Aggregates and Trade Date Serial Comparison Relationals' Base Comparisons for Percentages of Change and Change Designation Indicators-Only and the respective Standard Deviations of same will show how those illegal shares depress share price; when additional non-existent shares are injected further depress share price; and when the non-existent shares are finally acquired to be delivered as agreed to, the share price rarely returns at those times to where it had been when those non-existent shares were first created. It puts the lie to any claims of the practice being zero-sum gain. The basic aim of the creators of these Fails to Deliver (in effect: non-existent shares) is to trigger sufficient existing Stop-Loss-set sales to both acquire the appropriate numbers of shares to eliminate those still owed at prices lower than what they received when they sold those non-existent shares—resulting in a profit—and, depending on the aims of the perpetrators, acquire additional shares at artificially-depressed prices.
   II Insider Trading The tactics described above lend themselves to various actions associated with Insider Trading, motivated by such as periods approaching the granting of employee incentive stock options where eventual post-vesting exercise prices are at the lowest possible levels; suppressing share trading price prior to a Company announcement in order to acquire market shares in preparation to a positive announcement; many other minor motives but the very worst involves a high-placed insider cooperating with a competitor or buyout entity who wishes to acquire the Company at an artificially depressed price or permanently damage the competitor ostensibly employing the insider. Many business customers/clients avoid doing business with companies who are losing share trading price. That dropping share trading price casts a shadow of doubt on the viability of the business upon which it is based.
In the above sets of cases regarding Insider Trading, the Insiders specifically referenced are the various members of the Company's Board of Directors, including the Chairman of the Board, each member elected in an as non-democratic an election as can be devised while still retaining what could only loosely meet the term democratically elected—rarely if ever a competition for any given elected position or shareholder issue; and the top level of management—the officers who comprise that level—the Company CEO (Chief Executive Officer), the Company President, the myriad, various and often quite inventively titled Vice-Presidents, other Executive Officers such as Chief Operating Officer, Chief Technology Officer, Chief Financial Officer, and so on. Rarely mentioned and almost never a shareholder-elected member of the Board of Directors, there is the Board Secretary, one who attends every Board meeting, is responsible for all recording of the minutes and various other duties. Yet it is the Board Secretary who has the inside track, who is as ubiquitous as a fly on the wall.
   III Retroactively Changing Trade Type—Used for a multitude of reasons, the changing of the declared nature of a stock trade from a Long Sale to a Short Sale, particularly as a result of one or more subsequent event(s) coming to light in the days-long interim between trade and settlement is easily recognizable by sudden and frequent rises (particularly those with out-of-proportion-to-normal increases as identified by Standard Deviation calculations) in FTDs which, unlike Short Sold Shares initially labeled as such and counted on Trade Date as part of the Daily Short Volume, are not noted as FTDs until after the Settlement Date settling time—at or shortly after the close of trading on that Settlement Date, not the Trade Date; hence the spreadsheet Trade Date orientation of that particular data. These increases are strong indicators of an organized and highly illegal share price manipulation scheme when they immediately precede an Unpredictable Item of Interest in the same company's stock trading record. It is the frequency of these increases particularly related to the relative positioning of Unpredictable Items of Interest that make the case for intent, also readily identified by additional Standard Deviation metrics.
   IV Simply Choosing to Not Deliver so Shares Sold can be Sold Additional Times Add into the mix a selected variety of Unpredictable Items of Interest and other motivations appear for the manipulative activity being revealed. SEC filings as well as some Company Press Releases can produce large percentage increases and statistically significant nominal increases of Failures to be Delivered, relative to typical average FTD volumes as well as accounting for a major proportional percentage of the respective Daily Trading Volume—BEFORE the actual Public Release(s) or official SEC Publication. These evidences are correctly identified as such by proper alignments of all data to the respective Trade Dates since the majority of relative evidences are not published to the Trade Dates but rather to their respective Settlement Dates—3 or 2 Trade Dates later (by Pre- or Post-Sep. 5, 2017 shortening of the Trade-Date-to-Settlement-Date gap, respectively). Other tell-tales of this activity can be seen by the various entry comparatives, be they Row-Row, Column Trade Date Entry to Column Trade Date Entry, combinations and/or comparatives of same and various techniques of analysis presented in this Process Description.
The alteration of trade type (long sale into short sale) is enabled precisely because of the delay (gap) between Trade and Settlement Dates. Standard Deviations of these changes through their respective Date Relationals' series of changes relative to the averages of each category further points the accusatory finger at criminal activity, revealing the true weight of these manipulations and the changes they induce. Anonymous shares (identified ONLY by generalized CUSIP* number—A unique identification number that is assigned to stock and bond certificates allegedly in an effort to improve the efficiency of clearing operations—CUSIP: Committee on Uniform Securities Identification Procedures) being traded has significant contribution to this as well as delay between Trade Date and Settlement Date. What is actually used in identifying shares offered for sale is a lettered, generalized-by-corporate-name type of identification. Individual shares or the certificates that represent actual identification are NOT used when making trades, nor are they specifically identified when delivered to be anything other than a “same-as” representation of what was actually sold.
The above are not the only categories adversely affected by the introduction of artificial shares. When they are applied to certain SEC Filing Reference Periods (Record Dates for specific time-related shareholder identification) related to shareholder benefits or obligations, those shareholder benefits or obligations are denied by “ownership of illegitimate shares”. They do not own what they have paid for until that legitimate property is actually delivered.
   V Shareholder Identification Blocking for Record Date Benefits or Obligations The benefits/obligations to/of/due a shareholder or shareholders and the wholly unpredictable types of Reference Periods the Company's SEC Filings may include can be blocked by interfering with the legitimacy of their holdings. These Record Dates are required to be treated as highly confidential by all Company entities who are “in the know”. It is the Record Date where shareholder rights are conferred, such as: qualifying to receive Company-paid Dividends; attend shareholder meetings; vote on shareholder issues; receive specific shareholder information; be awarded beneficial share-splits or to receive valuable warrants for purchase of additional shares at pre-set prices, usually time-limited. Holders of artificial shares are denied all these things because the shares they paid for aren't genuine. These Record Dates are chosen by the Company Boards of Directors during Board Meetings, are limited by the Rules, Regulations and Laws that govern corporate management and oversight. Any pre-official dissemination is highly restricted if not prohibited—by law—criminally so.
These ill effects continue if/when those non-existent shares are then sold, conferring the onus of artificial shares upon the next owner and this continues until the original seller actually delivers real, genuine shares, either by finally choosing to deliver the shares they chose to not deliver—when required, or by purchasing the required number of shares to negate the “non-ownership-by-prior-fraud” the subsequent purchasers of those counterfeit shares had to endure and unknowingly confront, all of which occurs without their knowledge or consent, due in no small part by the malignant delay in accurate and timely identification and notification of their FTD status. That there is no consequence of worth imposed on any of the parties involved except the victims themselves only encourages this manipulative activity at every opportunity, for those so inclined—and they are legion.
One can add the appropriate Line-ID Numbered “x-of-y” Matches when the Appendix “A” Templates were used to produce the Trade Date Relationals' Directional Indicator Aggregate Match results to determine the relevant patterns, both to the frequencies—Standard Deviation statistical significance—associated with the specific-type Items of Interest positions; and then, for comparison, to the entire field of same type data the Company-specific spreadsheet contains (trading history being examined); their weighting multipliers (the decimal-adjusted potential results) can be applied and the resulting products compared; specific matching patterns associated with an immediate precedent presence to externally generated Items of Interest and/or their Unpredictable Reference Period(s); etc. can and do reveal intent. Patterns, especially those associated with externally chosen points in time, wholly independent of trading price and/or volume data as though randomly generated, can only be established with repetition and repetition reveals intent. Intent is the prerequisite for criminal prosecution of the perpetrators, facilitators, overseers, involved insiders and most importantly, the instigators.
With the above now established, further illegal activity can be revealed by posting the other Items of Interest, first the Semi-predictable group and then the Predictable Items of Interest. Among the Semi-predictable Items of Interest is the following:
   VI Extended Pre-identifiably Specific Trade Date Period in which FTDs and Daily Short Volume are Both on the Rise Semi-predictable Items of Interest can be defined as those events which are expected but the precise date is not known until announced. Only a relatively short range of Trade Dates is the general rule. However, there are some indicators of intentional manipulation that present themselves. These are most notably an extended period of increases in either Short Volume and/or Fails to Deliver, mainly in the expectation of a Semi-predictable event becoming effective. These actions by themselves are dilutive of demand, thus skewing the hypothetical pricing by the “laws of supply:demand” [upon which so much economic theory is based (and biased)] downward. Again, clearly demonstrated by multiple referent points, from the Illegal Trading Types list: I Basic Manipulative Action. The opposite, a rise in share price and a diminution of once present FTDs and a presence of Short Volume becoming minimized or disappearing altogether indicates a set-up for subsequent unrestrained if not artificially encouraged risen prices being then driven down by the increases in both, all in the preceding Trade Date data prior to a Semi-predictable event's occurrence—the price and volume data and respective analysis reveal the intent behind the activity.
While the above Illegal Trading Type VI may constitute the weakest of the Illegal Trading Types by stand-alone appearances, if combined with other indicators and evidences of Illegal Trading and the same entities are found acting as participants under both arenas, it serves as confirmation of a concerted, organized attack using intentional share price manipulation as its primary weapon for producing gains, albeit ill-got, either directly or indirectly.
The last group of Items of Interest may prove the most interesting and most widely utilized since target dates are known, are indeed Predictable and yet again, because the majority of evidentiary records of prosecutorial worth are delayed or camouflaged by mis-dating or both, can be willfully effected since the evidentiary data has been made essentially moot by that delay and/or camouflaging.
   VII Repetitive Activity Covering Specific Effects on Either or Both Sides of Predictable Items of Interest Date-of-Entry by Kind of Item Entered This category of detectable manipulation-by-intent most frequently involves external and/or hidden motivation, made invisible by the camouflaging by delay and/or mis-dating of the primary evidences eventually made available. These Predictable Items of Interest are signal events creating notice that attention paid can be of benefit in efforts to detect and identify illegal manipulative trading in precedent proximity to like-kind Items of Interest. Examples follow:
      A) Short Interest Last Trade Date (What follows describes direct cover-up activity.) When Trading Volume, Fails to Deliver, and Trading Price (especially the day's High and Close) rise numerically and as a percentage increase (particularly when a Standard Deviation measure indicates a statistically significant change has occurred) and the average Daily Short Volume deceases or only rises slightly before or on that last Trade Date for the Short Interest Last Trade Date of a given Short Interest Report Period, this is a strong indicator of deliberate price manipulation by short selling, including by naked short selling and Failing to Deliver. These changes can be on that last trade date or can be on one or more of the few days leading up to that last trade date. Confirmation of this manipulating tactic's cover-up activity so close to the last trade date frequently arrives the very next trade date when statistically significant changes occur in the opposite direction—Trading Prices go down (especially the Daily Low and Close), Daily Short Volume rises and as often as not the Fails to Deliver quantity goes down (but it isn't necessary for the other indicators' evidence are more than sufficient to show willful price manipulation). The intended net effect is to hide the short selling numbers from that entire Report Period, enough to minimize the appearance of an increase in that Report Period's Short Interest. The preceding rise in Fails to Deliver indicates artificial or counterfeit shares are being substituted for Report Period's short sold shares. It all has to do with when each (Short Sold shares vs Naked Short Sold and thus Failing to Deliver shares) is counted and reported and published. The Short Sold shares are reported and published within a relatively reasonable period of delay compared to the Fails to Deliver shares but the Fails to be Delivered detection and reporting can be delayed by significantly longer periods of delay, to say nothing of being misidentified by associated date information. That both occur on the same Trade Date only amplifies the deliberate cover-up nature of the entire process. All the indicated Short Selling and Fails to Deliver (at a minimum Naked Short Selling) throughout the Short Interest Report Period under examination is intended to compel Stop-Loss Selling, all without any corresponding opposite Go-Gain Buying and doing so with minimal risk of detection. Enforcement is even less likely.
B) Options Expiration Date This is the last possible date in which an options holder can exercise an option. Manipulation in the price underlying the target of the option is very common, is quite difficult to accomplish, and involves many parties, not least of which would be certain hedge and arbitrage funds attempting to unwind their positions while maintaining a profit from those positions. They are exclusively Trade Date oriented. Intensification of activity in the several days leading up to the absolute expiration (close of trading on the referred Expiration Date) of any possible Exercise Price provides an opportunity for hectic trading and wide fluctuations in prices of the underlying target assets. Participants in that activity include co-located actors, high-frequency computerized trading entities, and private equity funds, all of whom can and are overseen and/or facilitated by the major banks that operate in, on and through Wall Street and the entirety of public and private equity markets and cover-up institutions for organized front-running. Remnants, residues and collective detritus of that manipulative activity can be noted in the subsequent data once released and properly aligned.
C) Russell Indexes Re-balancing Date The rules and calculations and ultimate Re-balance timing of these common, less than whole market Indexes are known and published by those who create the various category lists that comprise each Russell Index. The Russell Indexes Re-balancing Initial Announcement and Re-balancing Final Announcement Dates are not firm but are expected announcements. They comprise primarily three different Indexes: The Russell 1000 which is the largest 1000 publicly-traded U.S. corporations by market-value weighting; the Russell 2000 which are the next largest 2000 publicly-traded U.S. corporations by market-value weighting; and the Russell 3000, a combination of the 1000 and 2000 indexes. There are sub-indexes, not limited to Russell Index Short Indexes as well as various Sector-oriented Russell Indexes, both long and short, all determined by the rules established in determining the initial three Russell Indexes. There are primarily two times where deliberate manipulation can be conducted on some of the components of these Indexes. The first, since the actual formulas are known, merely complex, so a manipulation-inclined entity can maneuver a borderline stock into being a “new” entry, especially to the 2000 and 3000 Indexes, then once so maneuvered and admitted to the 2000 and 3000 Indexes subject them to destructive manipulation, since they are presumed to be weakly present and market history strongly infers these very same “newly admitted Russell Index stocks” have a tendency to drop in valuation in the general markets. Proper alignment of such a group of stocks' data can reveal such manipulations, both up and down in trading prices. The patterns establish this. The patterns show intent and pricing by intent is illegal.
   D) Pre-announced Record Date for Shareholder Interests (Un-noted in the Process Description to this point.) This is usually rationalized by a Company as an attempt to mitigate hypothetically identified but not explained consequences of Post-announced Record Date for Shareholder Interests (announced after the actual Record Date). Those Post-announced Record Date for Shareholder Interests are usually not noted by a specifically dated meeting of the Company's Board of Directors, presumed at the time of the announcement to have been held after the chosen Record Date. The possibly identified but not explained consequences of certain types of Record Dates are directly due to some form of Insider Trading since these Post-announced Record Date for Shareholder Interests involve what must be highly restricted knowledge. The inference is “someone leaked” that information. Depending on when the meeting was held, the specific Record Date chosen, and when that specific Record Date was formally announced to the public, some things can be determined. If the Record Date chosen was more than the difference between Trade Date and Settlement Date yet, for instance, if proportionally large increases in Fails to Deliver occur on and/or immediately prior to that chosen Record Date, then the likelihood the individual or individuals who proposed that specific Date are high on the list for being involved with those directly responsible for those FTD increases. If it is the same Trade Date as the Board meeting or only a Trade Date or two prior to the choosing by the respective Board of Directors and a major increase in Fails to Deliver occur within that local Trade Date to Settlement Date time frame, it is a strong indication that information was leaked by someone in or at that meeting. The Pre-announcing of a Record Date has an even more pernicious effect: When associated with an important shareholder vote, such as to sell the Company, it allows very short-interested arbitragers to adversely influence the outcomes. This is not to be desired by longer-term shareowners who, for one or more reasons are against whatever issue is to be voted on. It is the arbitrage-oriented interested party or parties who have only a short-term few percentage point gain in mind and when these types of pre-announced Record Date vote matters are proposed, it is with the intent of the Board of Directors to force the desired outcome upon the longer-term shareowners. It is in these cases where Fails to Deliver numbers can rise, often with a disproportional number of Fails occurring in the days immediately prior to the stated Record Date that the most prevalent manipulation is evident. The reason being, the more shares that can be owned by the arbitragers, the more short-term interests influencing the vote outcome is effected. Since shares customarily trade only a couple percent below a stated company selling price in the days and weeks prior to a vote and the actual closing of that sale usually occurs shortly thereafter, an arbitrage interest can multiply those few percentages of gains by compounding them through a given calendar year, sometimes six or seven times. That alone can put the annual gains of an arbitrage interest well into double-digit territory with little risk. That they are also able to cap any trading by deploying timely Fails to Deliver only adds to their profit margin by discouraging others from continuing to hold on to their shares, by discouraging others from offering higher prices for the Company, by adding to their voting rights proportion of shares by buying up all shares offered at prices below the to-be-voted-on Company sale price. Once that vote occurs, the numbers of Fails to Deliver drops, since there is no further need to gain vote-outcome acquiring shares. They may not eliminate the Fails numbers but since the arbitrage interests can be satisfied with repetitive small gains compounded through the year, even partial percentage gains are more than acceptable when they only require a few days or weeks to become effective. These matters are known to the Boards of Directors and the advisers they employ to make their decisions a done deal.
In addition to the above, there are other evidences of illegal trading activity that can be revealed by the proper alignment of trading data when other esoteric data is included. One of those curiosities has to do with the published numbers of Shares Outstanding; one-half of one-percent of those numbers; the number of Fails to Deliver; numbers equal to or in excess of that one-half of one-percent in numbers of Fails to Deliver and the persistence of those numbers for given periods of time. The first is known as the Threshold Number and the other is known as Reg Sho.
   VIII Persistence of Fails to Deliver Sufficient to Qualify for Listing on the Threshold List When the number of Fails to Deliver reaches the equivalence of one-half of one-percent (0.5%) of the officially declared number of Shares Outstanding and effectively available for trade in the latest Company SEC filings for Shares Outstanding and that number or more is continuously present for five consecutive Trading Days, that Company's stock goes on what is termed “The Threshold List” and will not be removed from that list until at least five consecutive Trading Days have passed with the number of Fails to Deliver below that half-percent of Shares Outstanding.
   IX Persistence of Fails to Deliver Sufficient to Qualify for Listing on the Reg Sho List If the number of Fails to Deliver continues to be on the Threshold List for an additional eight Trading Days (thirteen Trading Days in total), the Company's stock is placed on what is called Reg Sho. Once listed on Reg Sho, the broker(s) whose clients are responsible for any of those Fails to Deliver are barred from offering any shares classified as being Short Sold until five consecutive Trading Days have passed where the one-half of one-percent (0.5%) of the officially declared number of Shares Outstanding and effectively available for trade in the latest Company SEC filings for Shares Outstanding is not equaled or exceeded. That five-Trading Days of uninterrupted period where the Threshold number of Fails to Deliver is not exceeded effectively removes that Company's stock from both Reg Sho and the Threshold List. It is also at that point whereby the brokers whose clients contributed to that Listing can again offer shorted shares for sale.
In both instances listed above, there are many ways to do end-arounds intended to evade the restrictions imposed. The evidence those evasions produce are represented in the data, however after the fact they may appear. Two simple evasive maneuvers are: 1) The broker for the entity responsible for some of the Fails to Deliver actually delivers the shares they traded through that broker that became Fails to Deliver, making the broker free once again to offer short sell shares for sale. This holds true if all the shares the specific broker handled for any client appearing in the total of Fails to Deliver for that stock are delivered. It holds true even if the Fails to Deliver count continues to exceed the Threshold number and even when it continues on Reg Sho; 2) The seller of shares that became Fails to Deliver simply changes brokers. There is a third technique even more noxious to genuine shareholders. This involves the most obvious—selling shares labeled as long sales, then deciding to not deliver them, most often to resell those same shares again, often multiple times, each time without actually delivering them until the trading price falls below the trading price they have already sold them for, thus buying the shares necessary to cover those they sold as long but were in effect naked short selling them. It is the effectively triggered stop loss selling these entities are aiming for to make their profit, frequently on the same Trade Date or soon thereafter. One of the key tells occur when there is an increase in Fails to Deliver that exceeds the Daily Short Volume. When combined with a Daily Trading Volume that is close to the Average Daily Volume, it should trigger interest from the regulatory agencies, both public (SEC Enforcement) and private (various SROs—Self Regulatory Organizations, often Congressionally sanctioned as such), but unfortunately, rarely if ever actually does.
The principle actors involved already believe with a justifiably high level of certainty they will not be caught since the details of what they do and have done are delayed and camouflaged by the manners in which those details are made public, if they are ever made public.
The various techniques employed by this Process as described, in part and in whole reveal the evidence necessary to demonstrate the criminal manipulation of share prices and, by the patterning, the intent of the participants involved. All of these techniques are based on publicly available data, the proper alignments of that data and the rigorous analysis of that properly aligned data. The whole of the analysis not only demonstrates when and how illegal activity occurs, it also clearly demonstrates when it is not. What remains is the political will (thoroughly lacking to date) to pursue the participants in collective criminal and civil prosecution as well as the victims themselves being made aware of the evidence so they are also capable of pursuing civil justice. Until that occurs, the perpetrators and the influence of wealth they are able to exert shall continue without interruption.
The only remaining data necessary for justice to be pursued and met is the accurate identification of those participants who made effective the actions this Process reveals. Those data are, thanks to various sections of The Patriot Act of 2001 and The Homeland Security Act of 2002, not only recorded and placed in a highest security facility available, they are duplicated multiple times and stored in a multitude of highly secured locations, since the one thing all asset-holders of wealth and the power and influence it confers insist upon is a thoroughly accurate trail of ownership, reflecting start to finish that succession of possession, of ownership, whether it be for decades or milliseconds. The fear of being unable to clearly demonstrate what one owns and when and for how much, as well as when and for how much that ownership was disposed is the very bedrock foundation of all speculation in a capitalist system. They keep their receipts.
These illegal practices irreparably damage shareholders, only one of the consequences they impose. They also harm the affected businesses, their employees and the very economy itself.

1) I claim, in the Primary, Secondary and Tertiary Levels, by rigorous attention to the correct alignment of input data to accurately reflect the actual Trade Dates in which the data was initially created (as opposed to when it was officially recognized and/or published) and the relation of that correctly aligned input data to itself on both a day-to-day basis as well as near-term multi-day relation, suspicious and likely illegal manipulative trading activity is revealed, being more than sufficient to compel further investigation to determine any relationship those anonymous, anomalous trading data may have to those responsible for their existence; i.e., Are they the same entities?

2) I claim, in the Quaternary and Quinary Levels, by initial and subsequent Pre-algorithmic and Algorithmic analyses of data (input data and spreadsheet data generated by that input's initial analyses), as well as subsequent algorithmic compounding analyses, the results are able to demonstrate specific repetitive patterns in the data, so when those demonstrably specific patterns show statistically significant occurrence, especially when they immediately precede externally determined non-trading relational timing(s), the evidence of definitive criminal activity, including that which invokes RICO (Racketeer Influenced and Corrupt Organizations Act) Statutes' violations, becomes apparent.

3) I claim, in the Senary Level, once patterns and their statistical significance are demonstrated, their specific locations in the trading data, contemporaneous to specific types of externally determined non-trading relational timing(s), certain types of motivations and tactics become apparent as all are harmful to legitimate investors, their assets and the intentions behind their placing those assets in chosen venues, each type of illegal tactics used by intent, to and for effect, can and are delineated by the evidence this entire Process details.
